(19) United States
(12) Patent Application Publication
(10) Pub. No.: US 2024/0399774 A1
(43) Pub. Date: Dec. 5, 2024

(54) DECORATIVE FILM AND MANUFACTURING METHOD OF SAME, LAMINATE AND MANUFACTURING METHOD OF SAME, SUBSTRATE WITH OPTICAL MASK FOR MANUFACTURING DECORATIVE FILM, MOLDED BODY, ARTICLE, AND DISPLAY DEVICE

(71) Applicant: FUJIFILM Corporation, Tokyo (JP)

(72) Inventors: Yuka MATSUMOTO, Kanagawa (JP); Jun WATANABE, Kanagawa (JP)

(73) Assignee: FUJIFILM Corporation, Tokyo (JP)

(21) Appl. No.: 18/800,000

(22) Filed: Aug. 9, 2024

Related U.S. Application Data
(63) Continuation of application No. PCT/JP2023/013020, filed on Mar. 29, 2023.

(30) Foreign Application Priority Data
Mar. 29, 2022 (JP) 2022-054572
Jun. 8, 2022 (JP) 2022-093029

(51) Int. Cl. B41M 3/00; C09K 19/38

(52) U.S. Cl. CPC B41M 3/008; C09K 19/3852

(57) ABSTRACT

A manufacturing method of a laminate includes: providing an optical mask layer on a substrate by printing a first pattern having AM screen tone with a screen ruling of 250 lines or less and having a halftone dotted region having a halftone dot area ratio of 0.5% to less than 99.5% on the substrate using a first ink, and printing a second pattern having a semi-translucent solid region having a print-area ratio of 99.5% or more and a light transmittance of 5% to less than 95% at a position overlapping the halftone dotted region of the first pattern using a second ink; providing a liquid crystal layer containing a liquid crystal compound and a photosensitive chiral agent on a side of the substrate opposite to the optical mask layer; and irradiating the liquid crystal layer with light through the optical mask layer to subject the photosensitive chiral agent to photoreaction.

### CROSS-REFERENCE TO RELATED APPLICATIONS

This application is a continuation application of International Application No. PCT/JP2023/013020, filed Mar. 29, 2023, the disclosure of which is incorporated herein by reference in its entirety. Further, this application claims priority from Japanese Patent Application No. 2022-054572, filed Mar. 29, 2022, and Japanese Patent Application No. 2022-093029, filed Jun. 8, 2022, the disclosures of which are incorporated herein by reference in its entirety.

### BACKGROUND OF THE INVENTION

### 1. Field of the Invention

The present disclosure relates to a decorative film and a manufacturing method of the same, a laminate and a manufacturing method of the same, a substrate with an optical mask for manufacturing a decorative film, a molded body, an article, and a display device.

### 2. Description of the Related Art

In recent years, a film for decorating an article has been proposed as an alternative material to coating or painting. For example, a technique of obtaining a decorated molded body by disposing a film on a surface of a desired resin molded body and coloring the surface of the resin molded body in a desired hue or providing a desired pattern on the surface of the resin molded body has been attracting attention. In addition, a decorated molded body can be obtained by disposing a decorative film in a mold frame in advance and then introducing a molding resin into the mold frame.

For example, a technique using cholesteric liquid crystal is known as the decorative film. As a specific example, a decorative film for molding has been disclosed that has a cured liquid crystal layer formed by curing a liquid crystal layer containing a cholesteric liquid crystal compound and a photoisomerization compound on a substrate (for example, WO2018/230395A).

### SUMMARY OF THE INVENTION

As in the technique disclosed in WO2018/230395A, use of a cholesteric liquid crystal compound and a photosensitive chiral agent, and a photoreaction of the photosensitive chiral agent due to irradiation with light through an optical mask layer having a pattern lead to a change in the length of a helical pitch of a liquid crystal phase depending on the light transmittance of the optical mask layer, which makes it possible to exhibit a hue in a patterned manner by the reflection of light having a wavelength corresponding to the helical pitch.

The optical mask layer having a pattern can be formed as a long optical mask layer of 100 meters or more by, for example, printing using a liquid electrophotographic method, a gravure printing method, or an ink jet rotary printing method.

In a case of forming a long decorative film having a patterned hue change using a cholesteric liquid crystal compound, a photosensitive chiral agent, and a long optical mask layer having a pattern, a hue change having a shape similar to a halftone dot of the optical mask layer may appear on the decorative film. This halftone dot-like hue change is visually recognized as a hue in which a plurality of hues are mixed, that is, a hue having low chroma saturation, and a hue having high chroma saturation is not obtained.

For example, in a case where an optical mask layer having finer halftone dots is formed using a high-definition printing method such as an ink jet sheet-fed printing method, a laser printer method, or a laser photoplotter method and is used for forming a decorative film, a halftone dot-like hue change does not appear and a hue having high chroma saturation is obtained. However, in such a high-definition printing method, only a short optical mask layer of several meters or less can be formed, so in order to form a long decorative film, it is necessary to bond a large number of short optical mask layers together, and thus, it has been found that there is a problem of poor manufacturing efficiency.

An embodiment of the present disclosure provides a manufacturing method of a laminate having a multicolor and having high chroma saturation and high productivity.

Another embodiment of the present disclosure provides a laminate having a multicolor and having high chroma saturation, a decorative film and a manufacturing method of the same, a substrate with an optical mask for manufacturing a decorative film, a molded body, an article, and a display device.

The specific means for achieving the objects includes the following aspects.

<1> A manufacturing method of a laminate, comprising: a step of providing an optical mask layer on a substrate by printing, on the substrate using a first ink, a first pattern having an AM screen tone with a screen ruling of 250 lines or less and having a halftone dotted region having a halftone dot area ratio of 0.5% or more and less than 99.5%, and printing, at a position overlapping with the halftone dotted region of the first pattern using a second ink, a second pattern having a semi-translucent solid region having a print area ratio of 99.5% or more and a light transmittance of 5% or more and less than 95%; a step of providing a liquid crystal layer containing a liquid crystal compound and a photosensitive chiral agent on a side of the substrate opposite to the optical mask layer; and a step of irradiating the liquid crystal layer with light through the optical mask layer to subject the photosensitive chiral agent to a photoreaction.

<2> The manufacturing method of a laminate according to <1>, in which an entire region of the halftone dotted region of the first pattern overlaps with the semi-translucent solid region of the second pattern, or the second pattern further has a region having a print area ratio of less than 0.5%, and the entire region of the halftone dotted region of the first pattern overlaps with the semi-translucent solid region of the second pattern and the region of the second pattern having a print area ratio of less than 0.5%.

<3> The manufacturing method of a laminate according to <1> or <2>, in which the entire region of the halftone dotted region of the first pattern overlaps with the semi-translucent solid region of the second pattern.

<4> The manufacturing method of a laminate according to any one of <1> to <3>, in which the second pattern further has a halftone dotted region, the first pattern further has at least one region of a semi-translucent solid region or a region having a print area ratio of less than 0.5%, an entire region of the halftone dotted region of the second pattern overlaps with the at least one region of the semi-translucent solid region or the region having a print area ratio of less than 0.5% of the first pattern, and the second pattern is a pattern having an AM screen tone with a screen ruling of 250 lines or less.

<5> The manufacturing method of a laminate according to <4>, further comprising, in the step of providing the optical mask layer on the substrate, printing a pattern different from the first pattern and the second pattern on the substrate, in which the pattern different from the first pattern and the second pattern has at least one region of a semi-translucent solid region or a region having a print area ratio of less than 0.5%, and the at least one region of the semi-translucent solid region or the region having a print area ratio of less than 0.5% of the pattern different from the first pattern and the second pattern overlaps with an entire region of the halftone dotted region of the first pattern and an entire region of the halftone dotted region of the second pattern.

<6> The manufacturing method of a laminate according to <5>, in which the pattern different from the first pattern and the second pattern further has a halftone dotted region and is a pattern having an AM screen tone with a screen ruling of 250 lines or less.

<7> The manufacturing method of a laminate according to <6>, in which the pattern different from the first pattern and the second pattern is a plurality of patterns, and the halftone dotted regions of each of the plurality of patterns do not overlap with each other.

<8> A manufacturing method of a decorative film, comprising: the manufacturing method of a laminate according to any one of <1> to <7>.

<9> A laminate comprising, in the following order: an optical mask layer; a substrate; and a cholesteric liquid crystal layer containing a liquid crystal compound and a photosensitive chiral agent, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

<10> A laminate comprising, in the following order: an optical mask layer; a substrate; and a cholesteric liquid crystal layer containing a liquid crystal compound and a photosensitive chiral agent, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}-T_{D}><80.75% is satisfied.

<11> The laminate according to <10>, in which (T_{A}−T_{D})/(T_{MAX}−Tₘᵢₙ)≤0.95 is satisfied for all halftone dotted regions of the optical mask layer.

<12> The laminate according to <10> or <11>, in which (T_{A}−T_{D})/(T_{MAX}−Tₘᵢₙ)≤0.50 is satisfied for all halftone dotted regions of the optical mask layer.

<13> A substrate with an optical mask for manufacturing a decorative film, comprising: a substrate; and an optical mask layer, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

<14> A substrate with an optical mask for manufacturing a decorative film, comprising: a substrate; and an optical mask layer, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}−T_{D}<80.75% is satisfied.

<15> A decorative film comprising: a cholesteric liquid crystal layer, in which the cholesteric liquid crystal layer has a halftone dot region in which maximum points of a cholesteric pitch are arranged in a halftone dot-like manner, and in a case where the halftone dot region is divided into unit lattices which are quadrangles having a smallest area with the maximum point of the cholesteric pitch as a vertex, and a difference between a maximum value and a minimum value of the cholesteric pitch in each of unit lattices is defined as an intra-lattice pitch difference ΔP_{S}, ΔP_{S(MAX)}, which is a maximum value of the ΔP_{S}, is 0<ΔP_{S(MAX)}/ΔPₐₗₗ≤0.4 with respect to ΔPₐₗₗ which is a difference between a maximum value and a minimum value of a cholesteric pitch in an entire cholesteric liquid crystal layer.

<16> The decorative film according to <15>, in which the cholesteric liquid crystal layer has a region in which a change in cholesteric pitch per a distance of 100 μm in an in-plane direction is 13 nm or more.

<17> The decorative film according to <15> or <16>, in which the ΔP_{S(MAX)} is less than 33 nm in the cholesteric liquid crystal layer.

<18> A decorative film comprising: a cholesteric liquid crystal layer, in which the cholesteric liquid crystal layer has a halftone dot region in which maximum points of a cholesteric pitch are arranged in a halftone dot-like manner, and in a case where the halftone dot region is divided into unit lattices which are quadrangles having a smallest area with the maximum point of the cholesteric pitch as a vertex, and a difference between a maximum value and a minimum value of the cholesteric pitch in each of unit lattices is defined as an intra-lattice pitch difference ΔP_{S}, ΔP_{S(MAX)}, which is a maximum value of the ΔP_{S}, is less than 33 nm in the cholesteric liquid crystal layer.

<19> The decorative film according to <15> or <18>, in which a difference ΔPₐₗₗ between a maximum value and a minimum value of a cholesteric pitch in an entire cholesteric liquid crystal layer is 70 nm or more in the cholesteric liquid crystal layer.

<20> A molded body obtained by molding the decorative film according to <15> or <18>.

<21> An article comprising: the decorative film according to <15> or <18> or the molded body according to <20>.

<22> The article according to <21>, in which the article is an electronic device. <23> A display device comprising: the article according to <22>.

According to the embodiment of the present disclosure, there is provided a manufacturing method of a laminate having a multicolor and having excellent productivity and high chroma saturation.

According to another embodiment of the present disclosure, there are provided a laminate having a multicolor and having high chroma saturation, a decorative film and a manufacturing method of the same, a substrate with an optical mask for manufacturing a decorative film, a molded body, an article, and a display device.

### BRIEF DESCRIPTION OF THE DRAWINGS

FIG. 1 is a view showing a pattern of an 8 cm×4 cm optical mask layer.

FIG. 2 is an enlarged view of a 370 μm×500 μm region of the pattern shown in FIG. 1, in which a light transmittance is controlled to 40%.

FIG. 3 is a view showing a hue change of an 8 cm×4 cm cholesteric liquid crystal layer.

FIG. 4 is an enlarged view of a 370 μm×500 μm region of the hue change of the cholesteric liquid crystal layer shown in FIG. 3.

FIG. 5A is a schematic view for describing an example of a first pattern of an optical mask layer carried out by a manufacturing method of the present disclosure. The color strength in the figure indicates the low light transmittance per 300 μm square, and the closer to black the region is, the lower the light transmittance per 300 μm square.

FIG. 5B is a schematic view for describing an example of a second pattern of an optical mask layer carried out by the manufacturing method of the present disclosure. The color strength in the figure indicates the low light transmittance per 300 μm square, and the closer to black the region is, the lower the light transmittance per 300 μm square.

FIG. 5C is a schematic view for describing an example of an optical mask layer carried out by the manufacturing method of the present disclosure. The color strength in the figure indicates the low light transmittance per 300 μm square, and the closer to black the region is, the lower the light transmittance per 300 μm square.

FIG. 5D is an enlarged view of a part of the first pattern shown in FIG. 5A.

FIG. 5E is an enlarged view of a part of the second pattern shown in FIG. 5B.

FIG. 5F is an enlarged view of a part of the optical mask layer shown in FIG. 5C.

FIG. 6 is a view schematically showing a manufacturing device for carrying out an example of a manufacturing method of a liquid crystal film of the present disclosure.

FIG. 7 is a schematic view for describing an example of the manufacturing method of a liquid crystal film carried out by the manufacturing device shown in FIG. 6.

FIG. 8 is a view showing a 300 mm×980 mm pattern of the optical mask layer used in Examples.

FIG. 9 is a view showing a first pattern of 300 mm×980 mm of the optical mask layer used in Examples.

FIG. 10 is a view showing a second pattern of 300 mm×980 mm of the optical mask layer used in Examples.

FIG. 11 is a view showing a third pattern of 300 mm×980 mm of the optical mask layer used in Examples.

FIG. 12 is a view showing a fourth pattern of 300 mm×980 mm of the optical mask layer used in Examples.

FIG. 13 is a view showing a fifth pattern of 300 mm×980 mm of the optical mask layer used in Examples.

FIG. 14 is a view showing a sixth pattern of 300 mm×980 mm of the optical mask layer used in Examples.

FIG. 15 is a view showing a first pattern of the optical mask layer used in Examples.

FIG. 16 is a view showing a second pattern of the optical mask layer used in Examples.

FIG. 17 is a view showing the first pattern of the optical mask layer used in Examples.

FIG. 18A is a view illustrating the first pattern of the optical mask layer used in Examples.

FIG. 18B is a view illustrating the second pattern of the optical mask layer used in Examples.

FIG. 18C is a view illustrating the optical mask layer used in Examples.

FIG. 19A is a view illustrating the first pattern of the optical mask layer used in Examples.

FIG. 19B is a view illustrating the second pattern of the optical mask layer used in Examples.

FIG. 19C is a view illustrating the optical mask layer used in Examples.

FIG. 20A is a view illustrating the first pattern of the optical mask layer used in Examples.

FIG. 20B is a view illustrating the second pattern of the optical mask layer used in Examples.

FIG. 20C is a view illustrating the optical mask layer used in Examples.

FIG. 21A is a view illustrating the first pattern of the optical mask layer used in Examples.

FIG. 21B is a view illustrating the second pattern of the optical mask layer used in Examples.

FIG. 21C is a view illustrating a third pattern of the optical mask layer used in Examples.

FIG. 21D is a view illustrating the optical mask layer used in Examples.

FIG. 22A is a view illustrating the first pattern of the optical mask layer used in Examples.

FIG. 22B is a view illustrating the second pattern of the optical mask layer used in Examples.

FIG. 22C is a view illustrating the third pattern of the optical mask layer used in Examples.

FIG. 22D is a view illustrating the optical mask layer used in Examples.

FIG. 23 is a view showing a second pattern of the optical mask layer used in Comparative Examples.

### DESCRIPTION OF THE PREFERRED EMBODIMENTS

Hereinafter, the contents of the present disclosure will be described in detail. The description of configuration requirements described below may be made on representative embodiments of the present disclosure, but the present disclosure is not limited to such embodiments.

In the present specification, any numerical range shown using “to” is used to mean a range including numerical values described before and after “to” as a lower limit value and an upper limit value, respectively. In a numerical range described in a stepwise manner in the present specification, an upper limit value or a lower limit value described in a certain numerical range may be replaced with an upper limit value or a lower limit value of another numerical range described in a stepwise manner. In addition, with regard to a numerical range described in the present specification, an upper limit value or a lower limit value of the numerical range may be replaced with the values shown in Examples.

Furthermore, in the present specification, in a case where there are a plurality of substances corresponding to each component in a composition, the amount of each component in the composition refers to a total amount of the plurality of the corresponding substances present in the composition unless otherwise specified.

In the present specification, the term “step” includes not only an independent step but also a step in which the intended purpose of the step is achieved even in a case where the step cannot be clearly distinguished from other steps.

In the present specification, the “total solid content” refers to a total mass of components excluding a solvent from a total composition of a composition. In addition, the “solid content” refers to components excluding a solvent as described above, which may be, for example, solid or liquid at 25° C.

In the present specification, in a case where there is no description regarding whether a group (atomic group) is substituted or unsubstituted, such a group includes both a group having no substituent and a group having a substituent. For example, an “alkyl group” includes not only an alkyl group having no substituent (unsubstituted alkyl group), but also an alkyl group having a substituent (substituted alkyl group).

In the present disclosure, “% by mass” and “% by weight” have the same meaning, and “part(s) by mass” and “part(s) by weight” have the same meaning.

In the present disclosure, a combination of two or more preferred aspects is a more preferred aspect.

In the present disclosure, unless otherwise specified, a weight-average molecular weight (Mw) and a number-average molecular weight (Mn) are each a molecular weight that is detected by a gel permeation chromatography (GPC) analyzer using TSKgel GMHxL, TSKgel G4000HxL, and TSKgel G2000HxL (all trade names, manufactured by Tosoh Corporation) as columns, tetrahydrofuran (THF) as a solvent, and a differential refractometer as a detector, and then expressed in terms of polystyrene as a standard substance.

### <Manufacturing Method of Laminate>

A manufacturing method of a laminate of the present disclosure includes a step of providing an optical mask layer on a substrate by printing, on the substrate using a first ink, a first pattern having an amplitude modulation (AM) screen tone with a screen ruling of 250 lines or less and having a halftone dotted region having a halftone dot area ratio of 0.5% or more and less than 99.5%, and printing, at a position overlapping with the halftone dotted region of the first pattern using a second ink, a second pattern having a semi-translucent solid region having a print area ratio of 99.5% or more and a light transmittance of 5% or more and less than 95%;
a step of providing a liquid crystal layer containing a liquid crystal compound and a photosensitive chiral agent on a side of the substrate opposite to the optical mask layer; and
a step of irradiating the liquid crystal layer with light through the optical mask layer to subject the photosensitive chiral agent to a photoreaction.

The cholesteric liquid crystal layer reflects incident light in a wavelength-selective manner to exhibit a hue corresponding to the wavelength of the reflected light. With regard to the hue exhibited by the cholesteric liquid crystal layer, a desired hue can be obtained by changing a helical pitch of a cholesteric liquid crystal compound.

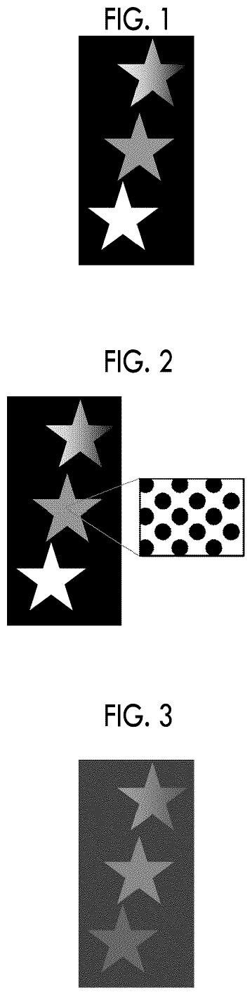

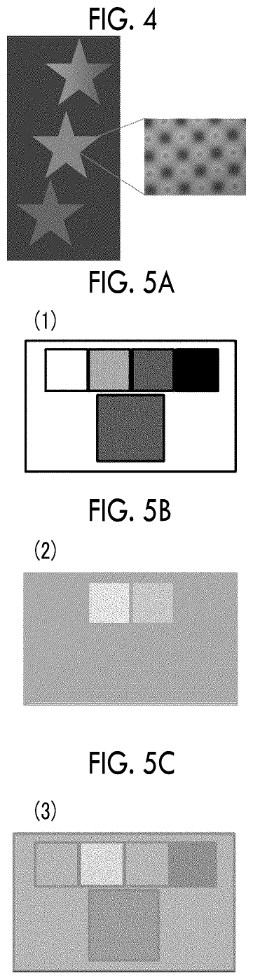

The helical pitch of the cholesteric liquid crystal compound can be controlled by combination use of a photosensitive chiral agent in which a helical twisting power is increased or decreased by a photoreaction and irradiation with light through an optical mask layer having a pattern, thereby making it possible to a hue depending on a light transmittance of the pattern. The optical mask layer having a pattern can be formed as a long optical mask layer of 100 meters or more by, for example, printing using a liquid electrophotographic method, a gravure printing method, or an ink jet rotary printing method, but the long optical mask layer is restricted in resolution and has coarse halftone dots that control the light transmittance. In a case where an attempt is made to form a long cholesteric liquid crystal layer having a patterned hue change using an optical mask layer having coarse halftone dots, a hue change in a shape similar to the halftone dots of the optical mask layer may appear in the cholesteric liquid crystal layer. For example, in a case where an attempt is made to form a cholesteric liquid crystal layer as shown in FIG. 3, which exhibits hues of blue to green to red, using an optical mask layer having a pattern of an AM screen tone with a screen ruling of 175 lines as shown in FIG. 1 and FIG. 2, a halftone dot-like hue change as shown in FIG. 4 may appear. The halftone dot-like hue change is visually recognized as a hue in which a plurality of hues are mixed, that is, a hue having low chroma saturation, and a hue having high chroma saturation is not obtained.

On the other hand, for example, in a case where an optical mask layer having finer halftone dots is formed using a high-definition printing method such as an ink jet sheet-fed printing method, a laser printer method, or a laser photoplotter method and is used for forming a decorative film, a halftone dot-like hue change does not appear and a hue having high chroma saturation is obtained. However, in such a high-definition printing method, only a short optical mask layer of several meters or less can be formed, so in order to form a long decorative film, it is necessary to bond a large number of short optical mask layers together, and thus, it has been found that there is a problem of poor manufacturing efficiency.

In the present disclosure, in view of the above-described phenomenon, it has been found that the difference in light transmittance between the halftone dots and the halftone dot-halftone dot gaps in the optical mask layer and the amount of diffusion of the photosensitive chiral agent are factors that cause the appearance of the halftone dot-like hue change and a decrease in the chroma saturation. In a case where the photosensitive chiral agent in the cholesteric liquid crystal layer is irradiated with light through the optical mask layer, the light is blocked in portions of the halftone dots, and the light is transmitted in portions of gaps between the halftone dots, so that the photoreaction of the photosensitive chiral agent proceeds to a large extent in the portions of gaps. That is, a difference in helical twisting power of the photosensitive chiral agent occurs depending on the difference in light transmittance between the halftone dot portions and the gap portions. The photosensitive chiral agent diffuses within the cholesteric liquid crystal layer depending on the viscosity or the temperature, so the difference in helical twisting power gradually approaches uniformity as the diffusion and mixing of the photoreacted photosensitive chiral agent and the unreacted photosensitive chiral agent progresses, but in a case where the difference in light transmittance is large relative to the amount of diffusion, the uniformity will not proceed sufficiently, and the difference in helical twisting power will remain in the form of halftone dots and appear as a hue change. In addition, the larger the size of a single halftone dot in an in-plane direction relative to the diffusion distance of the photosensitive chiral agent in an in-plane direction, the greater the amount of diffusion required for uniformity of the helical twisting power, so that the halftone dot-like hue change is likely to occur as the halftone dots are coarser. Further, it has been found that, since a halftone dot having a frequency modulation (FM) screen tone is a halftone dot method that controls a printing density by a density of halftone dots, a plurality of halftone dots are connected in a medium-density printing region to form a single halftone dot having a size several times larger in an in-plane direction, so that a halftone dot-like hue change is likely to occur.

On the other hand, in the manufacturing method of the present disclosure, by setting the halftone dot form to have an AM screen tone, the halftone dots can be arranged at equal intervals, thereby making it possible to prevent the connection of halftone dots at a medium density, and to suppress the halftone dot-like hue change. Further, by printing a semi-translucent solid region having a print area ratio of 99.5% or more and a light transmittance of 5% or more and less than 95% at a position overlapping with the halftone dotted region of the first pattern, an optical mask layer in which a difference in light transmittance between the halftone dot portions and the gap portions is controlled can be prepared, so that a decorative film having high chroma saturation can be manufactured. In addition, by setting the screen ruling to 250 lines or less, a long optical mask layer can be realized, so that a long decorative film can be efficiently produced.

Hereinafter, an example of a suitable embodiment of the manufacturing method of a laminate of the present disclosure will be described with reference to the accompanying drawings.

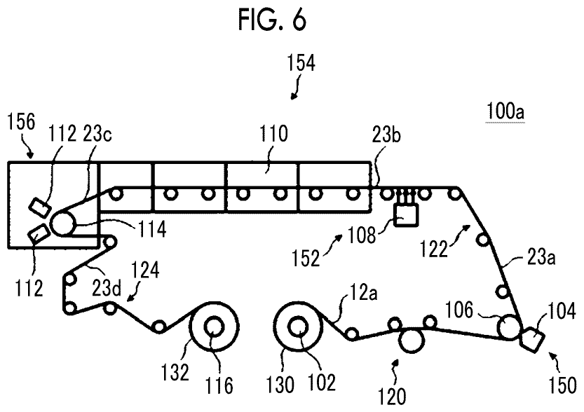

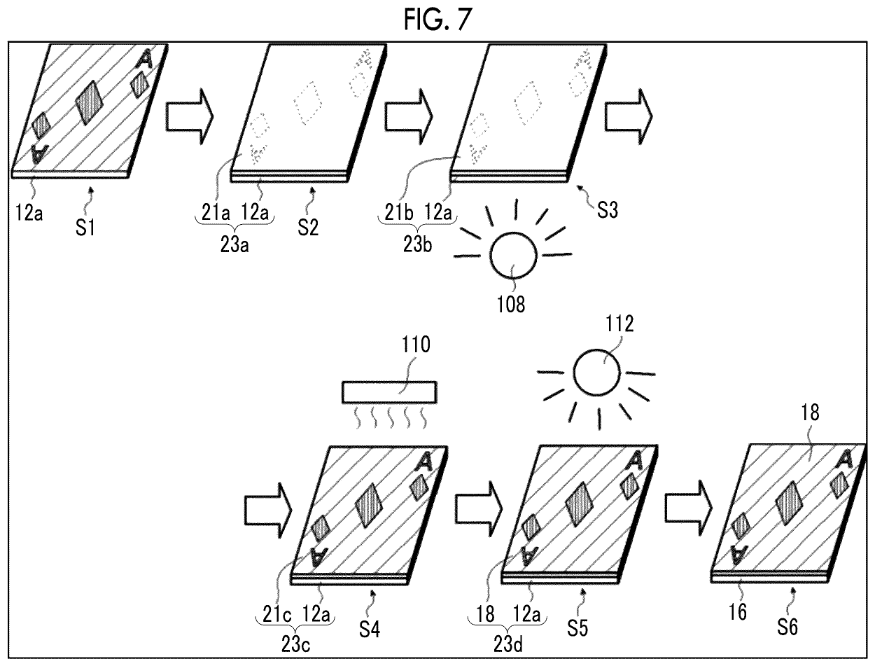

FIG. 6 is a schematic view showing an example of a manufacturing device of a laminate (hereinafter, also referred to as a “manufacturing device”) that carries out the manufacturing method of a laminate of the present disclosure (hereinafter, also referred to as the “manufacturing method of the present disclosure”). In addition, FIG. 7 is a schematic view for describing an example of the manufacturing method of a laminate carried out by the manufacturing device shown in FIG. 6.

It should be noted that the drawings in the present disclosure are schematic views, and the sizes of the respective parts, the thickness relationships and positional relationships of the respective layers, and the like do not necessarily match the actual ones. The same applies to the following drawings.

A manufacturing device 100a shown in FIG. 6 manufactures a liquid crystal film by roll-to-roll (hereinafter, also referred to as “RtoR”) using a long substrate 12a. As is well known, RtoR refers to a manufacturing method in which an object to be treated is fed out from a roll formed by winding a long object to be treated and is subjected to a treatment such as film formation while being transported in a longitudinal direction, and the treated object to be treated is wound again into a roll.

As an example, the manufacturing device 100a has a feed roller 102, a first transport unit 120, an application unit 150, a second transport unit 122, an exposure unit 152, a heating unit 154, a curing unit 156, a third transport unit 124, and a winding roller 116. The first transport unit 120, the second transport unit 122, and the third transport unit 124 each have transport rollers and the like and transport a long object to be treated along a predetermined path.

In addition to the members shown in the drawing, the manufacturing device 100a may have various members which are provided in a known device that carries out film formation by application while transporting a long object to be treated, such as a transport roller pair, a guide member for a substrate, and various sensors.

In the manufacturing device 100a, a roll 130 formed by winding the long substrate 12a is loaded into the feed roller 102.

The substrate 12a is pulled out from the roll 130 and is inserted into a predetermined path that passes through the first transport unit 120, the application unit 150, the second transport unit 122, the exposure unit 152, the heating unit 154, the curing unit 156, and the third transport unit 124 to reach the winding roller 116.

In addition, the prepared liquid crystal composition that will be formed into a cholesteric liquid crystal layer is supplied to an application nozzle 104 of the application unit 150 to carry out application.

In the manufacturing device 100a using RtoR, the feeding of the substrate 12a from the roll 130 and the winding of the substrate 12a (laminated film 23d) on which a cholesteric liquid crystal layer 18 is formed are carried out in synchronization. As a result, while the long substrate 12a is transported in a longitudinal direction along a predetermined transport path, the prepared liquid crystal composition in the application unit 150 is applied to the substrate 12a, the coating film is exposed in the exposure unit 152, the coating film is heated in the heating unit 154 to align liquid crystals, and the coating film is cured in the curing unit 156 by carrying out ultraviolet irradiation and/or heating to form the cholesteric liquid crystal layer 18. Further, the long laminated film 23d, in which the cholesteric liquid crystal layer 18 is formed on the substrate 12a, is wound into a roll on the winding roller 116 to form a roll 132.

In the present disclosure, the liquid crystal film is a film-like material having a cholesteric liquid crystal layer, and in the examples shown in FIG. 6 and FIG. 7, the laminated film 23d in which the cholesteric liquid crystal layer 18 is laminated on the surface of the substrate 12a is the liquid crystal film of the present disclosure. The cholesteric liquid crystal layer 18 may be used in a state of being laminated on the substrate 12a, or may be used after being peeled off from the substrate 12a.

In the feeding step shown in FIG. 6, the substrate 12a fed from the roll 130 is a resin film such as a PET film on which a pattern mask is formed, as shown in S1 of FIG. 7.

Various known sheet-like materials having transparency that are used as basal plates (substrates) can be used as the resin film forming the substrate 12a. Specific basal plates will be described later.

In the present disclosure, such a film having a layer (film) exhibiting a required function, such as an alignment layer, a protective layer, an adhesive layer, a light reflecting layer, an antireflection layer, a light shielding layer, a planarizing layer, a buffer layer, a stress relaxing layer, or a release layer, formed on a surface thereof may be used as the substrate 12a.

### Step of Providing Optical Mask Layer on Substrate

The manufacturing method of the present disclosure includes a step of providing an optical mask layer on a substrate. In the step of providing the optical mask layer on the substrate, two or more printed patterns (hereinafter, also referred to as patterns) including a first pattern formed by printing using a first ink and a second pattern formed by printing using a second ink are provided. The printed pattern is a pattern formed by disposing an ink from a single ink cartridge, ink tank, toner, or similar ink source. For example, in a case where, as in a liquid electrophotographic method, ink is disposed on a transfer roll from toners of two or more colors, and then two or more colors of ink are disposed on the substrate from the transfer roll at one time, the printed pattern is divided for each color and is not affected by the number of times the ink is disposed on the substrate. In addition, in a case where, in a gravure printing method, one type of ink is used for two or more printing plates, there are two types of patterns formed by disposing the ink, so the patterns are classified for each printing plate. Here, the first ink and the second ink each refer to ink of one color, and the first ink and the second ink may be the same as or different from each other.

The ink may be an oil-based ink, an aqueous ink, or an ultraviolet (UV) curable ink.

In addition, the color and composition of the ink are not particularly limited, and any known ink can be used.

From the viewpoint of controlling the amount of photoreaction of the photosensitive chiral agent, it is preferable that the ink absorbs or reflects light to be applied in the step of subjecting the photosensitive chiral agent to a photoreaction.

Further, in a case where the optical mask layer is used as a colored layer in a decorative film, it is preferable to form the optical mask layer using multicolored inks as appropriate depending on a desired design in the decorative film.

The optical mask layer includes a printed pattern having an AM screen tone. The printed pattern having an AM screen tone is a printing method of controlling a printing density in a gradational manner by changing an area ratio of halftone dots arranged at equal intervals in an in-plane direction. The screen ruling indicates the number of halftone dots arranged per inch, and as the screen ruling is higher, the resolution is higher and the interval between the halftone dots is narrower.

The first pattern has a halftone dotted region, and a halftone dot area ratio of the halftone dotted region is 0.5% or more and less than 99.5%, preferably 5% or more and less than 95%, and more preferably 10% or more and less than 90%. Since the hue exhibited by the decorative film changes depending on the halftone dot area ratio of the halftone dotted region, the color range exhibited by the decorative film can be expanded by setting the halftone dot area ratio within the above range.

From the viewpoint of increasing the number of hue change portions of the decorative film and improving the designability, the first pattern preferably has two or more halftone dotted regions and more preferably three or more halftone dotted regions. From the viewpoint of increasing the number of colors in the decorative film, it is preferable that these portions have different halftone dot area ratios.

The first pattern may have a region in which the halftone dot area ratio changes in a gradation manner depending on the desired hue pattern of the decorative film.

The halftone dot area ratio of the halftone dotted region is a ratio of the halftone dot area per unit area expressed as a percentage. The halftone dot area ratio of the halftone dotted region can be measured by measuring the size of halftone dots and the interval between the halftone dots using a microscope, and calculating the ratio of the halftone dot area from the halftone dot area per unit lattice and the area of the unit lattice.

The first pattern is a pattern having an AM screen tone with a screen ruling of 250 lines or less, with the screen ruling being preferably 230 lines or less and more preferably 210 lines or less. The smaller the screen ruling is, the less likely the printing unevenness occurs. Therefore, by setting the screen ruling within the above range, the loss due to the printing unevenness can be reduced, which is preferable. Further, from the viewpoint that the printing speed can be increased as the screen ruling is smaller, it is preferable to set the screen ruling within the above range. From the viewpoint of ease of diffusion of the photoreacted photosensitive chiral agent, the screen ruling is preferably 100 lines or more and more preferably 175 lines or more.

It is preferable that the first pattern further has at least one region of a semi-translucent solid region or a region having a print area ratio of less than 0.5%.

The semi-translucent solid region refers to a region in the printed pattern in which the print area ratio is 99.5% or more and the light transmittance is 5% or more and less than 95%, and may be a part of a printed pattern having an AM screen tone or may be a part of a two-tone printed pattern.

In addition, the semi-translucent solid region is preferably a region in the printed pattern in which the print area ratio within at least 300 μm square is 99.5% or more and the light transmittance is 5% or more and less than 95%.

The print area ratio is preferably a print area ratio within 300 μm square. The print area ratio within 300 μm square is an area ratio of a region in the printed pattern where ink is present within 300 μm square (a square with each side of 300 μm).

The light transmittance of the optical mask layer indicates a transmittance to light to be applied in the step of subjecting the photosensitive chiral agent to a photoreaction.

The region having a print area ratio of less than 0.5% is a region in the printed pattern in which the area ratio of a region where ink is present is less than 0.5%.

The second pattern is printed using a second ink on the pattern that overlaps with the halftone dotted region of the first pattern. The second pattern has a semi-translucent solid region having a print area ratio of 99.5% or more and a light transmittance of 5% or more and less than 95%. Here, the semi-translucent solid region is the same as the semi-translucent solid region of the first pattern described above.

In addition, the second pattern is preferably a semi-translucent solid region in which the print area ratio within at least 300 μm square is 99.5% or more and the light transmittance is 5% or more and less than 95%.

From the viewpoint of preventing the halftone dots of the first pattern from interfering with the second pattern and creating a new moire-like pattern, it is preferable that an entire region of the halftone dotted region of the first pattern overlaps with the semi-translucent solid region of the second pattern, or the second pattern further has a region having a print area ratio of less than 0.5%, and the entire region of the halftone dotted region of the first pattern overlaps with the semi-translucent solid region of the second pattern and the region of the second pattern having a print area ratio of less than 0.5%. Here, the region having a print area ratio of less than 0.5% is the same as the region having a print area ratio of less than 0.5% in the first pattern described above.

From the viewpoint of finely controlling the hue change of the cholesteric liquid crystal layer, it is preferable that the second pattern further has a halftone dotted region. Here, the halftone dotted region is the same as the halftone dotted region of the first pattern described above.

From the viewpoint of suppressing the halftone dot-like hue change of the cholesteric liquid crystal layer by reducing the difference in light transmittance between the halftone dot portions and the halftone dot-halftone dot gap portions and reducing the difference in amount of the reaction of the photosensitive chiral agent, it is preferable that the entire region of the halftone dotted region of the first pattern overlaps with the semi-translucent solid region of the second pattern.

From the viewpoint of suppressing the halftone dot-like hue change of the cholesteric liquid crystal layer, the difference in light transmittance between the halftone dot portions and the halftone dot-halftone dot gap portions is preferably 95% or less, more preferably 60% or less, still more preferably 40% or less, and particularly preferably 30% or less.

It is preferable that the step of providing an optical mask layer on a substrate further includes printing a pattern different from the first pattern and the second pattern on the substrate, in which the pattern different from the first pattern and the second pattern has at least one region of a semi-translucent solid region or a region having a print area ratio of less than 0.5%, and the at least one region of the semi-translucent solid region or the region having a print area ratio of less than 0.5% of the pattern different from the first pattern and the second pattern overlaps with the entire region of the halftone dotted region of the first pattern and the entire region of the halftone dotted region of the second pattern.

From the viewpoint of more finely controlling the hue change of the cholesteric liquid crystal layer, it is preferable that the pattern different from the first pattern and the second pattern further has a halftone dotted region.

It is preferable that the pattern different from the first pattern and the second pattern is a pattern having an AM screen tone with a screen ruling of 250 lines or less.

The pattern different from the first pattern and the second pattern is formed by further printing a pattern different from the first pattern and the second pattern on the substrate in addition to printing the first pattern and printing the second pattern.

From the viewpoint of achieving multi-gradation as the number of patterns increases and being able to reduce the difference in light transmittance between the halftone dot portions and the gap portions, the pattern different from the first pattern and the second pattern preferably includes a plurality of patterns, and each of the plurality of patterns is a different pattern. The plurality of patterns are formed by printing a pattern on a substrate a plurality of times or by printing a pattern on a medium a plurality of times and then transferring the pattern from the medium onto a substrate. The medium may be, for example, a transfer roller called a blanket, which is made of resin or rubber. It is preferable that the plurality of patterns are formed by further printing a pattern on the substrate one to five times in addition to printing the first pattern and printing the second pattern, or printing a pattern on the medium one to five times and then transferring the pattern onto the substrate, and it is more preferable that the plurality of patterns are formed by further printing a pattern three to five times in addition to printing the first pattern and printing the second pattern. By printing a pattern a plurality of times in addition to printing the first pattern and printing the second pattern, the difference in light transmittance between the halftone dot portions and the gap portions can be controlled more finely, and the suppression of the graininess of the decorative film is more excellent.

In a case where halftone dotted regions of different patterns overlap with each other, halftone dots are connected to each other to form halftone dots of a larger size, making the graininess more easily visible, so it is preferable that the halftone dotted region of the first pattern, the halftone dotted region of the second pattern, and the halftone dotted region of the pattern different from the first pattern and the second pattern do not overlap with each other; and in a case where the pattern different from the first pattern and the second pattern is a plurality of patterns, it is preferable that the halftone dotted regions of each of the plurality of patterns do not overlap with each other.

From the viewpoint of production efficiency, the printing method is preferably a printing method capable of carrying out long-length printing of 100 meters or more on a film substrate consisting of a resin material. Examples of the printing method include a liquid electrophotographic method, a gravure printing method, and an ink jet rotary printing method. From the viewpoint of resolution and registration of a plurality of printed patterns, the liquid electrophotographic method is more preferable.

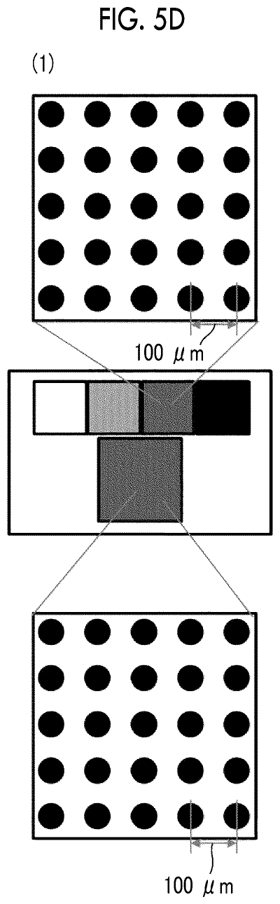

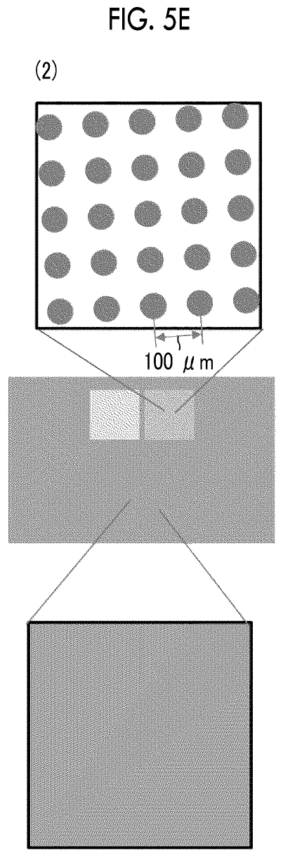

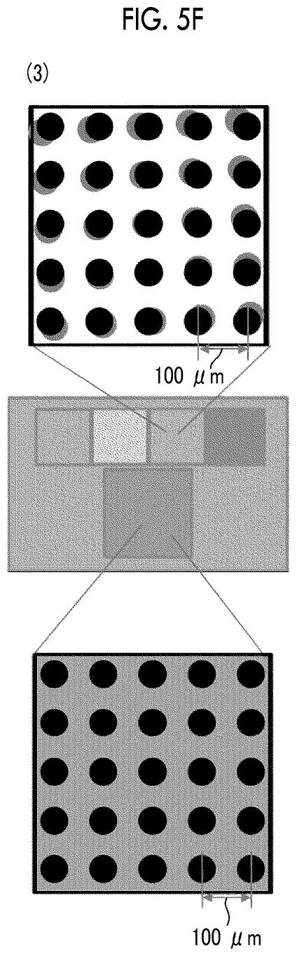

Here, an example of the first and second patterns in the present disclosure will be described with reference to FIG. 5A to FIG. 5F. FIG. 5A to FIG. 5C each show an optical mask layer at (3) in a case where the first pattern is at (1) and the second pattern is at (2). The color strength in the figure indicates the low light transmittance per 300 μm square, and the closer to black the region is, the lower the light transmittance per 300 μm square. FIG. 5D to FIG. 5F are each an enlarged view of a part of each of the pattern and the optical mask layer shown in FIG. 5A to FIG. 5C. In the first pattern shown in FIG. 5D (1), the diameter of the halftone dot is 27.8 μm and the interval between the halftone dots is 100 μm, so the halftone dot area ratio can be calculated as 24% and the pattern is considered to have a halftone dotted region. Further, the second pattern shown in FIG. 5E (2) has a semi-translucent solid region having a print area ratio of 100% and a light transmittance of 50%. As shown in FIG. 5F (3), a part of the semi-translucent solid region of the second pattern is formed at a position overlapping with the halftone dotted region of the first pattern.

The optical mask layer is preferably in direct contact with the substrate.

### (Substrate)

Examples of the substrate include a substrate used for molding such as three-dimensional molding and insert molding. From the viewpoint of ease of molding and chipping resistance, the substrate is preferably a resin substrate, and preferably a resin film.

Examples of the resin include polyethylene terephthalate (PET), polyethylene naphthalate (PEN), an acrylic resin, a urethane resin, a urethane-acrylic resin, polycarbonate (PC), acrylic-polycarbonate, polyolefin, triacetyl cellulose (TAC), a cycloolefin polymer (COP), and an acrylonitrile/butadiene/styrene copolymer (ABS resin).

From the viewpoint of moldability and strength, the substrate is preferably a resin film containing at least one resin selected from the group consisting of polyethylene terephthalate, an acrylic resin, a urethane resin, a urethane-acrylic resin, polycarbonate, acrylic-polycarbonate, and polypropylene, more preferably a resin film containing at least one resin selected from the group consisting of polyethylene terephthalate, an acrylic resin, polycarbonate, and an acrylic-polycarbonate resin, and most preferably polyethylene terephthalate.

The substrate may have a monolayer structure or a multilayer structure. Examples of the preferred laminated film include an acrylic resin/polycarbonate resin laminated film.

The substrate may contain an additive, as necessary. Examples of the additive include a lubricant such as a mineral oil, a hydrocarbon, a fatty acid, an alcohol, a fatty acid ester, a fatty acid amide, a metal soap, a natural wax, or silicone, an inorganic flame retardant such as magnesium hydroxide or aluminum hydroxide, an organic flame retardant such as a halogen-based flame retardant or a phosphorus-based flame retardant, an organic or inorganic filler such as metal powder, talc, calcium carbonate, potassium titanate, glass fiber, carbon fiber, or wood powder, an additive such as an antioxidant, an ultraviolet inhibitor, a glidant, a dispersant, a coupling agent, a foaming agent, or a colorant, and an engineering plastic other than the above-mentioned resins, such as a polyolefin, polyester, polyacetal, polyamide, or polyphenylene ether resin.

The substrate may be a commercially available product. Examples of the commercially available product of the substrate include TECHNOLLOY (registered trademark) series (acrylic resin film or acrylic resin/polycarbonate resin laminated film, Sumitomo Chemical Co., Ltd.), ABS films (Okamoto Industries., Inc.), ABS sheets (Sekisui Seikei Co., Ltd.), TEFLEX (registered trademark) series (PET film, Teijin Film Solutions Limited), LUMIRROR (registered trademark) easily moldable type (PET film, Toray Industries., Inc.), PURETHERMO (polypropylene film, Idemitsu Unitech Co., Ltd.), and COSMOSHINE (registered trademark) series (PET film, Toyobo Co., Ltd.).

In a case where the thickness of the substrate is too thin, the support properties are deteriorated and bending or the like may occur during transportation. On the other hand, in a case where the thickness of the substrate is too thick, the flexibility is deteriorated, making it difficult to transport and increasing the size in a case of being wound into a roll, or it may be difficult to peel off the formed cholesteric liquid crystal layer from the support substrate 12a. From the above viewpoints, the thickness of the substrate is preferably 1 μm or more, more preferably 10 μm or more, still more preferably 20 μm or more, and particularly preferably 50 μm or more. The thickness of the substrate is preferably 500 μm or less, more preferably 450 μm or less, and particularly preferably 200 μm or less.

### (Step of Providing Liquid Crystal Layer Containing Liquid Crystal Compound and Photosensitive Chiral Agent)

The manufacturing method of the present disclosure includes a step of providing a liquid crystal layer containing a liquid crystal compound and a photosensitive chiral agent on a side of the substrate opposite to the optical mask layer.

The liquid crystal layer is preferably a cholesteric liquid crystal layer.

As shown in FIG. 6, the substrate 12a fed from the roll 130 passes through the first transport unit 120 and reaches the application unit 150. In the application unit 150, the substrate 12a is subjected to a coating treatment. In the example shown in FIG. 6, in a case where the application is carried out in the application unit 150, the liquid crystal composition is applied onto the substrate 12a by the application nozzle 104 in a state where the substrate 12a is wound around a backup roller 106. In a case where the application is carried out by a method that allows the application without the backup roller 106, such as bar coating, the backup roller 106 may not be provided.

As shown in S2 of FIG. 7, in the coating step, the application nozzle 104 in FIG. 6 applies the liquid crystal composition containing a cholesteric liquid crystal compound and a photosensitive chiral agent onto the surface of the substrate 12a to form a coating film 21a. The laminate of the substrate 12a and the coating film 21a is referred to as a laminated film 23a.

The preferred liquid crystal compound and photosensitive chiral agent are the same as the liquid crystal compound and the photosensitive chiral agent contained in the cholesteric liquid crystal layer of the decorative film which will be described later.

The coating method in the coating step may be a roll coating method, a gravure printing method, or a spin coating method. The composition may be applied by a wire bar coating method, an extrusion coating method, a direct gravure coating method, a reverse gravure coating method, or a die-coating method. The composition may be applied using an ink jet device. In the coating method using an ink jet device, the composition may be jetted from a nozzle.

In addition, the coating film 21a is formed on the surface opposite to the optical mask layer. That is, the optical mask layer is formed on a surface (rear surface) of the substrate 12a opposite to the surface on which the coating film 21a is formed.

Step of Irradiating Liquid Crystal Layer with Light Through Optical Mask Layer to Subject Photosensitive Chiral Agent to Photoreaction

The manufacturing method of the present disclosure includes a step of irradiating a liquid crystal layer with light through an optical mask layer to subject the photosensitive chiral agent to a photoreaction.

As shown in FIG. 6, the laminated film 23a passes through the second transport unit 122 and reaches the exposure unit 152. In the exposure unit 152, the laminated film 23a is subjected to an irradiating step.

As shown in S3 of FIG. 7, in the irradiating step, an exposure device 108 irradiates the coating film 21a in an undried state with light from the substrate 12a side, that is, through the optical mask layer. The light applied by the exposure device 108 is light having a wavelength to which the photosensitive chiral agent in the coating film 21a (liquid crystal composition) is sensitive. Therefore, an exposed coating film 21b is formed by an exposure treatment. In the exposed coating film 21b, the photosensitive chiral agent is photosensitized, causing a structural change thereof and consequently resulting in a change in helical twisting power.

The laminate of the substrate 12a and the exposed coating film 21b is referred to as a laminated film 23b.

Here, the exposed coating film 21b is irradiated with light in an irradiation amount different for each region in accordance with the light transmittance of each region of the optical mask layer.

The amount of change in the structural change due to the photosensitization of the photosensitive chiral agent varies depending on the irradiation amount. Therefore, in the exposed coating film 21b, the amount of change in the helical twisting power of the photosensitive chiral agent varies from region to region depending on the transmittance of the optical mask layer.

The wavelength of light used for the exposure may be set depending on the type of the photosensitive chiral agent and the like.

In addition, the irradiation amount of light may also be set depending on the type of the photosensitive chiral agent, the light transmittance of the pattern mask, and the like.

Next, as shown in FIG. 6, the laminated film 23b is transported and reaches the heating unit 154. In a heating device 110, the coating film of the laminated film 23b is dried and subjected to an alignment treatment.

As shown in S4 of FIG. 7, in the aligning step, the liquid crystal compound in the coating film 21b is aligned by heating the exposed coating film 21b with the heating device 110. The heat treatment results in the formation of a coating film 21c in which the liquid crystal compound is aligned according to the structure of the chiral agent.

Here, as described above, in the coating film 21c, the structure in which a length of a helical pitch of a cholesteric liquid crystalline phase varies depending on the exposure amount is formed. Since the selective reflection wavelength in the cholesteric liquid crystalline phase depends on the pitch of the helical structure in the cholesteric liquid crystalline phase, regions having different selective reflection wavelengths are formed.

The laminate of the substrate 12a and the aligned coating film 21c is referred to as a laminated film 23c.

Next, as shown in FIG. 6, it is preferable that the laminated film 23c is transported and reaches the curing unit 156, where the laminated film 23c is subjected to a curing treatment.

As shown in S5 of FIG. 7, in the curing step, the curing unit 112 cures the aligned coating film 21c in a state where the laminated film 23c is wound around a backup roller 114 to form the cholesteric liquid crystal layer 18. As a result, a liquid crystal film having the cholesteric liquid crystal layer 18 is produced. The laminate of the substrate 12a and the cholesteric liquid crystal layer 18 is referred to as a laminated film 23d.

A known curing method such as photocuring by irradiation with light such as ultraviolet rays or thermal curing by heating can be used as the method of curing the coating film 21c.

In a case where the curing is carried out by irradiation with light, it is preferable that the coating film 21c is irradiated with light from the surface side opposite to the optical mask layer.

Next, it is preferable that the produced liquid crystal film (laminated film 23d) passes through the third transport unit 124 and is wound into a roll on the winding roller 116 to form a roll 132.

Since the cholesteric liquid crystal layer of the produced liquid crystal film has a configuration in which regions having different selective reflection wavelengths are formed depending on the transmittance of the optical mask layer, each region reflects light having a selective reflection wavelength, so that an image having a corresponding hue can be displayed.

Here, in the example shown in FIG. 6, the configuration is made such that the produced liquid crystal film is wound into a roll, but the present disclosure is not limited thereto, and the configuration may also be made to have a cutting unit that cuts the produced liquid crystal film into a predetermined size.

In addition, in a case where the method of curing the coating film in the curing step is photocuring, the wavelength of light to be applied in the curing step is preferably a wavelength different from the wavelength of light to be applied in the step of subjecting the photosensitive chiral agent to a photoreaction, and the wavelength of light to be applied in the step of subjecting the photosensitive chiral agent to a photoreaction is preferably longer than the wavelength of light to be applied in the curing step. Specifically, the wavelength of light to be applied in the step of subjecting the photosensitive chiral agent to a photoreaction is preferably a wavelength to which the photosensitive chiral agent is sensitive and a wavelength at which a polymerization initiator is not cleaved.

By using different wavelengths of light to be applied in the curing step and the step of subjecting the photosensitive chiral agent to a photoreaction, it is possible to suppress the coating film from being cured due to irradiation with light in the step of subjecting the photosensitive chiral agent to a photoreaction, and it is possible to set the amount of change in the pitch of the helical structure of the liquid crystal compound to a desired amount of change.

The wavelength of light to be applied in the step of subjecting the photosensitive chiral agent to a photoreaction may be selected from the wavelength to which the photosensitive chiral agent is sensitive, depending on the type of the photosensitive chiral agent. Specifically, the wavelength of light to be applied in the irradiating step is preferably 350 nm to 400 nm. That is, it is preferable to use a chiral agent that is sensitive to light in this wavelength range.

In addition, the irradiation amount of light to be applied in the step of subjecting the photosensitive chiral agent to a photoreaction may be set to an irradiation amount that results in a desired selective reflection wavelength, depending on the type of the photosensitive chiral agent and the like.

The wavelength of light to be applied in the curing step may be selected depending on the type of the polymerization initiator or the like. Specifically, the wavelength of light to be applied in the curing step is preferably 300 nm to 350 nm. That is, it is preferable to use a polymerization initiator capable of initiating a polymerization reaction in this wavelength range.

In addition, the irradiation amount of light to be applied in the curing step may be set depending on the type of the polymerization initiator or the like.

In addition, in the example shown in FIG. 6, the configuration has been made in which the irradiation with light is carried out once in the step of subjecting the photosensitive chiral agent to a photoreaction, but it may also be possible to adopt a configuration in which the irradiation with light is carried out twice or more times in a divided manner. For example, a configuration in which the step of subjecting the photosensitive chiral agent to a photoreaction includes a first irradiating step and a second irradiating step may be adopted.

By configuring the irradiation with light in the step of subjecting the photosensitive chiral agent to a photoreaction to be carried out twice or more times in a divided manner, the structural change of the photosensitive chiral agent due to the exposure can be more suitably adjusted, and the desired selective reflection wavelength can be achieved.

In addition, in the first irradiating step and the second irradiating step, a configuration may be adopted in which the peak wavelengths of light to be applied are different from each other.

By setting the peak wavelength of light in the first irradiating step to a wavelength shifted from the peak wavelength of light to which the photosensitive chiral agent is sensitive, and matching the peak wavelength of light in the second irradiating step with the peak wavelength of light to which the photosensitive chiral agent is sensitive, the irradiation amount of light can be substantially adjusted.

Specifically, for example, in a case where the light absorption peak wavelength of the photosensitive chiral agent is 365 nm and the spectrum has a base in a wavelength range of 250 nm to 450 nm, the irradiation amount of light can be substantially adjusted by irradiation with light having a wavelength of 265 nm in the vicinity of the base in the first irradiating step and irradiation with light having a peak wavelength of 365 nm in the second irradiating step.

In addition, in the example shown in FIG. 6, the configuration has been made in which the prepared liquid crystal film is wound into the roll 132 immediately after the formation of the cholesteric liquid crystal layer 18, but a step of bonding a protective film or the like to the surface of the cholesteric liquid crystal layer 18 may be provided before the prepared liquid crystal film is wound into the roll 132.

Here, in the examples shown in FIG. 6 and FIG. 7, the configuration has been made in which one cholesteric liquid crystal layer 18 is formed on the substrate 12a, but the present disclosure is not limited thereto, and it may also be possible to adopt a configuration in which a combination of the coating step, the irradiating step, the aligning step, and the curing step is carried out twice or more times to form two or more cholesteric liquid crystal layers.

For example, it may also be possible to adopt a configuration in which a substrate on which a cholesteric liquid crystal layer having a right-handed helix is formed is supplied again to the manufacturing device as an object to be treated to form a cholesteric liquid crystal layer having a left-handed helix on the cholesteric liquid crystal layer. Alternatively, the manufacturing device may be configured to have two or more combinations of an application unit, an exposure unit, a heating unit, and a curing unit between the feed roller and the winding roller in the transport direction of the substrate.

By adopting a configuration in which two or more cholesteric liquid crystal layers are formed, the hue of the two or more cholesteric liquid crystal layers can be changed using the same optical mask layer, and the patterns of the two or more cholesteric liquid crystal layers can be matched with high positional accuracy.

### Other Steps

The manufacturing method of the present disclosure may further include a peeling step of peeling the optical mask layer and the substrate from the laminate. The peeling step can be carried out, for example, by transferring the liquid crystal layer onto another film through a pressure-sensitive adhesive sheet (G25, manufactured by NEION Film Coatings Corp.).

### <Laminate>

A first embodiment of the laminate of the present disclosure includes, in the following order, an optical mask layer, a substrate, and a cholesteric liquid crystal layer containing a liquid crystal compound and a photosensitive chiral agent, in which the optical mask layer has a halftone dotted region having an AM screen tone with a screen ruling of 250 lines or less and a halftone dot area ratio of 0.5% or more and less than 99.5%. In addition, the first embodiment of the laminate of the present disclosure has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

A second embodiment of the laminate of the present disclosure includes, in the following order, an optical mask layer, a substrate, and a cholesteric liquid crystal layer containing a liquid crystal compound and a photosensitive chiral agent, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}−T_{D}<80.75% is satisfied.

In the present specification, unless otherwise specified, the term “laminate of the present disclosure” or simply “laminate” is used to refer to both the above-described first embodiment and the above-described second embodiment.

In addition, the laminate of the present disclosure is preferably a laminate manufactured by the manufacturing method of a laminate of the present disclosure.

### (Optical Mask Layer)

The optical mask layer can be produced in the same manner as the optical mask layer described above in the manufacturing method of a laminate. The light transmittance of the optical mask layer of the present disclosure indicates a transmittance to light to be applied in the step of subjecting the photosensitive chiral agent to a photoreaction.

The light transmittance T_{D} of the halftone dots in the halftone dotted region indicates a ratio, expressed as a percentage, of an amount of light that has transmitted through the halftone dots and entered the cholesteric liquid crystal layer relative to an amount of light that has entered the halftone dots. For example, the light transmittance T_{D} of the halftone dots can be measured using a microspectrophotometer whose measurement area is smaller than the area of the halftone dots, such that T_{D} is defined as the light transmittance per 10 μmΦ within the halftone dots (that is, within a circle with a diameter of 10 μm) measured using a micro UV-visible-near infrared spectrophotometer MSV-5500.

In addition, the light transmittance T_{A} of the gaps between the halftone dots indicates a ratio, expressed as a percentage, of an amount of light that has transmitted through the gaps between the halftone dots and entered the cholesteric liquid crystal layer relative to an amount of light that has entered the gaps between the halftone dots. Similar to the light transmittance of the halftone dots, the light transmittance T_{A} of the gaps between the halftone dots can be measured by measuring the light transmittance per 10 μmΦ in the gaps using a microspectrophotometer.

The portion of the optical mask layer having a lowest light transmittance is a portion having a lowest light transmittance per 10 μmΦ, and can be measured by, for example, a microspectrophotometer after narrowing down a measurement position to a portion having a relatively low transmittance by visual observation and microscopic observation. The portion of the optical mask layer having a highest light transmittance is a portion having a highest light transmittance per 10 μmΦ, and can be measured by, for example, a microspectrophotometer after narrowing down a measurement position to a portion having a relatively high transmittance by visual observation and microscopic observation.

In the first embodiment of the laminate of the present disclosure, in the halftone dotted region, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ) is 0.95 or less.

By setting (T_{A}−T_{D})/(T_{MAX}−Tₘᵢₙ) to 0.95 or less, the difference in the amount of photoreaction of the photosensitive chiral agent between the halftone dot portions and the gap portions can be reduced, the hue change of the cholesteric liquid crystal layer due to the difference in helical twisting power can be suppressed, and the chroma saturation can be improved.

In the second embodiment of the laminate of the present disclosure, from the viewpoint of improving the chroma saturation of the entire decorative film, (T_{A}−T_{D})/(T_{MAX}-Tₘᵢₙ) is preferably 0.95 or less in all halftone dotted regions of the optical mask layer.

Further, in the laminate of the present disclosure, (T_{A}−T_{D})/(T_{MAX}−Tₘᵢₙ) is preferably 0.50 or less and more preferably 0.30 or less in all halftone dotted regions of the optical mask layer. By setting (T_{A}−T_{D})/(T_{MAX}−Tₘᵢₙ) within the above range, the halftone dot-like hue change in the cholesteric liquid crystal layer can be reduced, and the graininess can be suppressed.

In the laminate of the present disclosure, (T_{A}−T_{D})/(T_{MAX}−Tₘᵢₙ) is preferably 0.03 or more, from the viewpoint of obtaining a decorative film rich in color change by controlling the light transmittance of the halftone dotted region.

The second embodiment of the laminate of the present disclosure has, in the halftone dotted region, a region in which, in a case where a light transmittance of the halftone dots is defined as T_{D} and a light transmittance of gaps between the halftone dots is defined as T_{A}, 5%≤ T_{A}<95% is satisfied and 1%≤T_{A}−T_{D}<80.75% is satisfied.

By setting T_{A}−T_{D} to less than 80.75%, the difference in the amount of photoreaction of the photosensitive chiral agent between the halftone dot portions and the gap portions can be reduced, the hue change of the cholesteric liquid crystal layer due to the difference in helical twisting power can be suppressed, and the chroma saturation can be improved. By setting T_{A}−T_{D} to 1% or more, the light transmittance of the halftone dotted region can be controlled, and a decorative film rich in color change can be obtained.

In the first embodiment of the laminate of the present disclosure, it is preferable that 1%≤T_{A}−T_{D}<80.75% is satisfied from the viewpoint of improving the chroma saturation of the entire decorative film.

Further, in the laminate of the present disclosure, T_{A}−T_{D} is preferably 60% or less, more preferably 50% or less, and particularly preferably 30% or less, from the viewpoint that the halftone dot-like hue change of the cholesteric liquid crystal layer can be reduced and the graininess can be suppressed. In addition, T_{A}-T_{D} is preferably 3% or more and more preferably 5% or more, from the viewpoint of obtaining a decorative film rich in color change.

The substrate is the same as the substrate described above in the manufacturing method of a laminate, and a preferred substrate is also the same.

The liquid crystal layer contains a liquid crystal compound and a photosensitive chiral agent, and the preferred liquid crystal compound and photosensitive chiral agent are the same as the liquid crystal compound and the photosensitive chiral agent contained in the cholesteric liquid crystal layer of the decorative film which will be described later.

The laminate of the present disclosure is preferably a decorative film.

<Substrate with Optical Mask for Manufacturing Decorative Film>

A first embodiment of the substrate with an optical mask for manufacturing a decorative film of the present disclosure includes a substrate and an optical mask layer, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

A second embodiment of the substrate with an optical mask for manufacturing a decorative film of the present disclosure includes a substrate and an optical mask layer, in which the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}−T_{D}><80.75% is satisfied.

In the present specification, unless otherwise specified, the term “substrate with an optical mask for manufacturing a decorative film of the present disclosure” or simply “substrate with an optical mask for manufacturing a decorative film” is used to refer to both the above-described first embodiment and the above-described second embodiment.

The substrate and the optical mask layer included in the substrate with an optical mask for manufacturing a decorative film are the same as the substrate and the optical mask layer of the above-mentioned laminate, and the preferred substrate and the preferred optical mask layer are also the same.

In addition, the first embodiment of the substrate with an optical mask for manufacturing a decorative film of the present disclosure corresponds to the first embodiment of the laminate of the present disclosure, and the second embodiment of the substrate with an optical mask for manufacturing a decorative film of the present disclosure corresponds to the second embodiment of the laminate of the present disclosure.

### <Decorative Film>

A first embodiment of the decorative film of the present disclosure is a decorative film including a cholesteric liquid crystal layer having a halftone dot region in which maximum points of a cholesteric pitch are arranged in a halftone dot-like manner. Then, in a case where the halftone dot region is divided into unit lattices which are quadrangles having a smallest area with the maximum point as a vertex, with respect to an intra-lattice pitch difference APS which is a difference between a maximum value and a minimum value of a cholesteric pitch in each of unit lattices, a maximum value ΔP_{S(MAX)} of APS in the entire halftone dotted region satisfies ΔP_{S(MAX)}/ΔPₐₗₗ≤0.4 with respect to a difference ΔPₐₗₗ between the maximum value and the minimum value of the cholesteric pitch in the entire cholesteric liquid crystal layer.

A second embodiment of the decorative film of the present disclosure is a decorative film including a cholesteric liquid crystal layer, in which the cholesteric liquid crystal layer has a halftone dot region in which maximum points of a cholesteric pitch are arranged in a halftone dot-like manner, and in a case where the halftone dot region is divided into unit lattices which are quadrangles having a smallest area with the maximum point of the cholesteric pitch as a vertex, and a difference between a maximum value and a minimum value of a cholesteric pitch in each of unit lattices is defined as an intra-lattice pitch difference ΔP_{S}, ΔP_{S(MAX)}, which is a maximum value of the ΔP_{S}, is less than 33 nm in the cholesteric liquid crystal layer.

In the present specification, unless otherwise specified, the term “decorative film of the present disclosure” or simply “decorative film” is used to refer to both the above-described first embodiment and the above-described second embodiment.

It is preferable that the above-described halftone dot region is a region in which maximum points of a cholesteric pitch are arranged in a halftone dot-like manner at equal intervals of 100 μm or more and less than 300 μm.

In addition, the preferred aspect of the above-described halftone dot region is the same as that of the above-described halftone dotted region, except that the above-described halftone dot region is formed in the cholesteric liquid crystal layer and is an aspect which will be described later.

The manufacturing method of a decorative film of the present disclosure is preferably a method including the manufacturing method of a laminate of the present disclosure.

In addition, the decorative film of the present disclosure may be the laminate itself manufactured by the manufacturing method of a laminate of the present disclosure, may be the above-mentioned laminate from which the substrate and the optical mask layer are removed, or may be the above-mentioned laminate from which the optical mask layer is removed.

For example, the above-described optical mask layer can also be a colored layer or the like in the decorative film of the present disclosure.

The cholesteric liquid crystal layer reflects incident light in a wavelength-selective manner to exhibit a hue corresponding to the wavelength of the reflected light. With regard to the hue exhibited by the cholesteric liquid crystal layer, a desired hue can be obtained by changing a helical pitch of a cholesteric liquid crystal compound.

In a case where the cholesteric liquid crystal layer has a plurality of cholesteric pitches within a minute region of about 100 μm square, the cholesteric liquid crystal layer reflects light having a plurality of wavelengths, and the visually recognized reflection spectrum is equivalent to an average of spectra of a plurality of reflection wavelengths. Therefore, a half-width of a reflectance peak of the visually recognized reflection spectrum can be increased as compared with a case of having a uniform cholesteric pitch. An increase or decrease in the half-width of the reflectance peak in the reflection spectrum significantly affects the chroma saturation. For example, in a case where the half-width is wider than an appropriate half-width, the hue approaches white and the chroma saturation decreases; on the other hand, in a case where the half-width is narrower than an appropriate half-width, the hue approaches black and the chroma saturation decreases.

In the present disclosure, it has been found that the chroma saturation can be increased by setting a maximum value ΔP_{S(MAX)} of a pitch difference between the cholesteric pitches within a unit lattice within a range of 0<ΔP_{S(MAX)}/ΔPₐₗₗ≤0.4.

In this regard, in a case where the pitch difference between the cholesteric pitches is provided within the unit lattice, the graininess may be visible. The visibility of the graininess is more easily recognized as the pitch difference between the cholesteric pitches within the unit lattice is larger, and the visibility of the graininess is less recognized as the color range of the entire decorative film is larger. For example, in a case where the decorative film has a color range of blue to green to red (a hue angle range of) 270°, a color difference of blue-green to green (a hue angle range of) 45° due to the pitch difference between the cholesteric pitches within the unit lattice is low in visibility. On the other hand, in a case where the decorative film has, for example, a color range of blue to green (a hue angle range of) 90°, a color difference of blue-green to green (a hue angle range of) 45° within the unit lattice is high in visibility. Further, it has been found that arranging the maximum points at equal intervals in a halftone dot-like manner of AM screen tone is also important for suppressing the graininess, since an increase in visually recognized color difference can be suppressed by such a configuration.

Therefore, in the present disclosure, it is possible to realize a multicolor decorative film with high chroma saturation and suppressed occurrence of the graininess by setting the maximum value ΔP_{S(MAX)} of the pitch difference between the cholesteric pitches within the unit lattice to satisfy ΔP_{S(MAX)}/ΔPₐₗₗ≤0.4 with respect to the pitch difference between the cholesteric pitches in the entire decorative film and further arranging the maximum points at equal intervals of 100 μm or more and less than 300 μm in a halftone dot-like manner of AM screen tone.

It is preferable that the cholesteric liquid crystal layer has a cholesteric pitch change of 13 nm or more per a distance of 100 μm in an in-plane direction, from the viewpoint that it is possible to realize a region with sharp boundaries between patterns as a decorative film. In a case of forming a decorative film with a design with sharp boundaries between patterns, that is, a cholesteric liquid crystal layer with a large rate of change in cholesteric pitch per distance in an in-plane direction, it is necessary to significantly change a helical twisting power of the photosensitive chiral agent or to suppress the diffusion of the photoreacted photosensitive chiral agent in an in-plane direction, which tends to deteriorate the visibility of the graininess. As in the case of the decorative film of the present disclosure, by setting the pitch difference ΔP_{S(MAX)} in the halftone dotted region to satisfy ΔP_{S(MAX)}/ΔPₐₗₗ≤0.4, even in a case where the rate of change in cholesteric pitch is the same, it is possible to suppress the deterioration of the visibility of the graininess and to achieve both a clear design and the suppression of the graininess.

In addition, in the second embodiment of the decorative film of the present disclosure, from the viewpoint of achieving high chroma saturation, suppressing the graininess, and obtaining a clear design, it is preferable that, with regard to the intra-lattice pitch difference APS which is a difference between a maximum value and a minimum value of a cholesteric pitch in each unit lattice, the maximum value ΔP_{S(MAX)} of APS in the entire halftone dotted region satisfies ΔP_{S(MAX)}/ΔPₐₗₗ≤0.4 with respect to the difference ΔPₐₗₗ between the maximum value and the minimum value of the cholesteric pitch in the entire cholesteric liquid crystal layer.

In the second embodiment of the decorative film of the present disclosure, ΔP_{S(MAX)} is less than 33 nm and preferably 13 nm or less. By setting ΔP_{S(MAX)} to less than 33 nm, the color difference due to the pitch difference between the cholesteric pitches can be reduced, the half-width of the reflectance peak of the visually recognized reflection spectrum can be increased, and the chroma saturation can be improved. In addition, by setting ΔP_{S(MAX)} to 13 nm or less, the visibility of the graininess is further reduced, and the glossiness is more excellent.

In the first embodiment of the decorative film of the present disclosure, ΔP_{S(MAX)} is preferably less than 33 nm and more preferably 13 nm or less. By setting ΔP_{S(MAX)} within the above range, the color difference due to the pitch difference between the cholesteric pitches is reduced, the visibility of the graininess is reduced, and the glossiness is more excellent, which is preferable.

In addition, ΔP_{S(MAX)} in the decorative film of the present disclosure is preferably 3.3 nm or more from the viewpoint of increasing the half-width of the reflectance peak of the visually recognized reflection spectrum and improving the chroma saturation.

ΔPₐₗₗ is preferably 70 nm or more from the viewpoint that the decorative film can express a wide color range from blue to green to red, and is more preferably 100 nm or more from the viewpoint that the decorative film can express a color range including an ultraviolet range or an infrared range, that is, colorlessness.

The upper limit of ΔPₐₗₗ is preferably 200 nm or less from the viewpoint that the color range for the decorative film is sufficient from an ultraviolet range to an infrared range.

The “reflection center wavelength” refers to an average value of a wavelength showing a maximum value Rₘₐₓ (%) of the reflectance and a wavelength showing a half-value reflectance R^{1/2} (%) in the reflection spectrum of light incident on the cholesteric liquid crystal layer. The reflectance is an integral reflectance and is a relative reflectance with respect to a white standard plate. The method of measuring the reflection center wavelength will be described later.

It is preferable that at least a part of the reflection center wavelength in the gradation region of the cholesteric liquid crystal layer is within a wavelength range of 380 nm to 780 nm.

The expression “at least a part of the reflection center wavelength is in a wavelength range of 380 nm to 780 nm” means that at least a part of the gradation region of the cholesteric liquid crystal layer has a reflection wavelength range in a visible light range (380 nm to 780 nm). That is, the cholesteric liquid crystal layer has a selective reflection property in which a selective reflection wavelength is present in a range of 380 nm to 780 nm. The term “selective reflection wavelength” refers to an average value of two wavelengths indicating a half-value transmittance (T12, unit: %) represented by the following expression, in a case where a minimum value of a transmittance in an object is defined as Tₘ (%).

Expression: Half-value transmittance T_{1/2}=100−(100−Tₘ)/2

Next, the cholesteric liquid crystal layer constituting the decorative film of the present disclosure will be described.

### (Cholesteric Liquid Crystal Layer)

The cholesteric liquid crystal layer is a layer containing at least a cholesteric liquid crystal compound. It is preferable that the cholesteric liquid crystal layer is a cured product (a cured layer; the same applies hereinafter) of a photocurable composition containing a cholesteric liquid crystal compound and a photosensitive chiral agent. The composition is cured, for example, by light or heat.

Examples of components of a composition or liquid crystal layer before curing that forms a cholesteric liquid crystal layer include a cholesteric liquid crystal compound, a photosensitive chiral agent, a chiral agent (including a photoisomerization compound) other than the photosensitive chiral agent, a polymerization initiator, a polymerizable monomer, a polyfunctional polymerizable compound, a crosslinking agent, a solvent, and an additive.

As the components of a composition or liquid crystal layer before curing that forms a cholesteric liquid crystal layer, it is preferable to contain a cholesteric liquid crystal compound and a photosensitive chiral agent, and it is more preferable to contain a cholesteric liquid crystal compound, a photosensitive chiral agent, and a polymerization initiator. In addition, as the components of the composition or liquid crystal layer before curing, other components such as a polymerization initiator, a polymerizable monomer, a polyfunctional polymerizable compound, a crosslinking agent, a solvent, and an additive may be further contained, as necessary.

The “cholesteric liquid crystal layer” is a layer having an alignment state of a molecule unique to a cholesteric liquid crystal. The alignment state may include an alignment state in which dextrorotatory circularly polarized light is reflected, an alignment state in which levorotatory circularly polarized light is reflected, or both of these alignment states. The alignment state may be fixed by a method such as polymerization or crosslinking.

Hereinafter, specific aspects of each component used in the cholesteric liquid crystal layer will be described.

### Cholesteric Liquid Crystal Compound

The cholesteric liquid crystal layer contains at least a cholesteric liquid crystal compound. The cholesteric liquid crystal layer may be a layer formed by curing a composition containing a cholesteric liquid crystal compound (or a liquid crystal layer in a case where the composition is formed into a liquid crystal layer). The type of the cholesteric liquid crystal compound is not limited. The cholesteric liquid crystal compound may be a known cholesteric liquid crystal compound.

The cholesteric liquid crystal compound preferably has a reactive group. The reactive group is preferably a polymerizable group. Examples of the polymerizable group include a radically polymerizable group and a cationically polymerizable group. From the viewpoint of reactivity and ease of fixing a helical pitch, the cholesteric liquid crystal compound preferably has a radically polymerizable group. The radically polymerizable group is preferably at least one polymerizable group selected from the group consisting of a vinyl group, an acryloyl group, and a methacryloyl group, and more preferably at least one polymerizable group selected from the group consisting of an acryloyl group and a methacryloyl group.

The cholesteric liquid crystal compound may have two or more reactive groups. The cholesteric liquid crystal compound may have two or more types of reactive groups.

The cholesteric liquid crystal compound may be a cholesteric liquid crystal compound having two or more types of reactive groups having different crosslinking mechanisms. The crosslinking mechanism may be a condensation reaction, hydrogen bonding, or polymerization. It is preferable that at least one of the crosslinking mechanisms of the two or more types of reactive groups is polymerization. The crosslinking mechanism preferably includes two or more types of polymerizations. Examples of the reactive group used in the crosslinking mechanism as described above include a vinyl group, a (meth)acryloyl group, an epoxy group, an oxetanyl group, a vinyl ether group, a hydroxy group, a carboxy group, and an amino group.

The cholesteric liquid crystal compound having two or more types of reactive groups having different crosslinking mechanisms may be a compound that can be crosslinked in stages. At each stage, a reactive group corresponding to the crosslinking mechanism of each stage reacts.

Examples of a method for crosslinking two or more types of reactive groups in stages include a method of changing reaction conditions in each stage. Examples of the change point of the reaction conditions include a temperature, a wavelength of light (irradiation), and a polymerization mechanism. It is preferable to use a difference in polymerization mechanism from the viewpoint of easy separation of reactions. The polymerization mechanism is controlled by, for example, the type of the polymerization initiator.

The combination of polymerizable groups is preferably a combination of a radically polymerizable group and a cationically polymerizable group. From the viewpoint of easy control of reactivity, it is preferable that the radically polymerizable group is a vinyl group or a (meth)acryloyl group and the cationically polymerizable group is an epoxy group, an oxetanyl group, or a vinyl ether group as for the combination of polymerizable groups.

In addition, the polymerizable group is preferably an ethylenically unsaturated group.

From the viewpoint of stretchability and heat resistance, the cholesteric liquid crystal compound preferably includes a cholesteric liquid crystal compound having one reactive group (preferably a polymerizable group). From the viewpoint of stretchability and heat resistance, the proportion of the content of the cholesteric liquid crystal compound having one reactive group with respect to the content of the cholesteric liquid crystal compound is preferably 96% by mass to 100% by mass, more preferably 97% by mass to 100% by mass, and preferably 98% by mass to 100% by mass.

From the viewpoint of stretchability and heat resistance, the cholesteric liquid crystal compound preferably includes a cholesteric liquid crystal compound having one reactive group and a cholesteric liquid crystal compound having two or more reactive groups. The cholesteric liquid crystal compound more preferably includes a cholesteric liquid crystal compound having one reactive group and a cholesteric liquid crystal compound having two reactive groups. From the viewpoint of stretchability and heat resistance, the ratio of the content of the cholesteric liquid crystal compound having two or more reactive groups to the content of the cholesteric liquid crystal compound having one reactive group is preferably 0 to 0.05, more preferably 0 to 0.04, and preferably 0 to 0.02, on a mass basis.

Specific examples of the reactive group are shown below. In this regard, the reactive group is not limited to the following specific examples. In the following specific examples, Et represents an ethyl group, and n-Pr represents an n-propyl group.

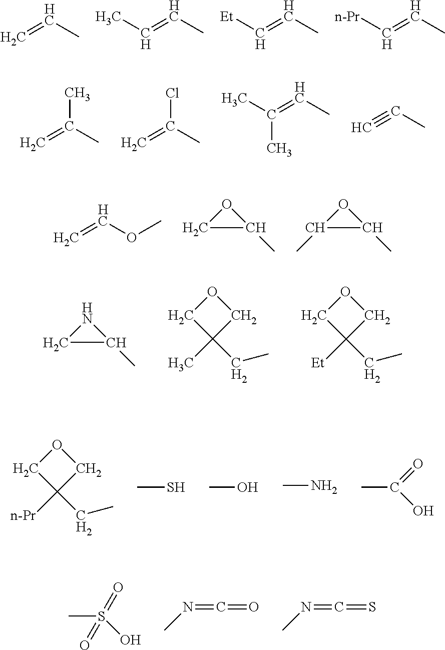

Examples of the cholesteric liquid crystal compound include a rod-like cholesteric liquid crystal compound and a disk-like cholesteric liquid crystal compound. The rod-like cholesteric liquid crystal compound may be a low-molecular-weight type compound or a polymer type compound. The disk-like cholesteric liquid crystal compound may be a low-molecular-weight type compound or a polymer type compound. In the present disclosure, the term “polymer” used for the cholesteric liquid crystal compound means a compound having a polymerization degree of 100 or more (Polymer Physics and Phase Transition Dynamics, written by Masao Doi, p. 2, Iwanami Shoten, Publishers, 1992). A mixture of two or more types of rod-like cholesteric liquid crystal compounds, a mixture of two or more types of disk-like liquid crystal compounds, or a mixture of a rod-like cholesteric liquid crystal compound and a disk-like cholesteric liquid crystal compound may be used. In two or more types of cholesteric liquid crystal compounds, it is preferable that at least one type of cholesteric liquid crystal compound has a reactive group.

The cholesteric liquid crystal compound is preferably a rod-like cholesteric liquid crystal compound. Examples of the rod-like cholesteric liquid crystal compound include azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles. Examples of the rod-like cholesteric liquid crystal compound also include a polymer of a rod-like cholesteric liquid crystal compound having a reactive group. Examples of the rod-like cholesteric liquid crystal compound also include compounds described in JP2008-281989A, JP1999-513019A (JP-H11-513019A), and JP2006-526165A.

Specific examples of the rod-like cholesteric liquid crystal compound are shown below. In this regard, the rod-like cholesteric liquid crystal compound is not limited to the following specific examples. The compounds shown below are synthesized, for example, by the method described in JP1999-513019A (JP-H11-513019A).

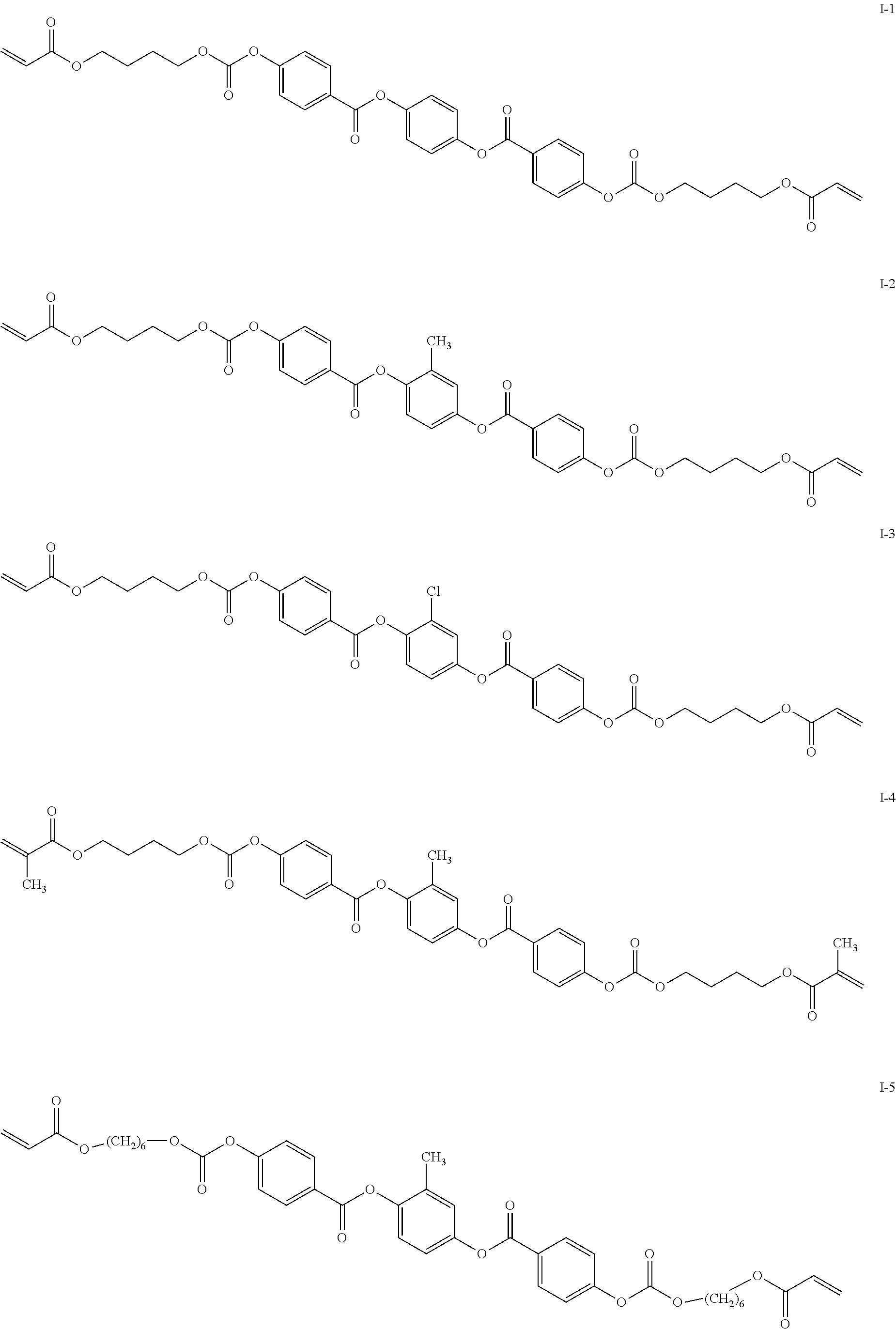

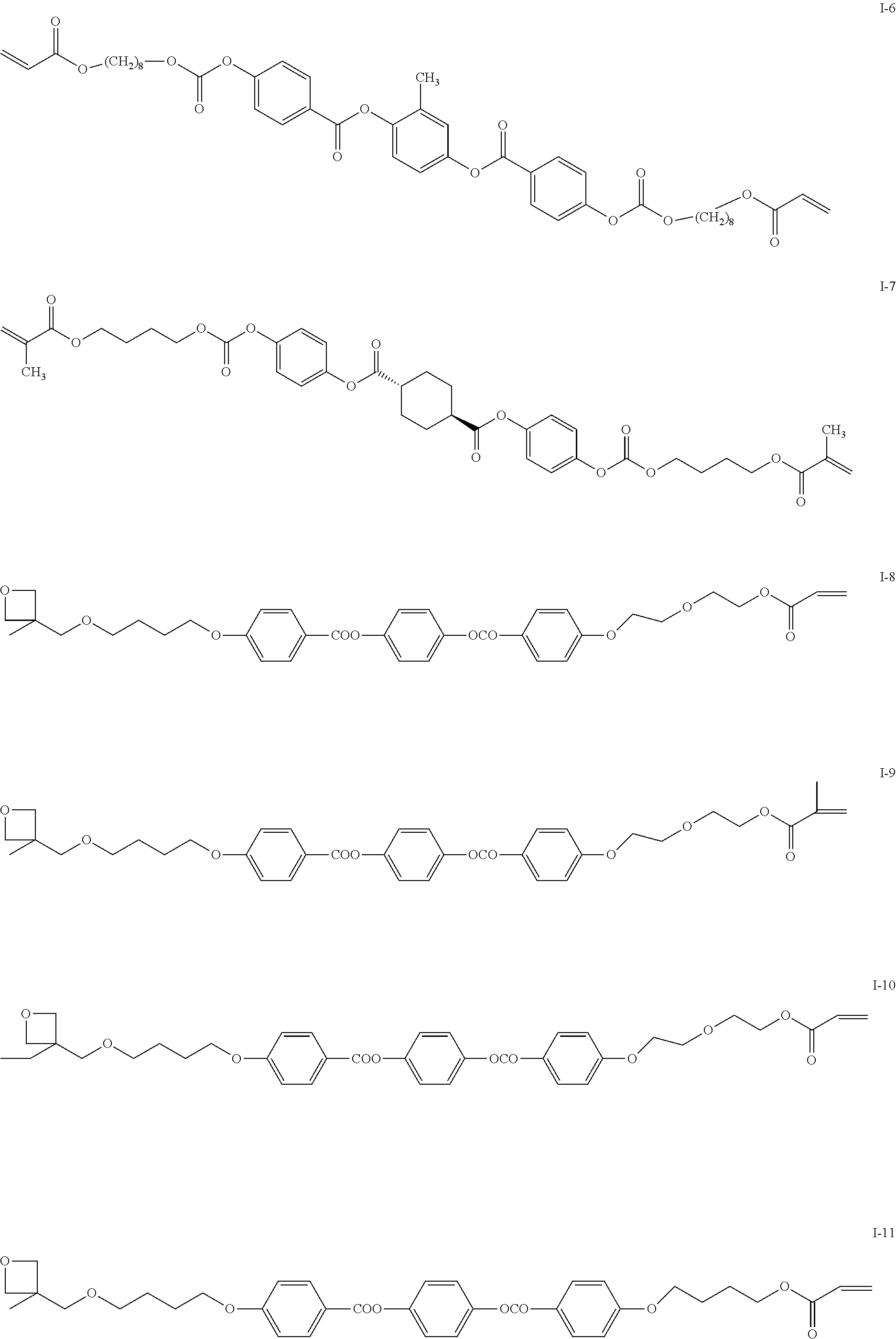

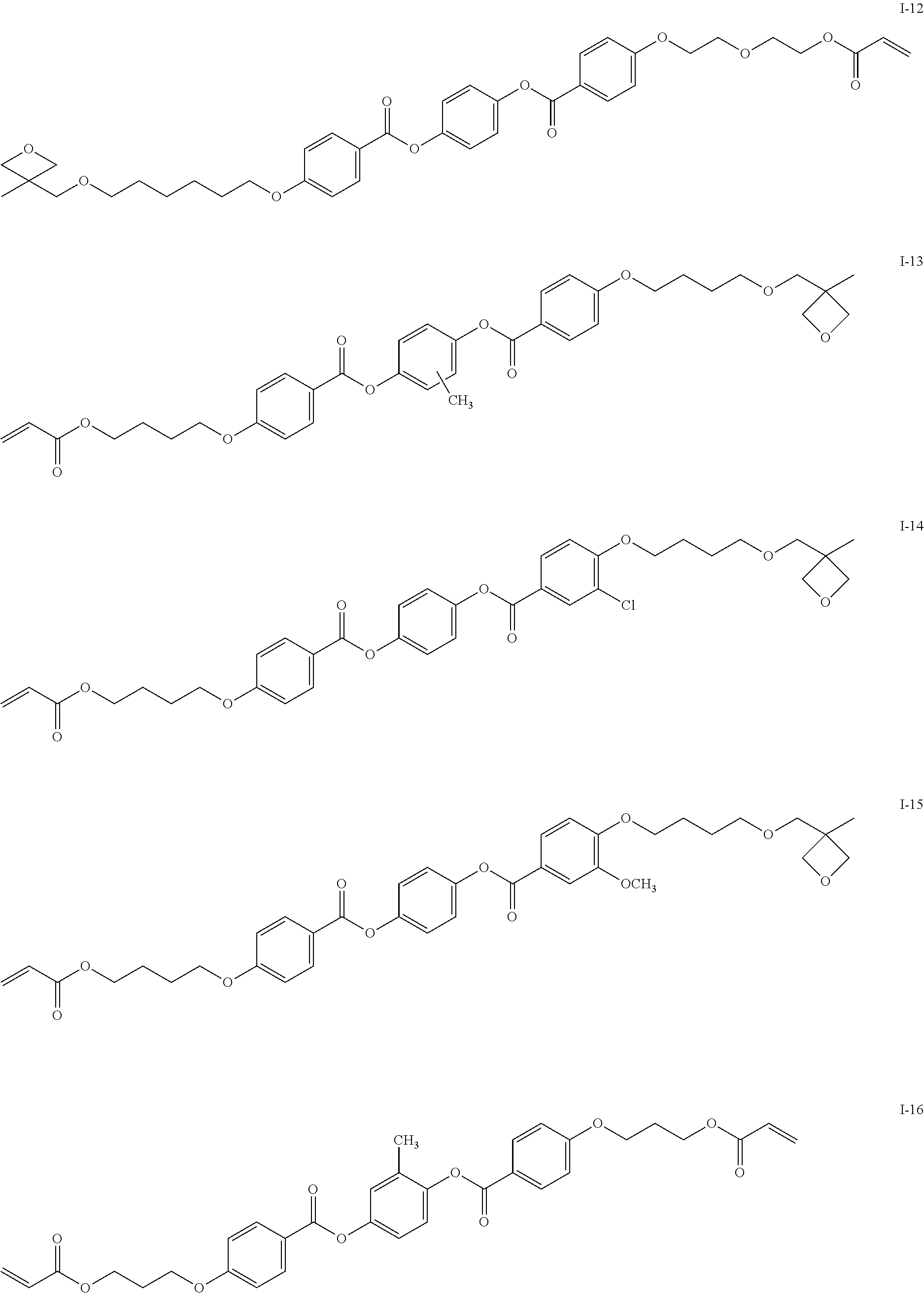

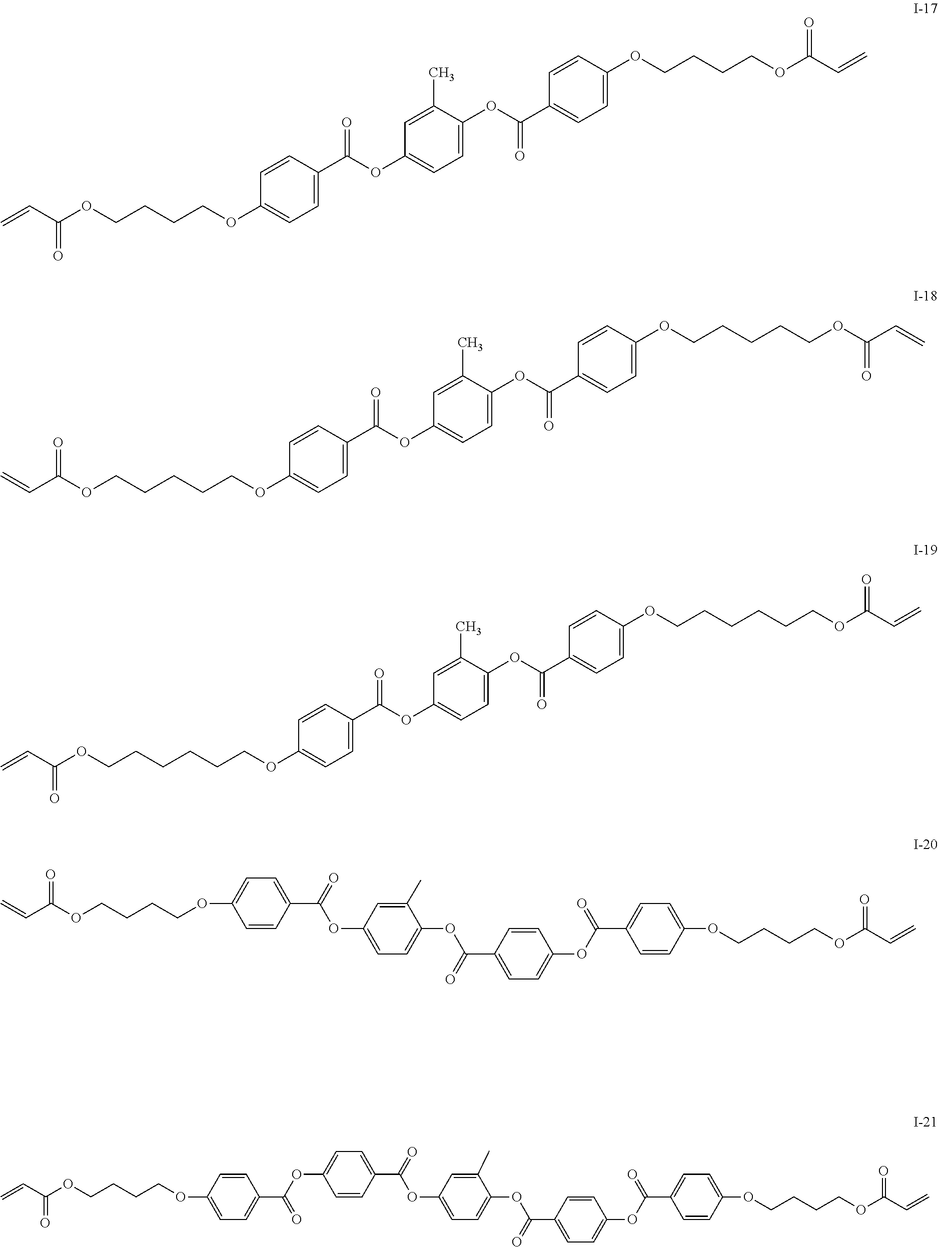

Examples of the rod-like cholesteric liquid crystal compound having one polymerizable group include the following compounds. “Me” in the following chemical formulae means a methyl group.

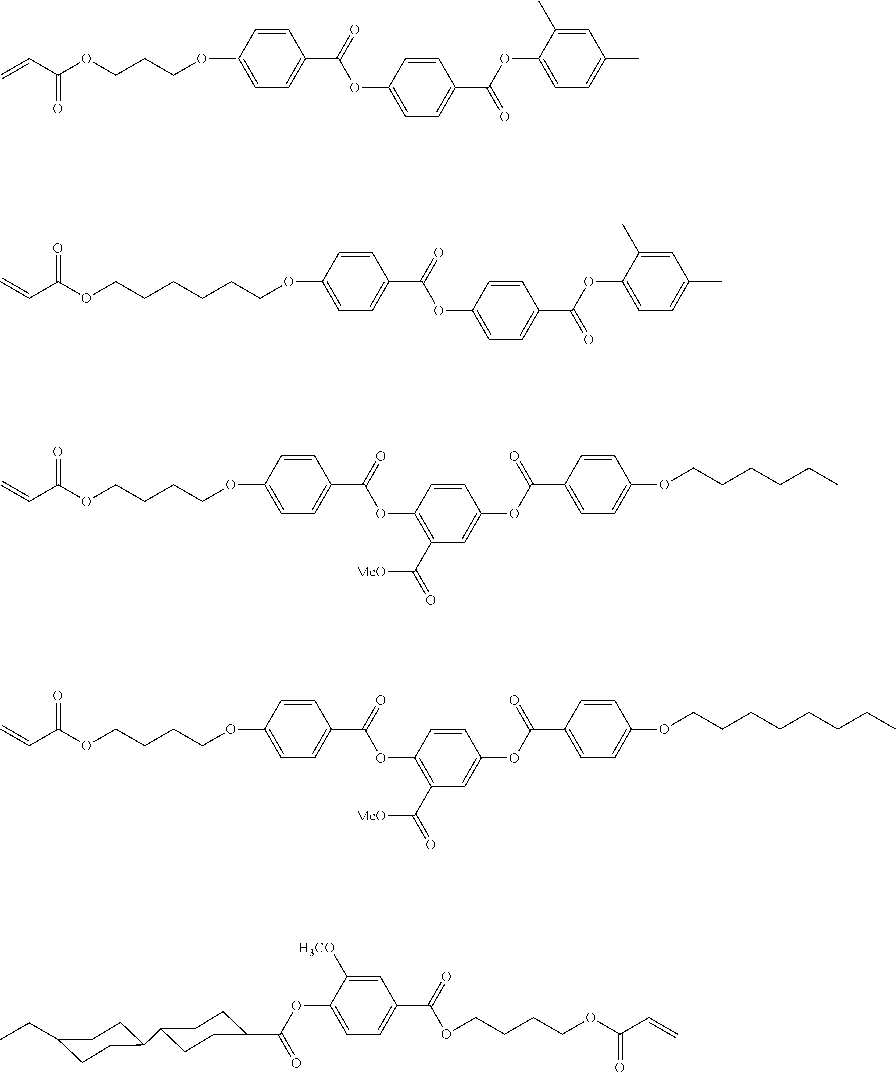

Examples of the disk-like cholesteric liquid crystal compound include the following compounds.
(1) Benzene derivatives described in a research report by C. Destrade et al., for example, Mol. Cryst. vol. 71, page 111 (1981)
(2) Truxene derivatives described in a research report by C. Destrade et al., for example, Mol. Cryst. vol. 122, p. 141 (1985) and Physics lett, A, vol. 78, p. 82 (1990)
(3) Cyclohexane derivatives described in a research report by B. Kohne et al., for example, Angew. Chem. vol. 96, p. 70 (1984)
(4) Azacrown-based or phenylacetylene-based macrocycles described in a research report by J. M. Lehn et al. (J. Chem. Commun., p. 1794 (1985)) and a research report by J. Zhang et al. (J. Am. Chem. Soc., vol. 116, p. 2655 (1994))

The disk-like cholesteric liquid crystal compound includes a liquid crystal compound, generally referred to as a disk-like liquid crystal, which has a structure in which the above-described various structures serve as a disk-like mother nucleus at the center of the molecule and groups such as a linear alkyl group, an alkoxy group, and a substituted benzoyloxy group are arranged in a radial manner, and which exhibits liquid crystallinity. In a case where an aggregate of such a compound is uniformly aligned, negative uniaxiality appears.

Examples of the disk-like cholesteric liquid crystal compound include the compounds described in paragraphs to of JP2008-281989A.

In the cholesteric liquid crystal layer, the disk-like cholesteric liquid crystal compound having a reactive group may be fixed in an alignment state such as horizontal alignment, vertical alignment, tilt alignment, or twisted alignment.

The cholesteric liquid crystal layer or the composition may contain one type of cholesteric liquid crystal compound or two or more types of cholesteric liquid crystal compounds.

The proportion of the content of the cholesteric liquid crystal compound with respect to the total mass of the cholesteric liquid crystal layer or the solid content of the composition is preferably 30% by mass to 99% by mass, more preferably 40% by mass to 99% by mass, still more preferably 60% by mass to 99% by mass, and particularly preferably 70% by mass to 98% by mass.

### Chiral Agent

The cholesteric liquid crystal layer contains a chiral agent (an optically active compound), particularly a photosensitive chiral agent. The chiral agent can induce a helical structure in a cholesteric liquid crystal compound. For example, the chiral agent can adjust a helical pitch. The chiral agent includes a photoisomerization compound, as will be described later.

The type of the chiral agent is not limited. The chiral agent may be any known chiral agent. The chiral agent may be selected depending on the desired helical structure. Examples of the chiral agent include the compounds described in Liquid Crystal Device Handbook (Chapter 3, Section 4-3, chiral agents for TN and STN, p. 199, edited by the 142nd Committee of Japan Society for the Promotion of Science, 1989), JP2003-287623A, JP2002-302487A, JP2002-80478A, JP2002-80851A, JP2010-181852A, and JP2014-034581A.

The chiral agent preferably has a cinnamoyl group.

The chiral agent preferably contains an asymmetric carbon atom. In this regard, the chiral agent may be an axially chiral compound or planar chiral compound which does not contain an asymmetric carbon atom. Examples of the axially chiral compound and the planar chiral compound include binaphthyl, helicene, paracyclophane, and derivatives thereof.

The chiral agent may have a reactive group. The reactive group is preferably a polymerizable group. The polymerizable group is preferably at least one polymerizable group selected from the group consisting of an ethylenically unsaturated group, an epoxy group, and an aziridinyl group, more preferably an ethylenically unsaturated group, and still more preferably at least one polymerizable group selected from the group consisting of an acryloyl group and a methacryloyl group. The chiral agent may have two or more reactive groups. The chiral agent may have two or more types of reactive groups.

From the viewpoint of stretchability and heat resistance, the chiral agent preferably includes a chiral agent having one polymerizable group. In a case where the chiral agent includes a chiral agent having one polymerizable group, the proportion of the content of the chiral agent having one polymerizable group with respect to the content of the chiral agent is preferably more than 0% by mass, more preferably 50% by mass or more, and still more preferably 70% by mass or more, from the viewpoint of stretchability and heat resistance. The upper limit of the proportion of the content of the chiral agent having one polymerizable group with respect to the content of the chiral agent may be 100% by mass. The proportion of the content of the chiral agent having one polymerizable group with respect to the content of the chiral agent may be 0% by mass to 100% by mass.

The composition for the cholesteric liquid crystal layer preferably contains a cholesteric liquid crystal compound having a polymerizable group and a photosensitive chiral agent having a polymerizable group. For example, the reaction between the photosensitive chiral agent having a polymerizable group and the cholesteric liquid crystal compound having a polymerizable group can form a polymer having a constitutional unit derived from the cholesteric liquid crystal compound having a polymerizable group and a constitutional unit derived from the photosensitive chiral agent having a polymerizable group. The type of the polymerizable group in the photosensitive chiral agent is preferably the same as the type of the polymerizable group in the cholesteric liquid crystal compound.

The chiral agent (optically active compound) may be a cholesteric liquid crystal compound.

From the viewpoint of ease of forming a cholesteric liquid crystal layer and ease of adjusting a helical pitch, the chiral agent used in the present disclosure includes a photoisomerization compound (photosensitive chiral agent) that also acts as the chiral agent. Examples of the photoisomerization compound that also acts as the chiral agent include a compound represented by Formula (CH1) which will be described later.

Preferred examples of the chiral agent include an isosorbide derivative, an isomannide derivative, and a binaphthyl derivative.

Specific examples of the chiral agent are shown below. In this regard, the chiral agent is not limited to the following specific examples.

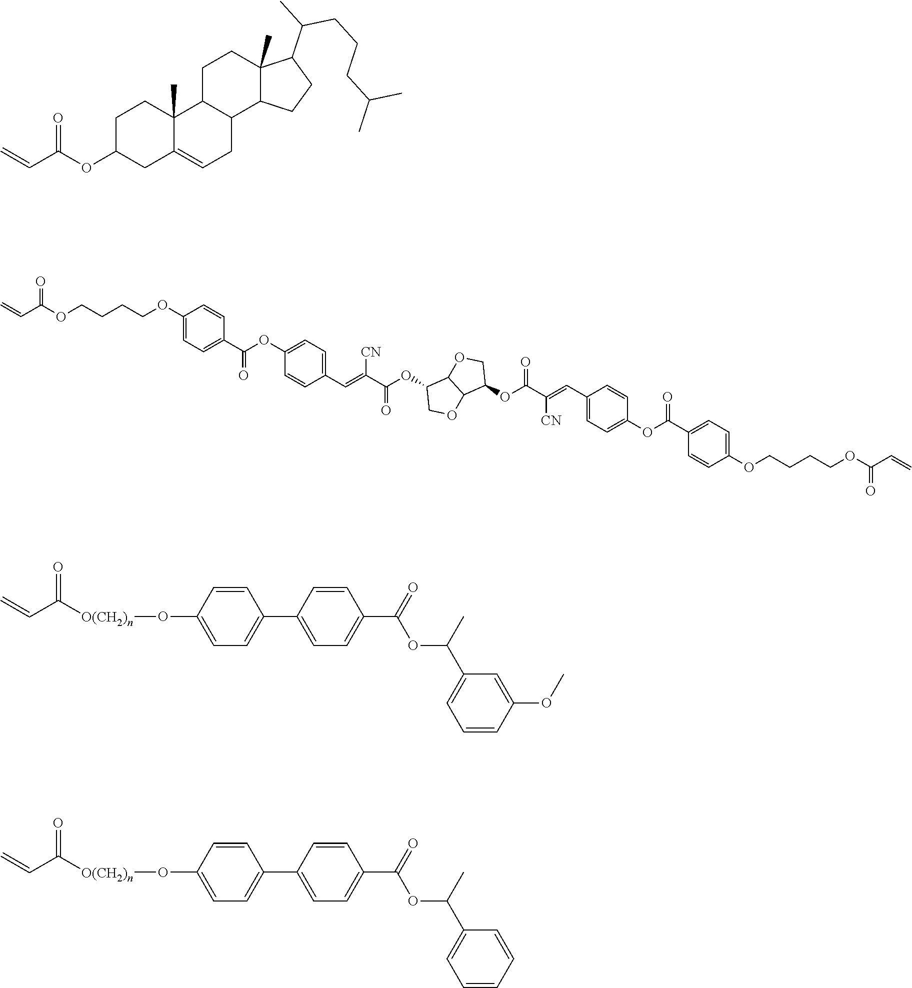

In the above chemical formulae, n represents an integer of 2 to 12. From the viewpoint of synthesis cost, n is preferably 2 or 4.

The cholesteric liquid crystal layer or the composition may contain one type of chiral agent or two or more types of chiral agents.

From the viewpoint of ease of forming a cholesteric liquid crystal layer and ease of adjusting a helical pitch, the proportion of the content of the chiral agent with respect to the total mass of the cholesteric liquid crystal layer or the solid content of the composition is preferably 1% by mass to 20% by mass, more preferably 2% by mass to 10% by mass, still more preferably 3% by mass to 9% by mass, and particularly preferably 4% by mass to 8% by mass.

The proportion of the content of the chiral agent having a polymerizable group with respect to the total mass of the cholesteric liquid crystal layer or the solid content of the composition is preferably 0.2% by mass to 15% by mass, more preferably 0.5% by mass to 10% by mass, and still more preferably 1% by mass to 8% by mass.

In addition, the proportion of the content of the chiral agent having no polymerizable group with respect to the total mass of the cholesteric liquid crystal layer or the solid content of the composition is preferably 0.2% by mass to 20% by mass and more preferably 0.5% by mass to 10% by mass.

The helical pitch, and the selective reflection wavelength and the range thereof are adjusted, for example, depending on not only the type of the cholesteric liquid crystal compound but also the content of the chiral agent. For example, in a case where the content of the chiral agent in the cholesteric liquid crystal layer is doubled, the helical pitch is halved, and the center value of the selective reflection wavelength is also halved.

### (Photoisomerization Compound)

The cholesteric liquid crystal layer or the composition may contain a photoisomerization compound.

The type of the photoisomerization compound is not limited. The photoisomerization compound may be any known photoisomerization compound. From the viewpoint of suppressing changes in reflectance after molding and maintaining an isomerization structure, a compound in which a steric structure changes by exposure is preferable.

The photoisomerization compound has a photoisomerization structure. From the viewpoint of suppressing changes in reflectance after molding, ease of photoisomerization, and maintenance of an isomerization structure, the photoisomerization compound preferably has a structure in which a steric structure changes by exposure, more preferably has a di- or higher substituted ethylenically unsaturated bond in which an EZ configuration is isomerized by exposure, and particularly preferably has a di-substituted ethylenically unsaturated bond in which an EZ configuration is isomerized by exposure. The isomerization of the EZ configuration includes cis-trans isomerization. The di-substituted ethylenically unsaturated bond is preferably an ethylenically unsaturated bond substituted with an aromatic group and an ester bond.

From the viewpoint of suppressing changes in reflectance after molding, ease of photoisomerization, and maintenance of an isomerization structure, it is preferable that the photoisomerization compound has two or more photoisomerization structures. The number of photoisomerization structures in the photoisomerization compound is preferably 2 to 4 and more preferably 2.

The photoisomerization compound is preferably a photoisomerization compound (photosensitive chiral agent) that also acts as the above-mentioned chiral agent. The photoisomerization compound that also acts as the chiral agent is preferably a chiral agent having a molar absorption coefficient of 30,000 or more at a wavelength of 313 nm.

Examples of the photoisomerization compound that also acts as the chiral agent include a compound represented by Formula (CH1). The compound represented by Formula (CH1) can change an alignment structure such as a helical pitch (twisting power or helical twisting angle) depending on the amount of light upon irradiation with light. In addition, the compound represented by Formula (CH1) is a compound in which an EZ configuration in two ethylenically unsaturated bonds can be isomerized by exposure.

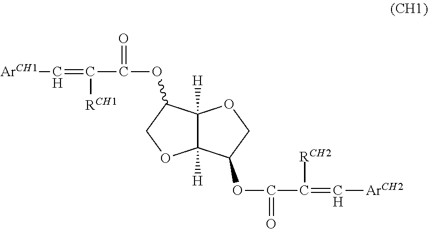

In Formula (CH1), Ar^{CH1} and Ar^{CH2} each independently represent an aryl group or a heteroaromatic ring group, and R^{CH1} and R^{CH2} each independently represent a hydrogen atom or a cyano group.

In Formula (CH1), it is preferable that Ar^{CH1} and Ar^{CH2} are each independently an aryl group. The aryl group may have a substituent. The substituent is preferably, for example, a halogen atom, an alkyl group, an alkenyl group, an alkynyl group, an alkoxy group, a hydroxy group, an acyl group, an alkoxycarbonyl group, an aryloxycarbonyl group, an acyloxy group, a carboxy group, a cyano group, or a heterocyclic group, and more preferably a halogen atom, an alkyl group, an alkenyl group, an alkoxy group, a hydroxy group, an acyloxy group, an alkoxycarbonyl group, or an aryloxycarbonyl group. The total number of carbon atoms in the aryl group is preferably 6 to 40 and more preferably 6 to 30.

It is preferable that Ar^{CH1} and Ar^{CH2} are each independently an aryl group represented by Formula (CH2) or Formula (CH3).

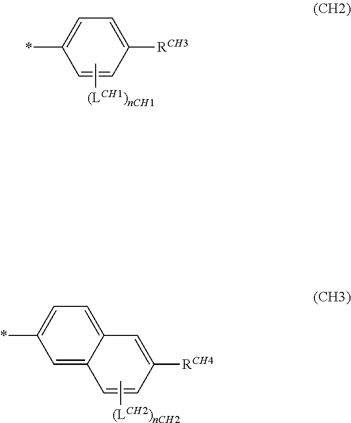

In Formula (CH2) and Formula (CH3), R^{CH3} and R^{CH4} each independently represent a hydrogen atom, a halogen atom, an alkyl group, an alkenyl group, an alkynyl group, an aryl group, a heterocyclic group, an alkoxy group, a hydroxy group, an acyl group, an alkoxycarbonyl group, an aryloxycarbonyl group, an acyloxy group, a carboxy group, or a cyano group, L^{CH1} and L^{CH2} each independently represent a halogen atom, an alkyl group, an alkoxy group, or a hydroxy group, nCH1 represents an integer of 0 to 4, nCH2 represents an integer of 0 to 6, and * represents a bonding position with the ethylenically unsaturated bond in Formula (CH1).

In Formula (CH2) and Formula (CH3), R^{CH3} and R^{CH4} are each independently preferably a hydrogen atom, a halogen atom, an alkyl group, an alkenyl group, an aryl group, an alkoxy group, a hydroxy group, an alkoxycarbonyl group, an aryloxycarbonyl group, or an acyloxy group, more preferably an alkoxy group, a hydroxy group, or an acyloxy group, and particularly preferably an alkoxy group.

In Formula (CH2) and Formula (CH3), L^{CH1} and L^{CH2} are each independently preferably an alkoxy group having 1 to 10 carbon atoms, or a hydroxy group.
nCH1 in Formula (CH2) is preferably 0 or 1.
nCH2 in Formula (CH3) is preferably 0 or 1.

The heteroaromatic ring group in Ar^{CH1} and Ar^{CH2} in Formula (CH1) may have a substituent. The substituent is preferably, for example, a halogen atom, an alkyl group, an alkenyl group, an alkynyl group, an aryl group, an alkoxy group, a hydroxy group, an acyl group, an alkoxycarbonyl group, an aryloxycarbonyl group, an acyloxy group, or a cyano group, and more preferably a halogen atom, an alkyl group, an alkenyl group, an aryl group, an alkoxy group, or an acyloxy group. The total number of carbon atoms in the heteroaromatic ring group is preferably 4 to 40 and more preferably 4 to 30. The heteroaromatic ring group is preferably a pyridyl group, a pyrimidinyl group, a furyl group, or a benzofuranyl group, and more preferably a pyridyl group or a pyrimidinyl group.

In Formula (CH1), it is preferable that R^{CH1} and R^{CH2} are each independently a hydrogen atom.

Preferred specific examples of the photoisomerization compound are shown below. In the following specific examples, Bu represents an n-butyl group. In the following compounds, the steric configuration of each ethylenically unsaturated bond is an E-form (trans-form), which changes to Z-form (cis-form) by exposure.

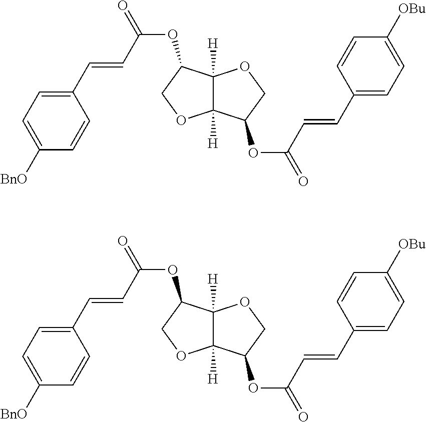

The cholesteric liquid crystal layer or the composition may contain one type of photoisomerization compound or two or more types of photoisomerization compounds.

The proportion of the content of the photosensitive chiral agent with respect to the total mass of the cholesteric liquid crystal layer or the solid content of the composition is preferably 1% by mass to 20% by mass, more preferably 2% by mass to 10% by mass, still more preferably 3% by mass to 9% by mass, and particularly preferably 4% by mass to 8% by mass.

### Polymerization Initiator

The cholesteric liquid crystal layer or the composition preferably contains a polymerization initiator.

The type of the polymerization initiator is not limited. The polymerization initiator may be a known polymerization initiator. The polymerization initiator is preferably a photopolymerization initiator. Examples of the photopolymerization initiator include an α-carbonyl compound (see, for example, U.S. Pat. Nos. 2,367,661A , 2,367,670A), an acyloin ether compound (see, for example, U.S. Pat. No. 2,448,828A), an α-hydrocarbon-substituted aromatic acyloin compound (see, for example, U.S. Pat. No. 2,722,512A), a polynuclear quinone compound (see, for example, U.S. Pat. Nos. 3,046,127A , 2,951,758A), a combination of a triarylimidazole dimer and p-aminophenyl ketone (see, for example, U.S. Pat. No. 3,549,367A), an acridine compound and a phenazine compound (see, for example, JP1985-105667A (JP-S60-105667A) and U.S. Pat. No. 4,239,850A), and an oxadiazole compound (see, for example, U.S. Pat. No. 4,212,970A).

Examples of the photopolymerization initiator include a photoradical polymerization initiator and a photocationic polymerization initiator. Preferred examples of the photoradical polymerization initiator include an α-hydroxyalkylphenone compound, an α-aminoalkylphenone compound, an acylphosphine oxide compound, a thioxanthone compound, and an oxime ester compound. Preferred examples of the photocationic polymerization initiator include an iodonium salt compound and a sulfonium salt compound.

The composition may contain one type of polymerization initiator or two or more types of polymerization initiators.

From the viewpoint of ease of adjusting a helical pitch, a polymerization rate, and the strength of a liquid crystal layer after curing, the proportion of the content of the polymerization initiator with respect to the total mass of the cholesteric liquid crystal layer or the solid content of the composition is preferably 0.05% by mass to 10% by mass, more preferably 0.05% by mass to 5% by mass, still more preferably 0.1% by mass to 4% by mass, and particularly preferably 0.2% by mass to 3% by mass.

### Polymerizable Monomer

The composition for a cholesteric liquid crystal layer may contain a polymerizable monomer. The polymerizable monomer can promote crosslinking of the cholesteric liquid crystal compound.

Examples of the polymerizable monomer include a monomer or oligomer that has two or more ethylenically unsaturated groups and undergoes addition polymerization upon irradiation with light. Examples of the polymerizable monomer include a compound having an ethylenically unsaturated group. Examples of the polymerizable monomer include a monofunctional acrylate, a monofunctional methacrylate, a polyfunctional acrylate, and a polyfunctional methacrylate. Examples of the polymerizable monomer include polyethylene glycol mono(meth)acrylate, polypropylene glycol mono(meth)acrylate, and phenoxyethyl (meth)acrylate.

Examples of the polymerizable monomer include polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta (meth)acrylate, hexanediol di(meth)acrylate, trimethylolpropane tri (acryloyloxypropyl) ether, tri (acryloyloxyethyl) isocyanurate, tri (acryloyloxyethyl) cyanurate, and glycerin tri(meth)acrylate.

Examples of the polymerizable monomer include a compound formed by adding ethylene oxide or propylene oxide to a polyfunctional alcohol such as trimethylolpropane or glycerin, followed by (meth)acrylation.

Examples of the polymerizable monomer include urethane acrylates described in JP1973-41708B (JP-S48-41708B), JP1975-6034B (JP-S50-6034B), and JP1976-37193A (JP-S51-37193A).

In addition, examples of the polymerizable monomer include polyester acrylates described in JP1973-64183A (JP-S48-64183A), JP1974-43191B (JP-S49-43191B), and JP1977-30490B (JP-S52-30490B).

Further, examples of the polymerizable monomer include epoxy acrylates, which are reaction products of an epoxy resin and a (meth)acrylic acid.

Preferred examples of the polymerizable monomer include trimethylolpropane tri(meth)acrylate, pentaerythritol tetra(meth)acrylate, dipentaerythritol hexa(meth)acrylate, and dipentaerythritol penta(meth)acrylate.

In addition, preferred examples of the polymerizable monomer include the “polymerizable compound B” described in JP1999-133600A (JP-H11-133600A).

The polymerizable monomer may be a cationically polymerizable monomer. Examples of the cationically polymerizable monomer include an epoxy compound, a vinyl ether compound, and an oxetane compounds described in JP1994-9714A (JP-H6-9714A), JP2001-31892A, JP2001-40068A, JP2001-55507A, JP2001-310938A, JP2001-310937A, and JP2001-220526A.

Examples of the epoxy compound include an aromatic epoxide, an alicyclic epoxide, and an aliphatic epoxide.

Examples of the aromatic epoxide include a diglycidyl ether or polyglycidyl ether of bisphenol A, a diglycidyl ether or polyglycidyl ether of an alkylene oxide adduct of bisphenol A, a diglycidyl ether or polyglycidyl ether of hydrogenated bisphenol A, a diglycidyl ether or polyglycidyl ether of an alkylene oxide adduct of hydrogenated bisphenol A, and a novolac type epoxy resin. Examples of the alkylene oxide include ethylene oxide and propylene oxide.

Examples of the alicyclic epoxide include a cyclohexene oxide-containing compound or cyclopentene oxide-containing compound which is obtained by epoxidizing a compound having a cycloalkane ring (for example, a cyclohexene ring or a cyclopentene ring) with an oxidizing agent (for example, hydrogen peroxide or peracid).

Examples of the aliphatic epoxide include a diglycidyl ether or polyglycidyl ether of an aliphatic polyhydric alcohol and a diglycidyl ether or polyglycidyl ether of an alkylene oxide adduct of an aliphatic polyhydric alcohol. Examples of the aliphatic epoxide include a diglycidyl ether of alkylene glycol (for example, a diglycidyl ether of ethylene glycol, a diglycidyl ether of propylene glycol, or a diglycidyl ether of 1,6-hexanediol). Examples of the aliphatic epoxide include a polyglycidyl ether of a polyhydric alcohol (for example, a diglycidyl ether or polyglycidyl ether of glycerin or a diglycidyl ether or polyglycidyl ether of an alkylene oxide adduct of glycerin). Examples of the aliphatic epoxide include a diglycidyl ether of a polyalkylene glycol (for example, a diglycidyl ether of polyethylene glycol or a diglycidyl ether of an alkylene oxide adduct of polyethylene glycol or a diglycidyl ether of polypropylene glycol or a diglycidyl ether of an alkylene oxide adduct of polypropylene glycol). Examples of the alkylene oxide include ethylene oxide and propylene oxide.

Examples of the cationically polymerizable monomer include a monofunctional or difunctional oxetane monomer. For example, 3-ethyl-3-hydroxymethyloxetane (for example, OXT101 manufactured by Toagosei Co., Ltd.), 1,4-bis [(3-ethyl-3-oxetanyl) methoxymethyl]benzene (for example, OXT121 manufactured by Toagosei Co., Ltd.), 3-ethyl-3-(phenoxymethyl)oxetane (for example, OXT211 manufactured by Toagosei Co., Ltd.), di(1-ethyl-3-oxetanyl)methyl ether (for example, OXT221 manufactured by Toagosei Co., Ltd.), and 3-ethyl-3-(2-ethylhexyloxymethyl)oxetane (for example, OXT212 manufactured by Toagosei Co., Ltd.) are preferably used. In particular, 3-ethyl-3-hydroxymethyloxetane, 3-ethyl-3-(phenoxymethyl)oxetane, and di(1-ethyl-3-oxetanyl)methyl ether are preferable. The monofunctional or polyfunctional oxetane compounds described in JP2001-220526A and JP2001-310937A may be used.

### Polyfunctional Polymerizable Compound

The composition for a cholesteric liquid crystal layer may contain a polyfunctional polymerizable compound. The polyfunctional polymerizable compound can contribute to suppression of changes in reflectance after molding.

Examples of the polyfunctional polymerizable compound include a cholesteric liquid crystal compound having two or more ethylenically unsaturated groups and not having a cyclic ether group, a cholesteric liquid crystal compound having two or more cyclic ether groups and not having an ethylenically unsaturated group, a cholesteric liquid crystal compound having two or more ethylenically unsaturated groups and two or more cyclic ether groups, a chiral agent having two or more polymerizable groups, and a crosslinking agent.

Preferred examples of the ethylenically unsaturated group include a (meth)acryloyl group. More preferred examples of the ethylenically unsaturated group include a (meth)acryloxy group.

Preferred examples of the cyclic ether group include an epoxy group and an oxetanyl group. More preferred examples of the cyclic ether group include an oxetanyl group.

The polyfunctional polymerizable compound preferably includes at least one compound selected from the group consisting of a cholesteric liquid crystal compound having two or more ethylenically unsaturated groups and not having a cyclic ether group, a cholesteric liquid crystal compound having two or more cyclic ether groups and not having an ethylenically unsaturated group, and a chiral agent having two or more polymerizable groups, and more preferably includes a chiral agent having two or more polymerizable groups.

The composition may contain one type of polyfunctional polymerizable compound or two or more types of polyfunctional polymerizable compounds.

The proportion of the content of the polyfunctional polymerizable compound with respect to the total mass of the cholesteric liquid crystal layer or the solid content of the composition is preferably 0.5% by mass to 70% by mass, more preferably 1% by mass to 50% by mass, still more preferably 1.5% by mass to 20% by mass, and particularly preferably 2% by mass to 10% by mass.

### Crosslinking Agent

The cholesteric liquid crystal layer or the composition may contain a crosslinking agent. The crosslinking agent can improve the strength and durability of the liquid crystal layer after curing.

The type of the crosslinking agent is not limited. The crosslinking agent may be a known crosslinking agent. The crosslinking agent is preferably a compound which is cured by ultraviolet rays, heat, or moisture.

Examples of the crosslinking agent include polyfunctional acrylate compounds such as trimethylolpropane tri(meth)acrylate and pentaerythritol tri(meth)acrylate; epoxy compounds such as glycidyl (meth)acrylate, ethylene glycol diglycidyl ether, and 3′,4′-epoxycyclohexylmethyl 3,4-epoxycyclohexanecarboxylate; oxetane compounds such as 2-ethylhexyloxetane and xylylenebisoxetane; aziridine compounds such as 2,2-bishydroxymethylbutanol-tris [3-(1-aziridinyl) propionate] and 4,4-bis(ethyleneiminocarbonylamino) diphenylmethane; isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a known catalyst may be used depending on the reactivity of the crosslinking agent. The use of the catalyst can improve productivity in addition to improving the strength and durability of the liquid crystal layer.

The cholesteric liquid crystal layer or the composition may contain one type of crosslinking agent or two or more types of crosslinking agents.

From the viewpoint of strength and durability of the cholesteric liquid crystal layer, the proportion of the content of the crosslinking agent with respect to the total mass of the cholesteric liquid crystal layer or the solid content of the composition is preferably 1% by mass to 20% by mass and more preferably 3% by mass to 15% by mass.

### Additives

The cholesteric liquid crystal layer or the composition may contain other additives.

Examples of the other additives include a surfactant, a polymerization inhibitor, an antioxidant, a horizontal alignment agent, an ultraviolet absorber, a light stabilizer, a colorant, and metal oxide particles.

### Physical Properties of Cholesteric Liquid Crystal Layer

The color of the cholesteric liquid crystal layer and a change in color depending on the viewing angle are adjusted by, for example, at least one selected from the group consisting of a helical pitch, a refractive index, and a thickness. The helical pitch can be adjusted by, for example, the content of the chiral agent. The details thereof are described in, for example, “FUJIFILM research & development No. 50 (2005), pp. 60 to 63”. The helical pitch may be adjusted by changing conditions such as a temperature, an illuminance, and an irradiation time in a case of fixing a cholesteric alignment state.

From the viewpoint of vividness of the reflected color, the thickness of the cholesteric liquid crystal layer is preferably 0.5 μm or more, more preferably 2 μm or more, and still more preferably 3 μm or more. In addition, from the viewpoint of ease of forming a cholesteric liquid crystal layer, the thickness of the cholesteric liquid crystal layer is preferably 10 μm or less, preferably 6 μm or less, and particularly preferably 4 μm or less. From the above viewpoints, the thickness of the cholesteric liquid crystal layer is preferably in a range of 0.5 μm to 10 μm.

The haze value of the cholesteric liquid crystal layer is preferably 2.0% or less. By setting the haze value to 2.0% or less, the transparency of the cholesteric liquid crystal layer can be improved. The haze value is more preferably 1.8% or less, still more preferably 1.3% or less, and particularly preferably 1.0% or less. Since a smaller haze is more preferable, there is no lower limit for the haze value. In a case where the lower limit of the haze value is set for convenience, it is 0% or more.

The haze value is a value measured using a haze meter (for example, NDH-5000, manufactured by Nippon Denshoku Industries Co., Ltd.) according to a method in accordance with JIS K 7105 (1981).

### (Colored Layer)

The decorative film may include a colored layer. As a result, it is easier to obtain a desired design. The colored layer is a layer that contains a colorant. The colored layer may be composed of one layer or two or more layers.

In addition, the colored layer may also be an optical mask layer in the laminate of the present disclosure.

In the decorative film, the position of the colored layer is not particularly limited, and the colored layer may be provided at a desired position. For example, the colored layer may be provided on a reflective layer. In addition, in a case where the decorative film includes a substrate, the colored layer may be provided on a side of the substrate opposite to the side on which the reflective layer is formed, or the colored layer may be provided, using a decorative film obtained by peeling off a substrate from a decorative film that includes a substrate, on the decorative film after the substrate is peeled off.

The color of the colored layer is not particularly limited, and can be appropriately selected depending on the application of the decorative film and the like. Examples of the color of the colored layer include black, gray, white, red, orange, yellow, green, blue, purple, and brown. In addition, the color of the colored layer may be a metallic color.

### Colorant

The colorant may be a pigment or a dye. From the viewpoint of durability, the colorant is preferably a pigment. In order to give the colored layer a metallic tone, a metal particle, a pearl pigment, or the like may be used as the colorant.

The pigment may be an inorganic pigment or an organic pigment.

Examples of the inorganic pigment include a white pigment such as titanium dioxide, zinc oxide, lithopone, light calcium carbonate, white carbon, aluminum oxide, aluminum hydroxide, or barium sulfate; a black pigment such as carbon black, titanium black, titanium carbon, iron oxide, or graphite; iron oxide, barium yellow, cadmium red, and chrome yellow.

Examples of the inorganic pigment also include the inorganic pigments described in paragraph and paragraph of JP2005-7765A.

Examples of the organic pigment include a phthalocyanine-based pigment such as phthalocyanine blue or phthalocyanine green; an azo-based pigment such as azo red, azo yellow, or azo orange; a quinacridone-based pigment such as quinacridone red, cinquasia red, or cinquasia magenta; a perylene-based pigment such as perylene red or perylene maroon; carbazole violet, anthrapyridine, flavanthrone yellow, isoindoline yellow, indanthrone blue, dibromoanthanthrone red, anthraquinone red, and diketopyrrolopyrrole.

Specific examples of the organic pigment include a red pigment such as C. I. Pigment Red 177, 179, 224, 242, 2515, or 264; a yellow pigment such as C. I. Pigment Yellow 138, 139, 150, 180, or 185; an orange pigment such as C. I. Pigment Orange 36, 38, or 71; a green pigment such as C. I. Pigment Green 7, 36, or 58; a blue pigment such as C. I. Pigment Blue 15:6; and a violet pigment such as C. I. Pigment Violet 23.

Examples of the organic pigment also include the organic pigments described in paragraph of JP2009-256572A.

The pigment may be a pigment having light transmittance and light reflectivity (so-called bright pigment). Examples of the bright pigment include a metallic bright pigment such as aluminum, copper, zinc, iron, nickel, tin, aluminum oxide, or an alloy thereof, an interference mica pigment, a white mica pigment, a graphite pigment, and a glass flake pigment. The bright pigment may be uncolored or colored.

The colorants may be used alone or in combination of two or more thereof. In a case where two or more types of colorants are used, an inorganic pigment and an organic pigment may be used in combination.

From the viewpoint of achieving the desired color expression, the content of the colorant is preferably 1% by mass to 50% by mass, more preferably 5% by mass to 50% by mass, and particularly preferably 10% by mass to 40% by mass with respect to the total amount of the colored layer.

### Binder Resin

From the viewpoint of strength, scratch resistance, and molding suitability, the colored layer preferably contains a binder resin. The type of the binder resin is not particularly limited. From the viewpoint of obtaining a desired color, the binder resin is preferably a transparent resin and specifically preferably a resin having a total light transmittance of 80% or more. The total light transmittance can be measured by a spectrophotometer (for example, a spectrophotometer “UV-2100” manufactured by Shimadzu Corporation).

Examples of the binder resin include an acrylic resin, a silicone resin, a polyester, a polyurethane, and a polyolefin. The binder resin may be a homopolymer or a copolymer.

The binder resins may be used alone or in combination of two or more thereof.

From the viewpoint of moldability, the content of the binder resin is preferably 5% by mass to 70% by mass, more preferably 10% by mass to 60% by mass, and particularly preferably 20% by mass to 60% by mass with respect to the total amount of the colored layer.

### Dispersant

From the viewpoint of improving dispersibility of the colorant, particularly the pigment, contained in the colored layer, the colored layer may contain a dispersant. In a case where a dispersant is contained, the dispersibility of the colorant in the colored layer is improved. Therefore, the color of the resulting decorative film can be more easily made uniform.

The dispersant can be appropriately selected depending on the type, shape, and the like of the colorant, and is preferably a polymer dispersant.

Examples of the polymer dispersant include a silicone polymer, an acrylic polymer, and a polyester polymer. For example, in a case where it is desired to impart heat resistance to the decorative film, the dispersant is preferably a silicone polymer such as a grafted silicone polymer.

The weight-average molecular weight of the dispersant is preferably 1,000 to 5,000,000, more preferably 2,000 to 3,000,000, and particularly preferably 2,500 to 3,000,000. In a case where the weight-average molecular weight of the dispersant is 1,000 or more, the dispersibility of the colorant is further improved.

The dispersant may be a commercially available product. Examples of commercially available products of the dispersant include EFKA 4300 (an acrylic polymer dispersant, manufactured by BASF Japan Ltd.); HOMOGENOL L-18, HOMOGENOL L-95, and HOMOGENOL L-100 (manufactured by Kao Corporation); SOLSPERSE 20000 and SOLSPERSE 24000 (manufactured by Lubrizol Japan Limited); and DISPERBYK-110, DISPERBYK-164, DISPERBYK-180, and DISPERBYK-182 (manufactured by BYK-Chemie Japan K.K.). Note that “HOMOGENOL”, “SOLSPERSE”, and “DISPERBYK” are all registered trademarks.

The dispersants may be used alone or in combination of two or more thereof.

The content of the dispersant is preferably 1 part by mass to 30 parts by mass with respect to 100 parts by mass of the colorant.

### Additive

The colored layer may contain an additive as necessary, in addition to the above-mentioned components. The additive is not particularly limited, and examples thereof include the surfactants described in paragraph of JP4502784B and paragraphs to
of JP2009-237362A, the thermal polymerization inhibitors described in paragraph
of JP4502784B (also referred to as polymerization inhibitors, preferred examples of which include phenothiazine.), and the additives described in paragraphs to of JP2000-310706A.

### Thickness

The thickness of the colored layer is not particularly limited, and is preferably 0.5 μm or more, more preferably 3 μm or more, still more preferably 3 μm to 50 μm, and particularly preferably 3 μm to 20 μm, from the viewpoint of visibility and three-dimensional moldability.

In a case where there are two or more colored layers, it is preferable that each colored layer independently has a thickness in the above range.

### Method for Forming Colored Layer

Examples of the method for forming a colored layer include a method of using a composition for forming a colored layer, and a method of bonding colored films to each other. Among these methods, the method of using a composition for forming a colored layer is preferable as the method for forming a colored layer.

Examples of the method for forming a colored layer using the composition for forming a colored layer include a method for forming a colored layer by applying the composition for forming a colored layer, for example, a method for forming a colored layer by printing the composition for forming a colored layer. Examples of the printing method include screen printing, ink jet printing, flexographic printing, gravure printing, and offset printing.

The composition for forming a colored layer may contain a colorant and, if necessary, at least one of a binder resin, a dispersant, or an additive. The type of each component may be the same as that described above for the colored layer.

The content of the colorant is preferably 1% by mass to 50% by mass, more preferably 5% by mass to 50% by mass, and particularly preferably 10% by mass to 40% by mass with respect to the total solid content of the composition for forming a colored layer.

The content of the binder resin is preferably 5% by mass to 70% by mass, more preferably 10% by mass to 60% by mass, and particularly preferably 20% by mass to 60% by mass with respect to the total solid content of the composition for forming a colored layer.

The content of the dispersant is preferably 1 part by mass to 30 parts by mass with respect to 100 parts by mass of the colorant.

The colored layer may be a layer formed by curing the composition for forming a colored layer, and may be formed, for example, by using a composition for forming a colored layer containing a polymerizable compound and a polymerization initiator. The polymerizable compound and the polymerization initiator are not particularly limited, and a known polymerizable compound and a known polymerization initiator may be used. The polymerizable compounds may be used alone or in combination of two or more thereof. The polymerization initiators may be used alone or in combination of two or more thereof.

From the viewpoint of making application easier, the composition for forming a colored layer may contain an organic solvent. The organic solvent is not particularly limited, and any known organic solvent can be used. Examples of the organic solvent include an alcohol, an ester, an ether, a ketone, and an aromatic hydrocarbon. The organic solvents may be used alone or in combination of two or more thereof.

The content of the organic solvent is preferably 5% by mass to 90% by mass and more preferably 30% by mass to 70% by mass with respect to the total amount of the composition for forming a colored layer.

For example, commercially available paints such as nax REAL series, nax ADMIRA series, and nax MULTI series (manufactured by Nippon Paint Co., Ltd.); and RETAN PG Series (manufactured by Kansai Paint Co., Ltd.) may be used as the composition for forming a colored layer.

The method for preparing the composition for forming a colored layer is not particularly limited, and the composition for forming a colored layer may be prepared, for example, by mixing each component such as a colorant. In addition, in a case where the composition for forming a colored layer contains a pigment as a colorant, it is preferable to prepare a pigment dispersion liquid containing the pigment and a dispersant in advance and mix the other components with the pigment dispersion liquid to prepare the composition for forming a colored layer, from the viewpoint of further enhancing the uniform dispersibility and dispersion stability of the pigment.

### (Alignment Layer)

The decorative film may have an alignment layer. The alignment layer is used to more easily align the molecules of the cholesteric liquid crystal compound in the light reflecting portion during the formation of the decorative film.

The alignment layer is provided by, for example, a rubbing treatment of an organic compound (preferably a polymer), oblique vapor deposition of an inorganic compound, or formation of a layer having microgrooves. An alignment layer that generates an alignment function by application of an electric field, application of a magnetic field, or irradiation with light is also known as the alignment layer.

The thickness of the alignment layer is not particularly limited, and is preferably 0.01 μm to 10 μm.

Depending on the type of the substrate and the base, the base can be used as an alignment layer without separately providing an alignment layer.

For example, the substrate can be directly subjected to an alignment treatment (for example, a rubbing treatment) so that the substrate functions as an alignment layer. Examples of the substrate that can be directly subjected to an alignment treatment include a layer consisting of polyethylene terephthalate (PET), which may be subjected to a rubbing treatment in a manner which will be described later.

Hereinafter, a rubbing-treated alignment layer and a photoalignment layer will be described as preferred examples.

### Rubbing-Treated Alignment Layer

The rubbing-treated alignment layer is formed, for example, by carrying out a rubbing treatment on a surface of a base onto which a liquid crystal composition is applied. The rubbing treatment can be carried out, for example, by rubbing a surface of a film mainly composed of a polymer with paper or cloth in a certain direction. General methods for the rubbing treatment are described in, for example, “Handbook of Liquid Crystals” (published by Maruzen Co., Ltd., Oct. 30, 2000).

Examples of the polymer for an alignment layer that forms the above-mentioned film mainly composed of a polymer include a methacrylate-based copolymer, a styrene-based copolymer, a polyolefin, a polyvinyl alcohol, a modified polyvinyl alcohol, a poly(N-methylolacrylamide), a polyester, a polyimide, a vinyl acetate copolymer, a carboxymethyl cellulose, and a polycarbonate, as described in paragraph of JP1996-338913A (JP-H8-338913A). In addition, the polymer for an alignment layer may also be a silane coupling agent. The polymer for an alignment layer is preferably a water-soluble polymer (for example, a poly(N-methylolacrylamide), a carboxymethyl cellulose, a gelatin, a polyvinyl alcohol, or a modified polyvinyl alcohol); more preferably a gelatin, a polyvinyl alcohol, or a modified polyvinyl alcohol; and particularly preferably a polyvinyl alcohol or a modified polyvinyl alcohol.

The method described in “Handbook of Liquid Crystals” (published by Maruzen Co., Ltd.) can be used as a method of changing a rubbing density. The rubbing density (L) is quantified by Expression (A).

Expression(A)L=N1(1+2πrn/60v)

In Expression (A), N is the number of times of rubbing, 1 is a contact length of a rubbing roller, r is a radius of the roller, n is a rotation speed (revolutions per minute; rpm) of the roller, and v is a stage moving speed (speed per second).

Examples of a method of increasing the rubbing density include a method of increasing the number of times of rubbing, a method of increasing a contact length of a rubbing roller, a method of increasing a radius of a roller, a method of increasing a rotation speed of a roller, and a method of decreasing a stage moving speed. On the other hand, examples of a method of decreasing the rubbing density include a method of decreasing the number of times of rubbing, a method of decreasing a contact length of a rubbing roller, a method of decreasing a radius of a roller, a method of decreasing a rotation speed of a roller, and a method of increasing a stage moving speed. In addition, with regard to the conditions for the rubbing treatment, reference can be made to the description of JP4052558B.

### Photoalignment Layer

Examples of the photo-alignment material used for the photoalignment layer which is formed by irradiation with light include the azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; the aromatic ester compounds described in JP2002-229039A; the maleimide and/or alkenyl-substituted nadiimide compounds having a photo alignment unit described in JP2002-265541A and JP2002-317013A; the photo-crosslinkable silane derivatives described in JP4205195B and JP4205198B; and the photo-crosslinkable polyimides, polyamides, or esters described in JP2003-520878A, JP2004-529220A, and JP4162850B. Above all, the photo-alignment material is preferably an azo compound or a photo-crosslinkable polyimide, polyamide, or ester.

A layer formed of a photo-alignment material is irradiated with linearly polarized light or non-polarized light to manufacture a photoalignment layer.

In the present disclosure, “irradiation with linearly polarized light” refers to an operation for causing a photoreaction in a photo-alignment material. The wavelength of the light used varies depends on the photo-alignment material used, and is not particularly limited as long as it is a wavelength necessary for the photoreaction. The light used for irradiation with light is preferably light having a peak wavelength of 200 nm to 700 nm, and more preferably ultraviolet rays having a peak wavelength of 400 nm or less.

Examples of the light source used for irradiation with light include known light sources, for example, lamps such as a tungsten lamp, a halogen lamp, a xenon lamp, a xenon flash lamp, a mercury lamp, a mercury xenon lamp, and a carbon arc lamp, various lasers (for example, a semiconductor laser, a helium neon laser, an argon ion laser, a helium cadmium laser, and a YAG laser), light emitting diodes, and cathode ray tubes.

Examples of the method of obtaining linearly polarized light include a method of using a polarizing plate (for example, an iodine polarizing plate, a dichroic coloring agent polarizing plate, or a wire grid polarizing plate), a method of using a prism-based element (for example, a Glan-Thompson prism) or a reflective type polarizer using a Brewster's angle, and a method of using light emitted from a laser light source having polarized light. In addition, only light having a required wavelength may be selectively applied using a filter, a wavelength conversion element, or the like.

In a case where the light to be applied is linearly polarized light, for example, there is a method of applying light in a direction perpendicular or oblique to the surface of the alignment layer from an upper surface or rear surface of the alignment layer. The incidence angle of light varies depending on the photo-alignment material and is preferably 0° to 90° (perpendicular) and more preferably 40° to 90° with respect to the alignment layer.

In a case where non-polarized light is used, the non-polarized light is applied in an oblique direction from an upper surface or rear surface of the alignment layer. The incidence angle of light is preferably 10° to 80°, more preferably 20° to 60°, and still more preferably 30° to 50°. The irradiation time is preferably 1 minute to 60 minutes and more preferably 1 minute to 10 minutes.

### (Refractive Index Adjusting Layer)

The decorative film preferably further has a refractive index adjusting layer, and more preferably has the refractive index adjusting layer between the reflective layer and the layer having an uneven structure. A known refractive index adjusting layer can be applied as the refractive index adjusting layer.

Examples of materials contained in the refractive index adjusting layer include a resin, a polymerizable compound, a metal salt, and particles. The method for controlling a refractive index of the refractive index adjusting layer is not particularly limited, and examples thereof include a method of using a resin having a predetermined refractive index alone, and a method of using a polymer and particles.

Examples of the polymer include the resin described above as the component of the layer having an uneven structure B. Examples of the polymerizable compound include the polymerizable compound and the crosslinking agent described above as the components of the reflective layer.

Examples of the particles include metal oxide particles and metal particles. The type of the metal oxide particles is not particularly limited, and examples of the metal oxide particles include known metal oxide particles. The metal of the metal oxide particles also includes a semimetal such as B, Si, Ge, As, Sb, or Te.

Specifically, the metal oxide particles are preferably at least one selected from the group consisting of zirconium oxide particles (ZrO₂ particles), Nb₂O₅ particles, titanium oxide particles (TiO₂ particles), silicon dioxide particles (SiO₂ particles), and composite particles thereof. Among these, the metal oxide particles are more preferably at least one selected from the group consisting of zirconium oxide particles and titanium oxide particles, for example, from the viewpoint of ease of adjusting the refractive index.

Examples of commercially available products of the metal oxide particles include calcined zirconium oxide particles (product name: ZRPGM15WT %-F04, manufactured by CIK NanoTek Corporation), calcined zirconium oxide particles (product name: ZRPGM15WT %-F74, manufactured by CIK NanoTek Corporation), calcined zirconium oxide particles (product name: ZRPGM15WT %-F75, manufactured by CIK NanoTek Corporation), calcined zirconium oxide particles (product name: ZRPGM15WT %-F76, manufactured by CIK NanoTek Corporation), zirconium oxide particles (NanoUse OZ-S30M, manufactured by Nissan Chemical Corporation), and zirconium oxide particles (NanoUse OZ-S30K, manufactured by Nissan Chemical Corporation).

The average primary particle diameter of the particles is preferably 1 nm to 200 nm and more preferably 3 nm to 80 nm, for example, from the viewpoint of transparency of the cured film. The average primary particle diameter of the particles is calculated by measuring particle diameters of 200 random particles using an electron microscope and arithmetically averaging the measurement results. In a case where the shape of the particle is not spherical, the longest side is taken as the particle diameter.

The particles may be used alone or in combination of two or more thereof.

The content of the particles in the refractive index adjusting layer is preferably 1% by mass to 95% by mass, more preferably 20% by mass to 90% by mass, and still more preferably 40% by mass to 85% by mass with respect to the total mass of the refractive index adjusting layer.

The difference between the refractive index of the refractive index adjusting layer and the refractive index of the cholesteric liquid crystal layer is preferably 0.10 or less, more preferably 0.05 or less, and particularly preferably 0.005 to 0.03.

The thickness of the refractive index adjusting layer is not particularly limited, and is preferably 1 μm or more, more preferably 10 μm or more, and still more preferably 20 μm or more. In addition, from the same viewpoint, the thickness of the refractive index adjusting layer is preferably 300 μm or less, more preferably 100 μm or less, and still more preferably 50 μm or less.

### (Other Layers)

The decorative film may have layers other than the cholesteric liquid crystal layer, the substrate, the colored layer (optical mask layer), and the refractive index adjusting layer.

Examples of the other layers include a protective layer, a pressure-sensitive adhesive layer, an easy adhesion layer, an ultraviolet absorbing layer, a self-repairing layer, an antistatic layer, an antifouling layer, an electromagnetic wave shielding layer, and a conductive layer, which are known layers in the decorative film.

The other layers can be formed by a known method. For example, a method of applying a composition containing the components to be contained in these layers (a composition for forming a layer) in the form of a layer and drying the applied composition can be mentioned.

### <Molded Body, Article, and Display Device>

The molded body of the present disclosure is obtained by molding the decorative film of the present disclosure. The decorative film of the present disclosure can be used for various applications. For example, the decorative film of the present disclosure can be used as a molded body by molding the decorative film.

The article of the present disclosure includes the decorative film of the present disclosure or the molded body of the present disclosure. The display device of the present disclosure includes the article of the present disclosure.

Examples of the article of the present disclosure include an electronic device such as a smartphone, a mobile phone, or a tablet, an automobile, an electric appliance, and a packaging container, and in particular, the decorative film of the present disclosure can be suitably used for an electronic device. More suitable examples of the electronic device include a display device such as a display, a smartphone, a mobile phone, or a tablet. Above all, the decorative film of the present disclosure can be particularly suitably used for a normal display or a display in a display device of a smartphone, a home appliance, an audio product, a computer, an in-vehicle product, or the like.

In addition, in a case where the decorative film of the present disclosure is used in a display device such as a display or a smartphone, a phase difference film may be provided between the decorative film of the present disclosure and a display member such as a display. A known phase difference film can be used as the phase difference film.

The means for molding the laminate of the present disclosure to obtain a molded body is not particularly limited, and may be, for example, a known method such as three-dimensional molding or insert molding. In addition, the means for applying the laminate of the present disclosure to an article is also not particularly limited, and a known method may be appropriately used depending on the type of the article.

### EXAMPLES

Hereinafter, the present disclosure will be described more specifically with reference to Examples, but the present disclosure is not limited to the following Examples as long as it does not depart from the gist of the present disclosure.

### Example 1

As Example 1, a liquid crystal film was produced using a manufacturing device 100a having a configuration as shown in FIG. 6.

### [Preparation of Substrate]

A polyethylene terephthalate film (COSMOSHINE A4160, manufactured by Toyobo Co., Ltd., thickness: 100 μm, width: 330 mm, length: 2000 m) including an easy adhesion layer on one surface was prepared as the substrate.

[Preparation of Substrate with Optical Mask Layer]

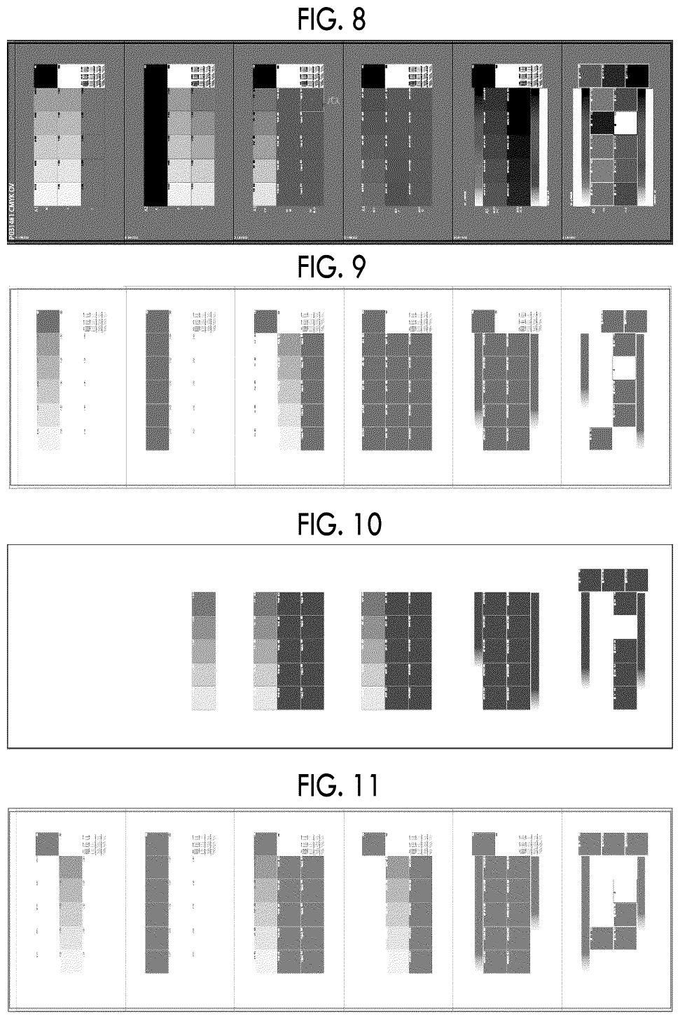

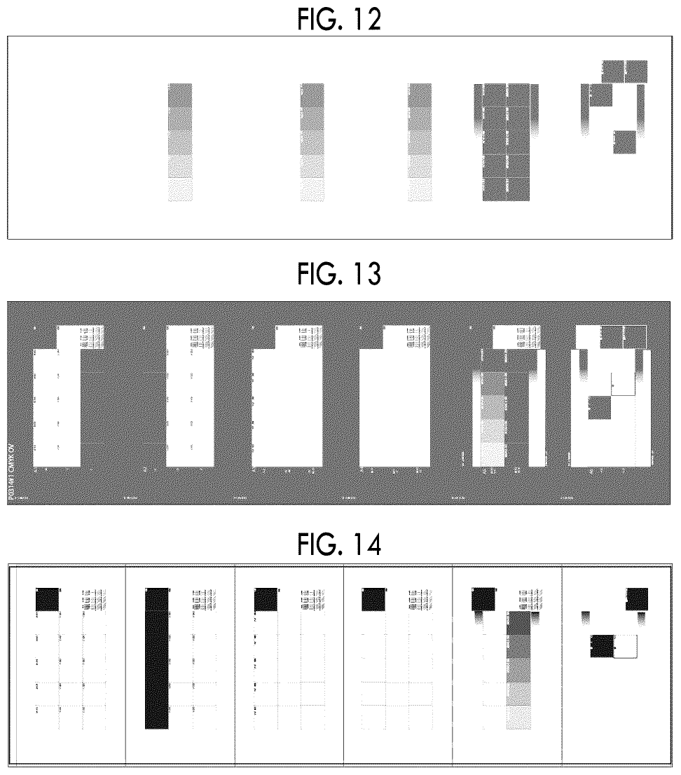

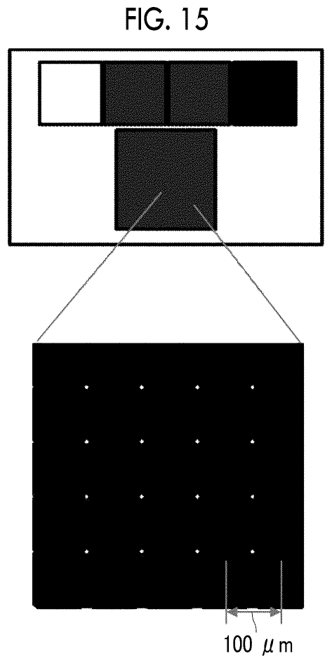

An optical mask layer was provided by a printing treatment on the surface of the substrate on which the easy adhesion layer was formed. Specifically, using a liquid electrophotographic printing press (Indigo 6900, manufactured by Hewlett-Packard Company), a pattern (width of 300 mm, length of 980 mm) shown in FIG. 8 was repeatedly printed continuously for 1500 m in a longitudinal direction of the substrate on the surface of the substrate on which the easy adhesion layer was formed. The pattern shown in FIG. 8 was formed by superimposing a first pattern shown in FIG. 9 formed with magenta ink, a second pattern shown in FIG. 10 formed with violet ink, a third pattern shown in FIG. 11 formed with yellow ink, a fourth pattern shown in FIG. 12 formed with orange ink, a fifth pattern shown in FIG. 13 formed with cyan ink, and a sixth pattern shown in FIG. 14 formed with black ink.

The inks used were HP Indigo ElectroInk (trade name, manufactured by Hewlett-Packard Company) for four standard colors of magenta, yellow, cyan, and black, and special color ink HP IndiChrome (trade name, manufactured by Hewlett-Packard Company) for violet and orange.

In all of the first to sixth patterns, the patterns were formed in an AM screen tone of 210 lines, and the print area ratio per 300 μm square was controlled. The color strength in FIG. 8 to FIG. 14 indicates the height of the print area ratio per 300 μm square, and the darker the region in the figure, the higher the printing area ratio per 300 μm square, and the region shown in the darkest color indicates a print area ratio of 100%. In addition, the patterns were controlled such that the halftone dotted regions of the first to sixth patterns did not overlap with each other.

### [Alignment Treatment]

The surface of the substrate on which the easy adhesion layer was not disposed was subjected to a rubbing treatment in a direction rotated 3° counterclockwise with reference to a short side direction. The conditions for the rubbing treatment are as follows.

### <<Conditions>>

Rubbing cloth: rayon cloth
Pressure: 0.1 kgf
Rotation speed: 1,000 rpm
Transportation speed: 10 m/min
Number of times: 1 time

### [Formation of Liquid Crystal Layer (Cholesteric Liquid Crystal Layer)]

A liquid crystal composition 1 having the following composition was prepared.

### Composition of Liquid Crystal Composition 1

Rod-like liquid crystal compound (1) shown below: 100 parts by mass

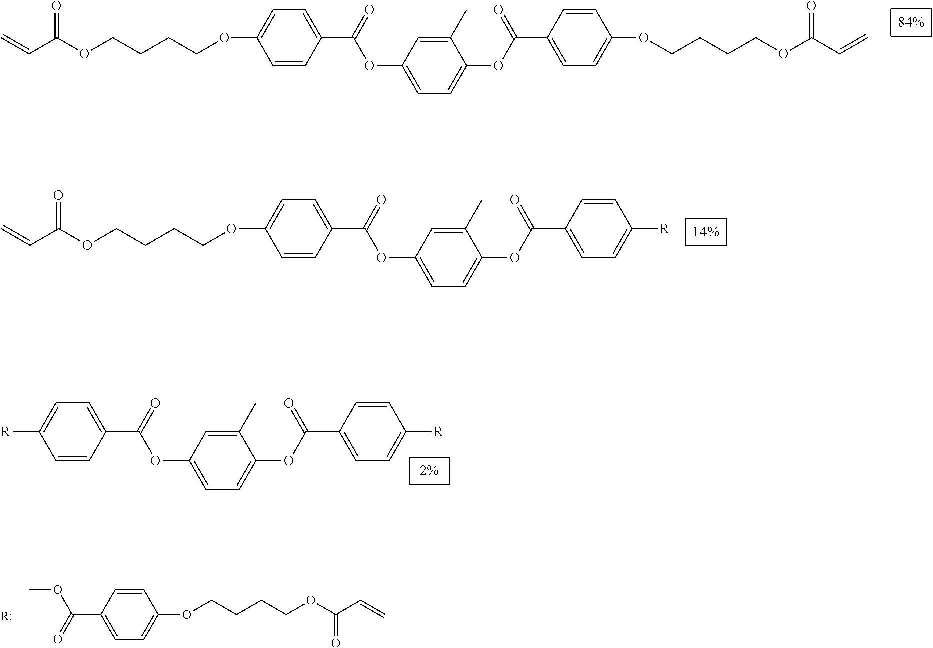

Photopolymerization initiator (KAYACURE DETX-S, manufactured by Nippon Kayaku Co., Ltd.): 4 parts by mass
Surfactant 1 (a compound having the following structure): 0.05 parts by mass
Surfactant 2 (a compound having the following structure): 0.055 parts by mass
Organic solvent 1 (methyl ethyl ketone): 187 parts by mass
Organic solvent 2 (furfuryl alcohol): 36 parts by mass
Photosensitive chiral agent (1) (a compound having the following structure): 8 parts by mass

Surfactant 1: a compound shown below

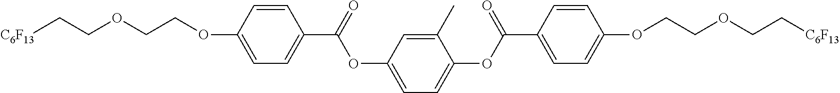

Surfactant 2: a compound shown below

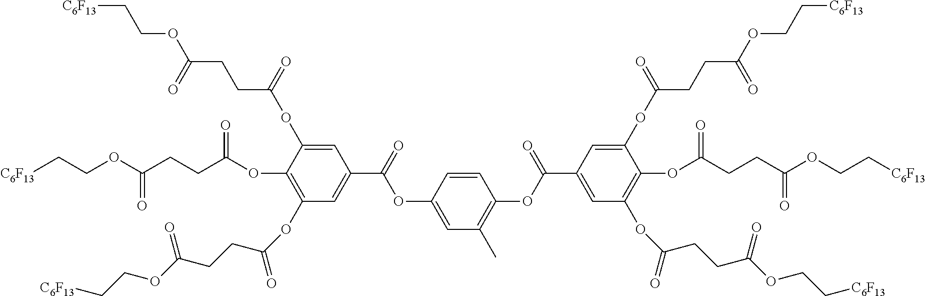

Photosensitive chiral agent (1): a compound shown below

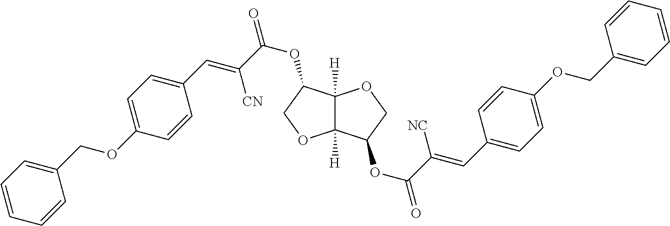 [SMILES: N#C/C(=C\c1ccc(OCc2ccccc2)cc1)C(=O)O[C@H]1CO[C@H]2[C@@H]1OC[C@H]2OC(=O)/C(C#N)=C/c1ccc(OCc2ccccc2)cc1]

Next, the liquid crystal composition 1 prepared above was applied onto a rubbing-treated surface of a substrate using a die coater. The application was carried out at room temperature, adjusting the thickness after drying to about 2.5 μm to 4 μm, to form a coating film (a liquid crystal material preparing step).

Next, the coating film was irradiated with an ultraviolet (UV)-LED (manufactured by CCS, Inc.) through an optical mask layer at room temperature under conditions of an illuminance of 50 mW and an exposure amount of 25 mJ/cm², and the cholesteric liquid crystal layer was irradiated with ultraviolet light (first light) having a wavelength of 365 nm (a photoreaction step of a photosensitive chiral agent). Since an optical mask layer having a small difference in light transmittance between the halftone dots and the gaps was used, the difference in the amount of photoreaction of the photosensitive chiral agent in the cholesteric liquid crystal layer between the halftone dot portions and the gap portions was small, and the difference in helical twisting power was also small.

The substrate on which the coating film after the photoreaction step of a photosensitive chiral agent was laminated was heated in a hot air drying zone at 60° C. for 1 minute.

Next, the coating film after the heating treatment was irradiated with light (second light) from a metal halide lamp (MAL625NAL, manufactured by GS Yuasa Corporation) from the cholesteric liquid crystal layer side in a low oxygen atmosphere (oxygen concentration: 500 ppm or less) at room temperature to cure the cholesteric liquid crystal layer, thereby obtaining a decorative film (a curing step). The irradiation here was carried out under an exposure condition of an exposure amount of 800 mJ/cm².

Thereafter, the film was wound up by a winding roller.

The substrate with an optical mask layer was verified as follows.

### Print Area Ratio Per 300 μm Square

The substrate with an optical mask layer was observed from the surface of the optical mask layer using an optical microscope (Eclipse LV100N POL, manufactured by Nikon Corporation). In order to observe a 300 μm square region, the magnification was adjusted to give a visual field ranging from 400 μm to 2 mm. For the printed pattern to be observed contained within a 300 μm square, an area was calculated from the shape and the size, and a value obtained by dividing the calculated area by 90,000 μm² was taken as a print area ratio per 300 μm square.

### Light Transmittance

As for the wavelength of light to be applied in the step of subjecting the photosensitive chiral agent to a photoreaction, the transmittance per 10 μmq was measured using a differential microscopic ultraviolet-visible-near infrared spectrophotometer (MSV-5500, manufactured by JASCO Corporation).

Light Transmittance T_{D} of Halftone Dot and Light Transmittance T_{A} of Gap

The light transmittance per 10 μmφ within the halftone dot was measured using a differential microscopic ultraviolet-visible-near infrared spectrophotometer (MSV-5500, manufactured by JASCO Corporation) and defined as T_{D}. Similarly, the light transmittance per 10 μmΦ within the gap was measured and defined as T_{A}.

In the optical mask layer, the minimum value of the light transmittance per 10 μmΦ was defined as Tₘᵢₙ, and the maximum value of the light transmittance per 10 μmΦ was defined as T_{MAX}.

The decorative film was verified as follows.

### Cholesteric Pitch

A section of the decorative film was produced using a microtome (RX-860, manufactured by Yamato Kohki Industrial Co., Ltd.), and a cross section of the cholesteric liquid crystal layer of the section was observed and measured using a scanning electron microscope (SU3800, manufactured by Hitachi High-Tech Corporation).

The difference obtained by subtracting a minimum value of the cholesteric pitch from a maximum value of the cholesteric pitch in the entire cholesteric liquid crystal layer was defined as ΔPₐₗₗ.

### Intra-Lattice Pitch Difference APS

For maximum points of the cholesteric pitch arranged at equal intervals, a quadrangle having a smallest area among quadrangles having the maximum point as a vertex was defined as the unit lattice. The halftone dotted region was divided into unit lattices, and the difference obtained by subtracting a minimum value of the pitch from a maximum value of the pitch within the unit lattice was defined as the intra-lattice pitch difference APS. For the unit lattice having a largest APS in the halftone dotted region, the intra-lattice pitch difference was defined as ΔP_{S(MAX)}.

As a result of the verification, the prepared substrate with an optical mask layer had a halftone dotted region made of yellow ink having an AM screen tone with a screen ruling of 210 lines and had a semi-translucent solid region of 300 μm square with a print area ratio of 100% and a light transmittance of 26.4% at a position overlapping with the halftone dotted region, and the semi-translucent solid region contained a pattern made of magenta ink and a pattern made of violet ink and contained three or more patterns. Further, an optical mask layer in which (T_{A}−T_{D})/(T_{MAX}−Tₘᵢₙ) was 0.28 or less in all regions was formed, in a case where the light transmittance of the halftone dot is defined as T_{D}, the light transmittance of the gap between the halftone dots is defined as T_{A}, the light transmittance of the optical mask layer at the portion with the lowest light transmittance is defined as Tₘᵢₙ, and the light transmittance of the optical mask layer at the portion with the highest light transmittance is defined as T_{MAX}. In addition, the optical mask layer also contained a region where T_{A} was 49%, T_{D} was 27%, and T_{A}−T_{D} was 22%.

The obtained decorative film had a pitch difference ΔPₐₗₗ in the entire cholesteric liquid crystal layer of 258 nm, a maximum value APS (MAX) of an intra-lattice pitch difference of 30 nm, and ΔP_{S(MAX)}/ΔPₐₗₗ=0.12. Further, the maximum value of the amount of changes in the cholesteric pitch per a distance of 100 μm in an in-plane direction (maximum value of changes in cholesteric pitch) was 172 nm.

### (Evaluation 1)

In order to eliminate the influence of the optical mask layer on the decorative film obtained in Example 1 above, the cholesteric liquid crystal layer was transferred to a PET film (A4160, manufactured by Toyobo Co., Ltd.) through an optical pressure-sensitive adhesive sheet (G25, manufactured by NEION Film Coatings Corp.) to produce a decorative film for evaluation, and the following evaluations were carried out.

### Reflection Chroma Saturation c*

Taking the surface of the decorative film on which the cholesteric liquid crystal layer was formed as an incident surface, the reflection spectrum was measured for the decorative film. The measurement was carried out by using a spectrophotometer (V-670, manufactured by JASCO Corporation) and a large integrating sphere device (ILV-471) and installing black drawing paper with a 1 mm square hole opened as a measurement window. The reflection spectrum is an integrated reflection spectrum measured by a spectrophotometer equipped with an integrating sphere device in a measurement window of 1 mm square, and shows a relative reflection spectrum with respect to a white standard plate measured in the same manner in a measurement window of 1 mm square.

The chromaticity L*a*b* was calculated using the obtained reflection spectrum, the reflection chroma saturation c* was calculated from the obtained chromaticity L*a*b* according to the following expression, and the reflection chroma saturation was evaluated according to the standards. As for the decorative film, the grade “A” or “B” in which a decorative effect is easily visible is preferable, and the grade “A” is particularly preferable.

$$Chroma saturation {c}^{*} = {\{ {( {a}^{*} )}^{2} + {( {b}^{*} )}^{2} \}}^{1 / 2}$$

### <Standards>

$$\begin{matrix}A : 50 \leq {c}^{*} \\ B : 40 \leq {c}^{*} < 50 \\ C : {c}^{*} < 40\end{matrix}$$

### Polychroism of Decorative Film

With regard to the reflection center wavelength of the decorative film, the reflection center wavelength was measured as follows.

Taking the surface of the decorative film on which the cholesteric liquid crystal layer was formed as an incident surface, the reflection spectrum was measured for the decorative film. The measurement was carried out by using a spectrophotometer (V-670, manufactured by JASCO Corporation) and a large integrating sphere device (ILV-471) and installing black drawing paper with a 1 mm square hole opened as a measurement window. The reflectance was then obtained from the reflection spectrum. The reflectance is an integral reflectance measured by a spectrophotometer equipped with an integrating sphere device in a measurement window of 1 mm square, and shows a relative reflectance with respect to a white standard plate measured in the same manner in a measurement window of 1 mm square.

Using the obtained reflection spectrum and reflectance, the wavelength showing a maximum value Rₘₐₓ (%) of the integral reflectance and the wavelength showing a half-value reflectance R^{1/2} (%) were averaged, and the average wavelength was defined as the reflection center wavelength.

The entire decorative film was evaluated, and the polychroism of the decorative film was evaluated according to the following standards. As for the decorative film, the grade “A” is preferable.

### <Standards>

A: There are three or more regions having different reflection center wavelengths.
B: There are less than three regions having different reflection center wavelengths.

### Graininess

The obtained decorative film was visually observed indoors using a fluorescent lamp (straight tube, daylight white, manufactured by Panasonic Corporation) and observed with an optical microscope (Eclipse LV100N POL, manufactured by Nikon Corporation), and the graininess was evaluated according to the following standards. As for the reflective decorative film, the grades “AA” to “D” are preferable, the grades “AA” to “C” are more preferable, the grades “AA” to “B” are still more preferable, the grade “AA” or “A” is particularly preferable, and the grade “AA” is most preferable.

### <Standards>

AA: No graininess is visible by visual observation from a point 5 cm away from the decorative film, and no halftone dot-like hue change is observed even by observation with an optical microscope.
A: No graininess is visible by visual observation from a point 5 cm away from the decorative film, and a halftone dot-like hue change is observed by an observation with an optical microscope.
B: No graininess is visible by visual observation from a point 10 cm away from the decorative film, and the graininess is visible by visual observation from a point 5 cm away from the decorative film.

C: No graininess is visible by visual observation from a point 20 cm away from the decorative film, and the graininess is visible by visual observation from a point 10 cm away from the decorative film.

D: No graininess is visible by visual observation from a point 30 cm away from the decorative film, and the graininess is visible by visual observation from a point 20 cm away from the decorative film.

E: The graininess is visible by visual observation from a point 30 cm away from the decorative film.

### Glossiness

Using a spectrophotometer (V-770, manufactured by JASCO Corporation) and an absolute reflectance measurement unit (ARMV-919, manufactured by JASCO Corporation), the obtained decorative film was subjected to measurement of a diffuse reflectance spectrum in a case where light was incident from an angle of −15° with respect to a line perpendicular to the decorative film surface and reflected light was received at an angle of +25°. Further, the specular reflection spectrum at light incidence of −5° and light receiving of +5° was also measured. The measurement wavelength range was 380 nm to 780 nm. In a case where the average value of the reflectance in a wavelength range of 380 nm to 780 nm was defined as a reflection intensity RI, a contrast RI_{D}/RI_{S} of a reflection intensity RI_{D} of the diffuse reflection with respect to a reflection intensity RI_{S} of the specular reflection was calculated. As the reflection intensity in a diffusion direction was stronger, the glossiness was decreased, so the glossiness was evaluated according to the following standards. As for the reflective decorative film, the grades “A” to “C” are preferable, the grade “A” or “B” is more preferable, and the grade “A” is particularly preferable.

### <Standards>

$$\begin{matrix}A : {RI}_{D} / {RI}_{S} \leq 0.005 \\ B : 0.005 < R {I}_{D} / {RI}_{S} \leq 0.02 \\ C : 0.02 < R {I}_{D} / {RI}_{S} \leq 0.05 \\ D : 0.05 < R {I}_{D} / {RI}_{S}\end{matrix}$$

### Complementary Chroma Saturation c*

The decorative film was superimposed on a standard white plate to prepare a laminate. Using a spectrophotometer (V-770, manufactured by JASCO Corporation) and an absolute reflectance measurement unit (ARMV-919, manufactured by JASCO Corporation), and taking the surface of the laminate on the decorative film side as an incident surface, the laminate was subjected to measurement of a complementary reflection spectrum at a light incident angle of −5° and a light receiving angle of +15° with respect to a line perpendicular to the decorative film surface. Only the standard white plate was measured at the same angles, and the relative reflectance with respect to the standard white plate was calculated. From the relative reflectance, the relative chromaticity L*,a*,b* and the relative chroma saturation c* were calculated with the standard white plate being (L*,a*,b*)=(100,0,0), and these were taken as the complementary chroma saturation. For the decorative film, the higher the complementary chroma saturation, the more vivid the decorative effect can be visible, which is preferable.

As a result of the above, in Example 1, a multicolor decorative film having high reflection chroma saturation, low visibility of graininess, and glossiness could be efficiently produced.

### Comparative Example 1

A decorative film was produced in the same manner as in Example 1, except that, in the step of providing an optical mask layer on a substrate, the printing press was changed to an ink jet type (Jet Press 540WV, manufactured by FUJIFILM Corporation), the pattern was formed in an FM screen tone instead of an AM screen tone, and the print area ratio and the light transmittance were controlled by the density of halftone dots. Then, verification and evaluation 1 were further carried out. The results of the verification and evaluation are summarized in Table 1.

In the prepared optical mask layer, halftone dots were connected to each other to form larger halftone dots in the medium density region. In the obtained decorative film, the cholesteric pitch was not sufficiently uniform in a region of the optical mask layer where the halftone dots were large, resulting in occurrence of halftone dot-like hue change and non-uniformity of the reflected color. As a result, the obtained decorative film had low chroma saturation, graininess that was easily visible, and weak glossiness. The reason for the decrease in the glossiness is presumably that, in a case where the cholesteric pitch is non-uniform, the alignment of the cholesteric liquid crystal is tilted depending on an increase or decrease in the pitch, and thus light is reflected in a diffusion direction as compared with the desired horizontal alignment.

### Comparative Example 2

A decorative film was produced in the same manner as in Example 1, except that, in the step of providing an optical mask layer on a substrate, the printing press was changed to a laser photoplotter type, the pattern was formed on an A3-sized plate-making film (GPR-7S) in an AM screen tone of 350 lines, and then the pattern forming surface of the plate-making film was bonded to the substrate in contact with the substrate. Then, verification and evaluation 1 were further carried out. The results of the verification and evaluation are summarized in Table 1.

As a result, it was possible to produce a multicolor decorative film having high reflection chroma saturation, low visibility of graininess, and glossiness, but it was necessary to bond the A3-sized plate-making film in the number corresponding to a desired length to the substrate, resulting in poor production efficiency.

### Comparative Example 3

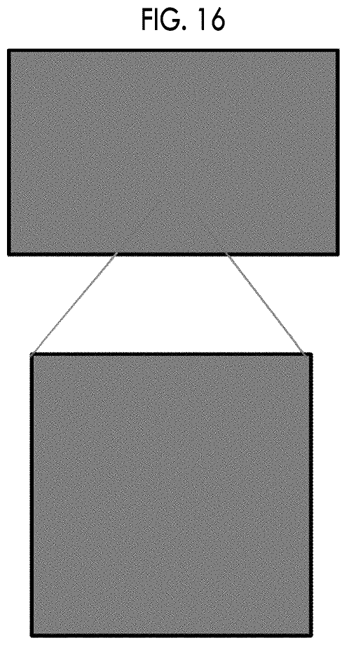

A decorative film was produced in the same manner as in Example 1, except that the first pattern was changed to a pattern of FIG. 15 having no halftone dotted region, the second pattern was changed to a pattern of FIG. 16, the third to sixth patterns were not formed, and the content of the photosensitive chiral agent was changed to 5.5 parts by mass. Then, verification and evaluation 1 were further carried out. The results of the verification and evaluation are summarized in Table 1.

The obtained decorative film was a decorative film with a small number of colors because no control of the hue was carried out by the halftone dotted regions of the optical mask layer.

### Comparative Example 4

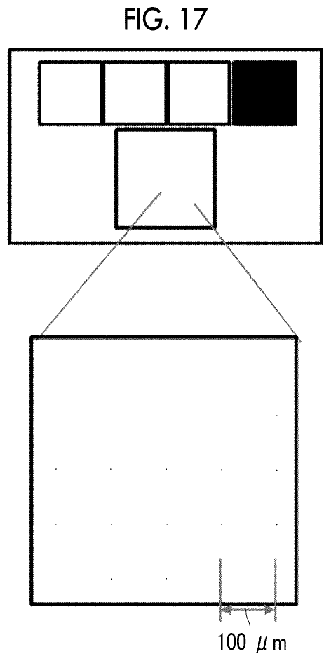

A decorative film was produced in the same manner as in Example 1, except that the first pattern was changed to a pattern of FIG. 17 having no halftone dotted region, the second pattern was changed to a pattern of FIG. 16, the third to sixth patterns were not formed, and the exposure amount of the first light was changed to 13 mJ/cm². Then, verification and evaluation 1 were further carried out. The results of the verification and evaluation are summarized in Table 1.

The obtained decorative film was a decorative film with a small number of colors because no control of the hue was carried out by the halftone dotted regions of the optical mask layer.

### Comparative Example 5

A decorative film was produced in the same manner as in Example 1, except that the second to sixth patterns were not formed. Then, verification and evaluation 1 were further carried out. The results of the verification and evaluation are summarized in Table 1.

The prepared optical mask layer had a large difference in light transmittance between the halftone dot portions and the gap portions, and the obtained decorative film exhibited an occurrence of halftone dot-like hue change. As a result, the obtained decorative film had low chroma saturation, graininess that was easily visible, and weak glossiness.

### Comparative Example 6

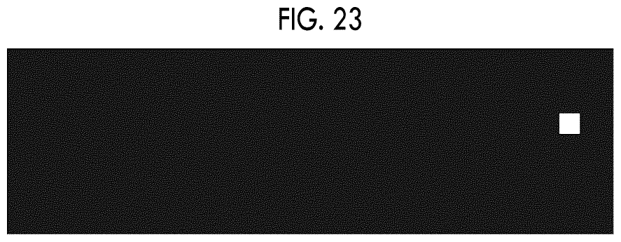

A decorative film was produced in the same manner as in Example 1, except that the second pattern was changed to a pattern of FIG. 23, the third to sixth patterns were not formed, and the exposure amount of the first light was changed to 13 mJ/cm². Then, verification and evaluation 1 were further carried out. The results of the verification and evaluation are summarized in Table 1.

In the prepared optical mask layer, the light transmittance T_{A} of the second pattern was small, and the control range of the light transmittance by the first pattern was narrowed, so that the amount of the hue change of the cholesteric liquid crystal layer was small. As a result, the obtained decorative film had a small number of colors.

### Example 2

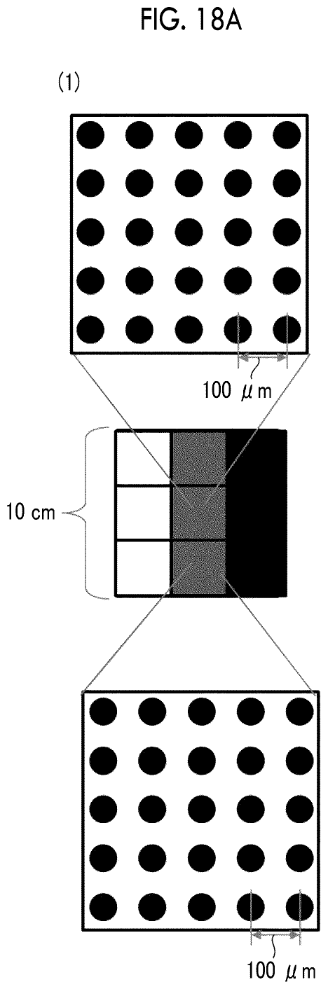

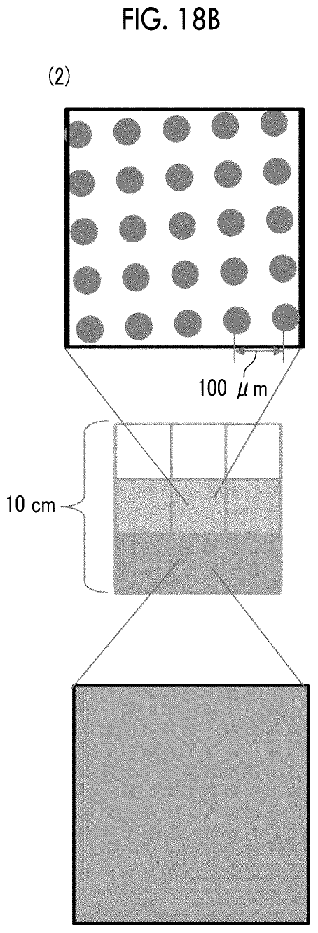

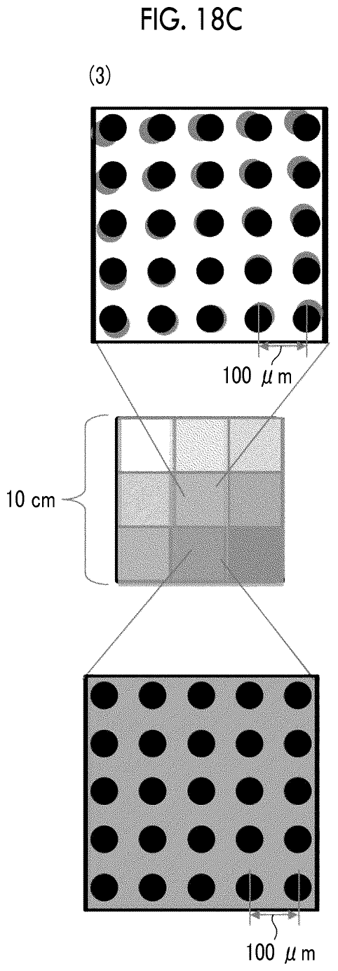

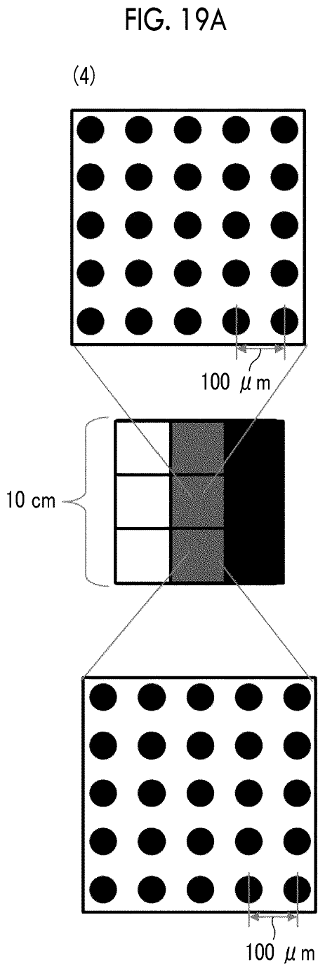

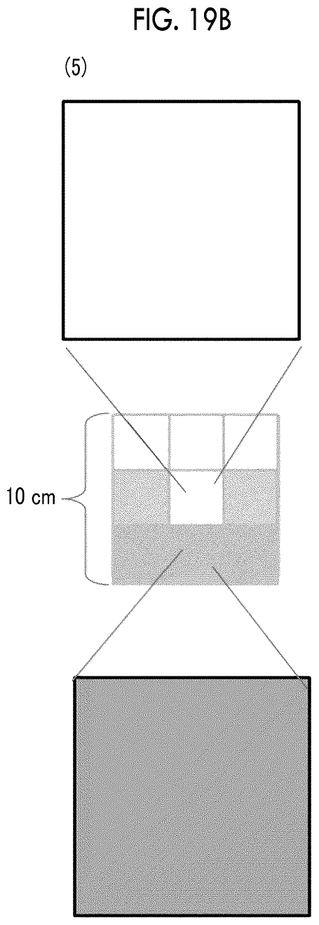

A decorative film was produced in the same manner as in Example 1, except that the first pattern was changed to a 10 cm square pattern having a halftone dotted region shown in (1) of FIG. 18A, the second pattern was changed to a 10 cm square pattern having a semi-translucent solid region shown in (2) of FIG. 18B, and the third to sixth patterns were not formed. Then, verification and evaluation 1 were further carried out. The results of the verification and evaluation are summarized in Table 1.

The prepared optical mask layer had a region where (T_{A}−T_{D})/(T_{MAX}−Tₘᵢₙ)=0.52 and a region where (T_{A}−T_{D})/(T_{MAX}−Tₘᵢₙ)=0.99. As a result, the chroma saturation in the region where (T_{A}−T_{D})/(T_{MAX}−Tₘᵢₙ)=0.52 was high, and a multicolor decorative film was efficiently obtained, but the graininess was strongly visible in the region where (T_{A}-T_{D})/(T_{MAX}−Tₘᵢₙ)=0.99. This is presumably because, in a region where the halftone dotted region of the first pattern and the halftone dotted region of the second pattern overlap with each other, the halftone dots are connected to each other to form large-sized halftone dots, as shown in (3) of FIG. 18C.

### Example 3

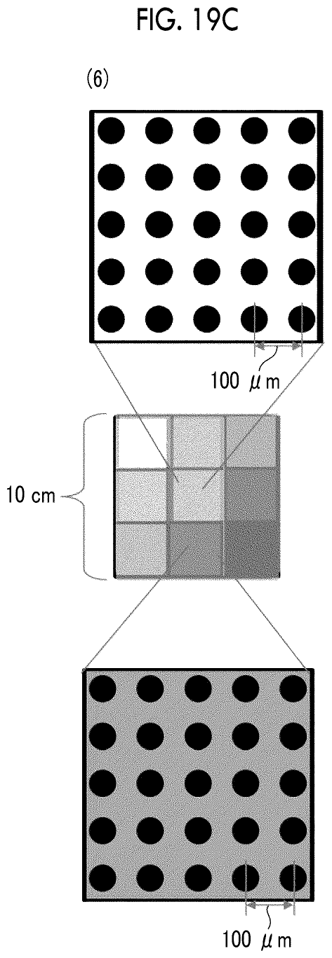

A decorative film was produced in the same manner as in Example 2, except that the first pattern was changed to a 10 cm square pattern having a halftone dotted region shown in (4) of FIG. 19A, and the second pattern was changed to a 10 cm square pattern having a semi-translucent solid region shown in (5) of FIG. 19B. Then, verification and evaluation 1 were further carried out. The results of the verification and evaluation are summarized in Table 1.

The prepared optical mask layer had a region where (T_{A}−T_{D})/(T_{MAX}−Tₘᵢₙ)=0.52 and a region where (T_{A}−T_{D})/(T_{MAX}−Tₘᵢₙ)=0.99. As a result, the chroma saturation in the region where (T_{A}−T_{D})/(T_{MAX}−Tₘᵢₙ)=0.52 was high, and a multicolor decorative film was efficiently obtained, but the graininess was visible in the region where (T_{A}−T_{D})/(T_{MAX}−Tₘᵢₙ)=0.99. This is because there were regions where the difference in transmittance between the halftone dot portions and the gap portions was large.

### Example 4

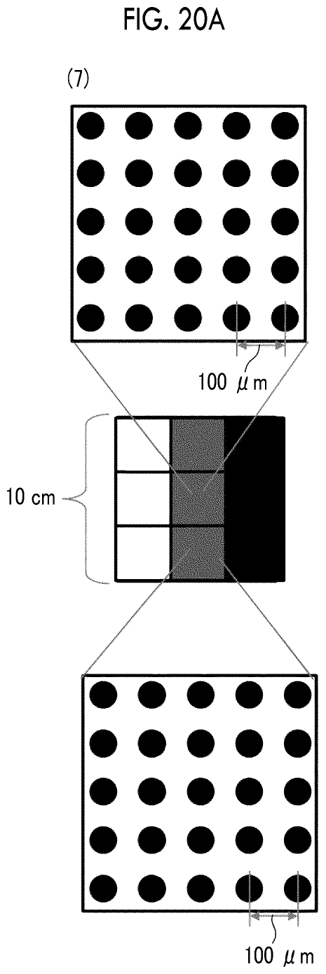

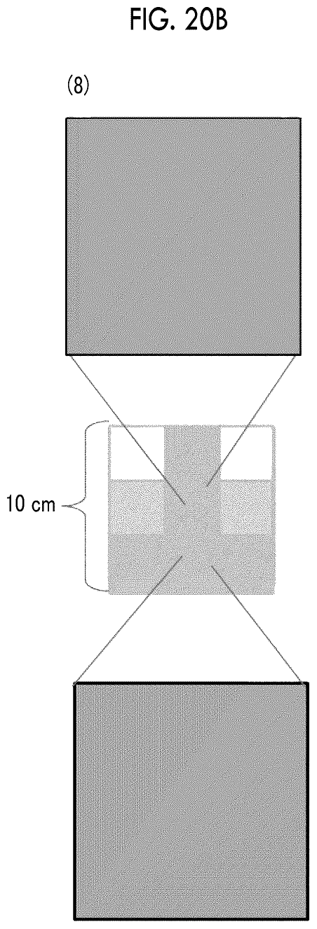

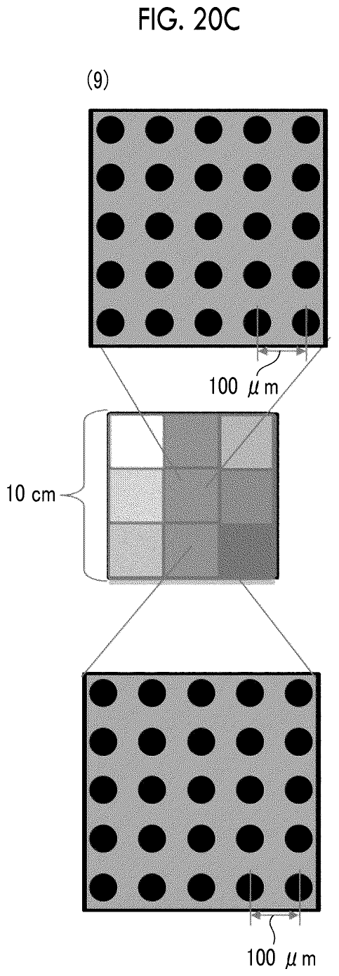

A decorative film was produced in the same manner as in Example 3, except that the first pattern was changed to a 10 cm square pattern having a halftone dotted region shown in (7) of FIG. 20A, the second pattern was changed to a 10 cm square pattern having a semi-translucent solid region shown in (8) of FIG. 20B, and the optical mask layer was made such that the entire region of the halftone dotted region of the first pattern overlapped with the semi-translucent solid region of the second pattern. Then, verification and evaluation 1 were further carried out. The results of the verification and evaluation are summarized in Table 1.

In the prepared optical mask layer, (T_{A}−T_{D})/(T_{MAX}−Tₘᵢₙ)=0.52 was satisfied even in a region where the difference in transmittance between the halftone dot portions and the gap portions was the largest, and (T_{A}−T_{D})/(T_{MAX}−Tₘᵢₙ)≤0.95 was satisfied for all halftone dotted regions. As a result, a multicolor decorative film with high chroma saturation and slightly suppressed visibility of the graininess was efficiently obtained.

### Example 5

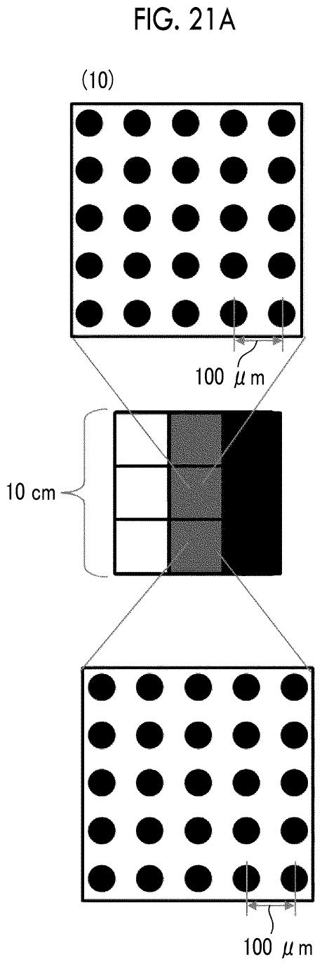

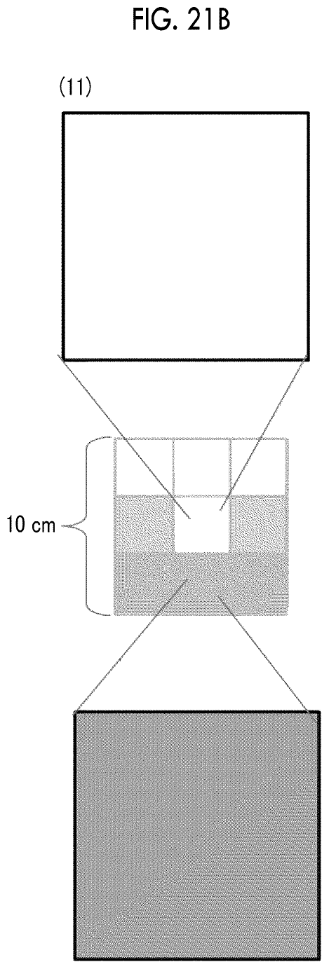

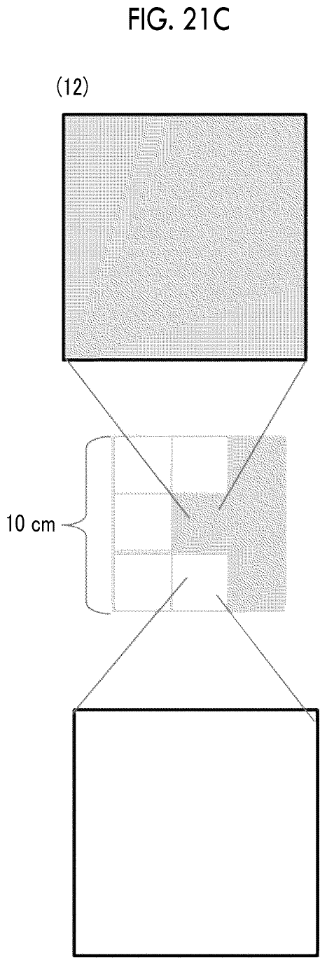

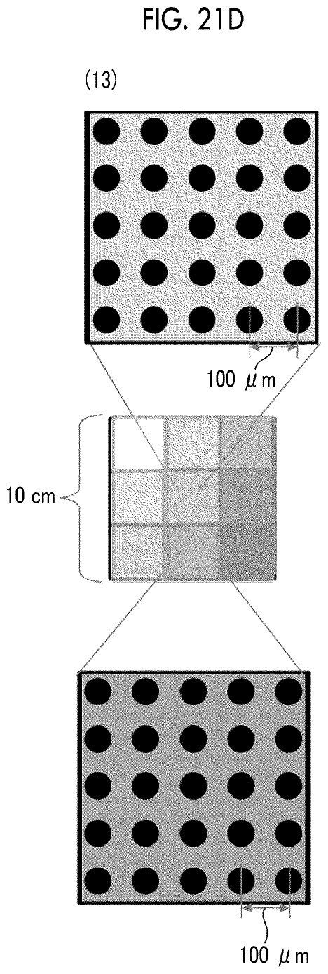

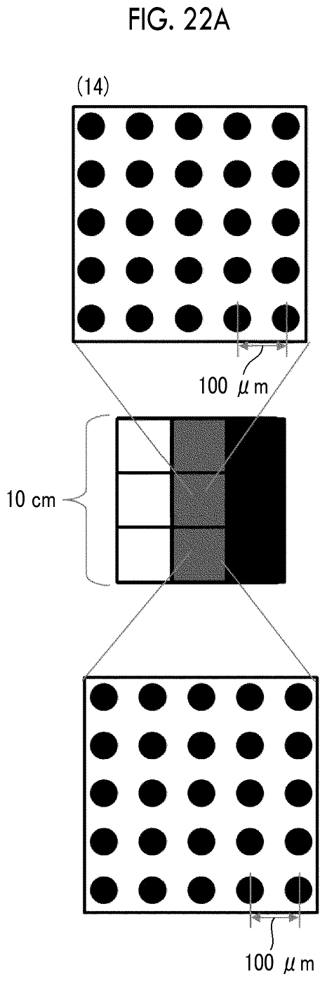

A decorative film was produced in the same manner as in Example 4, except that the first pattern was changed to a 10 cm square pattern having a halftone dotted region shown in (10) of FIG. 21A, the second pattern was changed to a 10 cm square pattern having a semi-translucent solid region shown in (11) of FIG. 21B, and the optical mask layer contained three patterns. Then, verification and evaluation 1 were further carried out. The results of the verification and evaluation are summarized in Table 1.

The prepared optical mask layer had a region where (T_{A}−T_{D})/(T_{MAX}−Tₘᵢₙ)=0.39. As a result, a multicolor decorative film having a region with higher chroma saturation than that of Example 4 and exhibiting slightly suppressed visibility of the graininess was efficiently obtained.

### Example 6

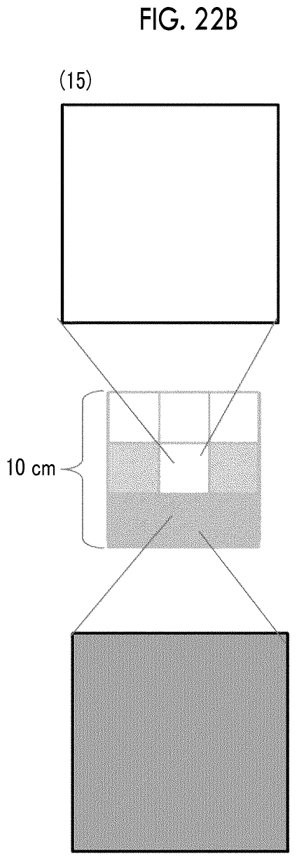

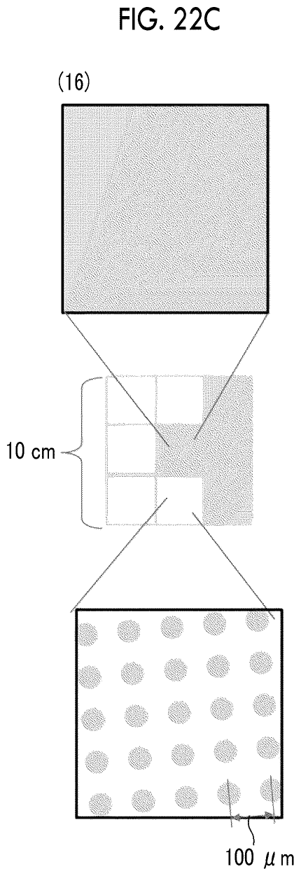

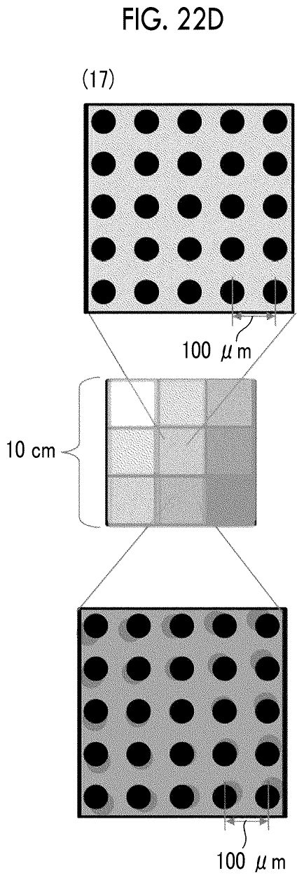

A decorative film was produced in the same manner as in Example 5, except that the first pattern was changed to a 10 cm square pattern having a halftone dotted region shown in (14) of FIG. 22A, the second pattern was changed to a 10 cm square pattern having a semi-translucent solid region shown in (15) of FIG. 22B, and the third pattern was changed to a 10 cm square pattern having a halftone dotted region shown in (16) of FIG. 22C. Then, verification and evaluation 1 were further carried out. The results of the verification and evaluation are summarized in Table 1.

As a result, a multicolor decorative film with high chroma saturation and slightly suppressed visibility of the graininess was efficiently obtained.

TABLE 1

| | | Example | Comparative | Comparative | Comparative | Comparative | Comparative |
|---|---|---|---|---|---|---|---|
| | | 1 | Example 1 | Example 2 | Example 3 | Example 4 | Example 5 |
| First | Printing | AM | FM | AM | AM | AM | AM |
| pattern | gradation | screen | screen | screen | screen | screen | screen |
| | manner | tone | tone | tone | tone | tone | tone |
| | Screen ruling | 210 lines | — | 350 lines | 250 lines | 250 lines | 250 lines |
| | Pattern | FIG. 9 | FIG. 9 | FIG. 9 | FIG. 15 | FIG. 17 | FIG. 9 |
| | Halftone dotted | Present | — | Present | Not present | Not present | Present |
| | region having | | | | (halftone | (halftone | |
| | halftone dot | | | | dot area | dot area | |
| | area ratio of | | | | ratio | ratio | |
| | 0.5% or more | | | | of 99.8%) | of 0.2%) | |
| | and less than | | | | | | |
| | 99.5% | | | | | | |
| Second | Pattern | FIG. 10 | FIG. 10 | FIG. 10 | FIG. 16 | FIG. 16 | Not |
| pattern | | | | | | | present |
| | Print area ratio | 100% | 100% | 100% | 100% | 100% | — |
| | within 300 um | | | | | | |
| | square | | | | | | |
| | Light | 26.4% | 48.9% | 48.9% | 50% | 50% | — |
| | transmittance | | | | | | |
| Pattern different from first | | Included | Not | Included | Not | Not | Not |
| pattern and second pattern | | | included | | included | included | included |
| (three or more patterns) | | | | | | | |
| Pattern of optical mask | | FIG. 8 | FIG. 8 | FIG. 8 | — | — | — |
| layer | | | | | | | |
| (T_{A} − T_{D})/(T_{MAX} − Tₘᵢₙ) | | 0.28 | 0.99 | 0.28 | — | — | 0.99 |
| maximum value | | | | | | | |
| (T_{A} − T_{D})/(T_{MAX} − Tₘᵢₙ) | | 0.03 | 0.99 | 0.03 | — | — | 0.99 |
| minimum value | | | | | | | |
| Evaluation | Productivity | A | A | B | A | A | A |
| | Reflection | A: 63.7 | C: 38 | A: 59.8 | A: 64.3 | A: 64.2 | C: 38.2 |
| | chroma | | | | | | |
| | saturation c* | | | | | | |
| | Polychroism | A | A | A | B | B | A |
| | Graininess | AA | C | A | AA | AA | C |
| | Glossiness | A | B | A | A | A | C |
| | Complementary | 26 | 16 | 24 | 26 | 25 | 16 |
| | chroma | | | | | | |
| | saturation c* | | | | | | |

| | | Comparative | Example | Example | Example | Example | Example |
|---|---|---|---|---|---|---|---|
| | | Example 6 | 12 | 3 | 4 | 5 | 6 |
| First | Printing | AM | AM | AM | AM | AM | AM |
| pattern | gradation | screen | screen | screen | screen | screen | screen |
| | manner | tone | tone | tone | tone | tone | tone |
| | Screen ruling | 250 lines | 250 lines | 250 lines | 250 lines | 250 lines | 250 lines |
| | Pattern | FIG. 9 | FIG. 18A | FIG. 19A | FIG. 20A | FIG. 21A | FIG. 22A |
| | | | (1) | (4) | (7) | (10) | (14) |
| | Halftone dotted | Present | Present | Present | Present | Present | Present |
| | region having | | | | | | |
| | halftone dot | | | | | | |
| | area ratio of | | | | | | |
| | 0.5% or more | | | | | | |
| | and less than | | | | | | |
| | 99.5% | | | | | | |
| Second | Pattern | FIG. 23 | FIG. 18B | FIG. 19B | FIG. 20B | FIG. 21B | FIG. 22B |
| pattern | | | (2) | (5) | (8) | (11) | (15) |
| | Print area ratio | 100% | 100% | 100% | 100% | 100% | 100% |
| | within 300 um | | | | | | |
| | square | | | | | | |
| | Light | 3% | 48.9% | 52.1% | 52.1% | 39.1% | 39.1% |
| | transmittance | | | | | | |
| Pattern different from first | | Not | Not | Not | Not | Included | Included |
| pattern and second pattern | | included | included | included | included | | |
| (three or more patterns) | | | | | | | |
| Pattern of optical mask | | FIG. 8 | FIG. 18C | FIG. 19C | FIG. 20C | FIG. 21D | FIG. 22D |
| layer | | | (3) | (6) | (9) | (13) | (17) |
| (T_{A} − T_{D})/(T_{MAX} − Tₘᵢₙ) | | 0.99 | 0.99 | 0.99 | 0.52 | 0.52 | 0.52 |
| maximum value | | | | | | | |
| (T_{A} − T_{D})/(T_{MAX} − Tₘᵢₙ) | | 0.03 | 0.49 | 0.52 | 0.52 | 0.39 | 0.22 |
| minimum value | | | | | | | |
| Evaluation | Productivity | A | A | A | A | A | A |
| | Reflection | C: 38.6 | B: 40.7 | B: 48.0 | B: 48.1 | A: 55.2 | A: 57.8 |
| | chroma | | | | | | |
| | saturation c* | | | | | | |
| | Polychroism | B | A | A | A | A | A |
| | Graininess | A | D | C | B | B | B |
| | Glossiness | A | C | B | B | A | A |
| | Complementary | 16 | 17 | 19 | 19 | 22 | 22 |
| | chroma | | | | | | |
| | saturation c* | | | | | | |

As shown in Table 1, in Examples 1 to 6, a multicolor decorative film having high chroma saturation could be efficiently produced.

### (Evaluation 2)

In order to eliminate the influence of the optical mask layer on the decorative film obtained in Example 1, the cholesteric liquid crystal layer was transferred to a PET film (A4160, manufactured by Toyobo Co., Ltd.) through an optical pressure-sensitive adhesive sheet (G25, manufactured by NEION Film Coatings Corp.) to produce a decorative film for evaluation, and the following evaluation 2 was carried out.

### Sharpness of Boundary

For the region of the decorative film where the hue changes in an in-plane direction, the reflection spectra at two points separated by 100 μm were measured using a differential microscopic ultraviolet-visible-near infrared spectrophotometer (MSV-5500, manufactured by JASCO Corporation), and the respective reflection center wavelengths were calculated. As the change in reflection center wavelength per a distance of 100 μm in an in-plane direction increases, the boundary of the color is sharply visible and is visible as a clear design. The sharpness of the boundary was evaluated according to the following standards. As for the decorative film that realizes a clear design, the grade “A” is preferable.

### <Standards>

A: The change in the reflection center wavelength per a distance of 100 μm in an in-plane direction is 20 nm or more.
B: The change in the reflection center wavelength per a distance of 100 μm in an in-plane direction is less than 20 nm.

### Color Range

The reflection center wavelength of the decorative film was measured in the same manner as in the evaluation of the reflection chroma saturation c*, the reflection center wavelength of the shortest wavelength and the reflection center wavelength of the longest wavelength in the decorative film were calculated, and the color range was evaluated according to the following standards from the difference A2 in the reflection center wavelength. As for the decorative film, the grade “A” is preferable.

### <Standards>

A: Δλ≥110 nm
B: Δλ<110 nm

The results of the verification and evaluation are summarized in Table 2.

### Example 7

A decorative film was produced in the same manner as in Example 1, except that, in the step of subjecting the photosensitive chiral agent to a photoreaction, frosted glass was placed between the light source and the optical mask layer, the first light was diffused light, and the heating carried out between the step of subjecting the photosensitive chiral agent to a photoreaction and the curing step was carried out at 85° C. Then, verification and evaluation were further carried out. The results of the verification and evaluation are summarized in Table 2. In the formed cholesteric liquid crystal layer, the maximum value of the change in cholesteric pitch per a distance of 100 μm in an in-plane direction was 10 nm.

In Example 7, a decorative film having high chroma saturation, glossiness, and suppressed graininess could be efficiently produced, but the obtained decorative film had a blurred boundary of the pattern. As the change in cholesteric pitch in an in-plane direction is more gradual, the tilt alignment is more suppressed, which leads to an improvement in chroma saturation, but at the same time, the color change in an in-plane direction is also more gradual, resulting in a decrease in the sharpness of the boundary.

### Example 8

A decorative film was produced in the same manner as in Example 1, except that the first light was set to a condition of an exposure amount of 75 mJ/cm². Then, verification and evaluation were further carried out. The results of the verification and evaluation are summarized in Table 2. In the formed cholesteric liquid crystal layer, the maximum value of the intra-lattice pitch difference was 75 nm.

As a result, a multicolor decorative film having high chroma saturation could be efficiently produced, but the obtained decorative film had weak glossiness and the graininess that was easily visible. As the intra-lattice pitch difference increases, the alignment of the cholesteric liquid crystal is tilt alignment having a larger angle, resulting in a worsening of glossiness and graininess.

### Example 9

A decorative film was produced in the same manner as in Example 1, except that the first light was set to a condition of an exposure amount of 10 mJ/cm². Then, verification and evaluation were further carried out. The results of the verification and evaluation are summarized in Table 2. The formed cholesteric liquid crystal layer had a difference between the maximum and minimum values of the cholesteric pitch of 65 nm.

As a result, a multicolor decorative film having high chroma saturation, glossiness, and suppressed graininess could be efficiently produced, but the obtained decorative film had a narrow color range, with only a color change from blue to green. As the difference between the maximum value and the minimum value of the cholesteric pitch in the cholesteric liquid crystal layer decreases, the color range that can be realized is narrowed.

### Example 10

The preparation of a substrate, the preparation of a substrate with an optical mask layer, the alignment treatment, and the formation of a liquid crystal layer were carried out in the same manner as in Example 1, except that the following liquid crystal composition 2 was used as the liquid crystal composition, and light (second light) from a metal halide lamp (MAL625NAL, manufactured by GS Yuasa Corporation) was applied through a short wavelength cut filter (a glass basal plate on which a dielectric multi-layer film was vapor-deposited to have a transmittance of 0.1% or less at a wavelength of 200 nm to 340 nm) in the curing step.

### Composition of Liquid Crystal Composition 2

Rod-like liquid crystal compound (1): 100 parts by mass
Photopolymerization initiator (KAYACURE DETX-S, manufactured by Nippon Kayaku Co., Ltd.): 1 part by mass
Surfactant 1: 0.02 parts by mass
Surfactant 2: 0.055 parts by mass
Organic solvent 1 (methyl ethyl ketone): 187.4 parts by mass
Organic solvent 2 (furfuryl alcohol): 35.7 parts by mass
Photosensitive chiral agent (2) (a compound having the following structure): 8.3 parts by mass

Photosensitive chiral agent (2): a compound shown below

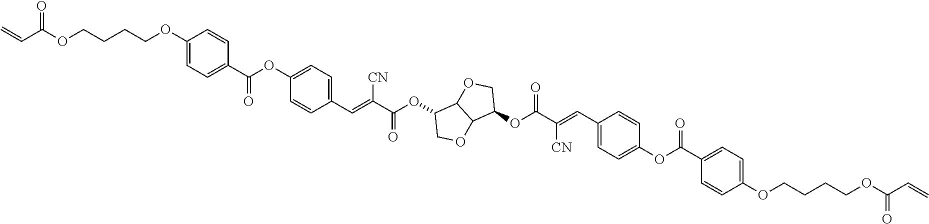

The obtained liquid crystal layer was further subjected to an alignment treatment and a second liquid crystal layer was laminated thereon, using the manufacturing device 100a having a configuration as shown in FIG. 6.

### [Alignment Treatment]

The liquid crystal layer surface of the decorative film was subjected to a rubbing treatment in a direction rotated counterclockwise by 3° with reference to a short side direction. The conditions for the rubbing treatment are as follows.

### <<Conditions>>

Rubbing cloth: rayon cloth
Pressure: 0.1 kgf
Rotation speed: 1,000 rpm
Transportation speed: 10 m/min
Number of times: 1 time

### [Formation of Liquid Crystal Layer (Cholesteric Liquid Crystal Layer)]

A liquid crystal composition 3 having the following composition was prepared.

### Composition of Liquid Crystal Composition 3

Rod-like liquid crystal compound (1): 100 parts by mass
Photopolymerization initiator (KAYACURE DETX-S, manufactured by Nippon Kayaku Co., Ltd.): 4 parts by mass
Surfactant 1: 0.05 parts by mass
Surfactant 2: 0.055 parts by mass
Organic solvent 1 (methyl ethyl ketone): 212.4 parts by mass
Organic solvent 2 (furfuryl alcohol): 21 parts by mass
Photosensitive chiral agent (3) (a compound having the following structure): 13.5 parts by mass

Photosensitive chiral agent (3): a compound shown below

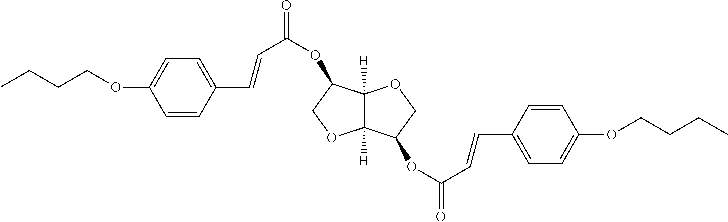 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

Next, the liquid crystal composition 3 prepared above was applied onto a rubbing-treated surface of a substrate using a die coater. The application was carried out at room temperature, adjusting the thickness after drying to about 2.5 to 4 μm, to form a coating film (a liquid crystal material preparing step).

Next, the coating film was irradiated with an ultraviolet (UV)-LED (manufactured by CCS, Inc.) through an optical mask layer at room temperature under conditions of an illuminance of 50 mW and an exposure amount of 330 mJ/cm², and the cholesteric liquid crystal layer was irradiated with ultraviolet light (first light) having a wavelength of 365 nm (a photoreaction step of a photosensitive chiral agent). Since an optical mask layer having a small difference in light transmittance between the halftone dots and the gaps was used, the difference in the amount of photoreaction of the photosensitive chiral agent in the cholesteric liquid crystal layer between the halftone dot portions and the gap portions was small, and the difference in helical twisting power was also small.

The substrate on which the coating film after the photoreaction step of a photosensitive chiral agent was laminated was heated in a hot air drying zone at 60° C. for 1 minute.

Next, the coating film was irradiated with light (second light) from a metal halide lamp (MAL625NAL, manufactured by GS Yuasa Corporation) from the cholesteric liquid crystal layer side at 75° C. in a low oxygen atmosphere (oxygen concentration: 500 ppm or less) to cure the cholesteric liquid crystal layer, thereby obtaining a decorative film (a curing step). The irradiation here was carried out under an exposure condition of an exposure amount of 600 mJ/cm².

Thereafter, the film was wound up by a winding roller.

The obtained decorative film was verified and evaluated. The results of the verification and evaluation are summarized in Table 2.

As a result, a multicolor decorative film having high chroma saturation, glossiness, and suppressed graininess could be efficiently produced. Further, the obtained decorative film had a configuration in which two cholesteric liquid crystal layers, that is, a cholesteric liquid crystal layer having a right-handed helix and a cholesteric liquid crystal layer having a left-handed helix were formed, and the two cholesteric liquid crystal layers were changed in hues using the same optical mask layer, so a decorative film was obtained in which the patterns of the two cholesteric liquid crystal layers were aligned with high positional accuracy.

TABLE 2

| | | Example 1 | Example 7 | Example 8 | Example 9 | Example 10 |
|---|---|---|---|---|---|---|
| Cholesteric liquid | ΔP_{s(MAX)}/ΔPₐₗₗ | 0.12 | 0.06 | 0.13 | 0.35 | 0.12 |
| crystal layer | Maximum value of change in cholesteric pitch | 172 nm | 10 nm | 320 nm | 42 nm | 1 72 nm |
| | per distance of 100 μm in in-plane direction | | | | | |
| | ΔP_{s(MAX)} | 30 | 15 | 75 | 23 | 30 |
| | ΔPₐₗₗ | 258 | 258 | 593 | 65 | 258 |
| | ΔP_{s(MAX)}/ΔPₐₗₗ | 0.12 | 0.06 | 0.13 | 0.35 | 0.12 |
| Evaluation | Productivity | A | A | A | A | A |
| | Reflection chroma saturation c* | A: 63.7 | A: 63.7 | A: 58 | A: 60.9 | A: 101.9 |
| | Polychroism | A | A | A | A | A |
| | Sharpness of boundary | A | B | A | A | A |
| | Glossiness | A | A | B | A | A |
| | Color range | A | A | A | B | A |
| | Graininess | AA | AA | B | AA | AA |

As shown in Table 2, in Examples 7 to 10, a multicolor decorative film having high chroma saturation could be efficiently produced.

### Example 11

A protective film on one side of a pressure-sensitive adhesive sheet (G25, manufactured by NEION Film Coatings Corp., thickness: 25 μm) having protective films on both sides of a pressure-sensitive adhesive layer was peeled off, and then the sheet was attached to be laminated on a polyethylene terephthalate film (COSMOSHINE A4360, manufactured by Toyobo Co., Ltd., thickness: 50 μm, width: 330 mm, length: 2000 m) having easy adhesion layers on both sides (temperature: 30° C., linear pressure: 100 N/cm, transportation speed: 0.1 m/min). This resulted in a transfer substrate having a protective film, a pressure-sensitive adhesive layer, and a transfer destination substrate in this order.

After peeling off the protective film of the transfer substrate, the pressure-sensitive adhesive layer was attached to be laminated on the liquid crystal layer of the decorative film produced in Example 10 (temperature: 30° C., linear pressure: 100 N/cm, transportation speed: 0.1 m/min). This resulted in a decorative film 2 having a transfer destination substrate, a pressure-sensitive adhesive layer, a liquid crystal layer, a substrate, and an optical mask layer in this order. The optical mask layer and the substrate of the decorative film 2 were peeled off to obtain a decorative film 3 having a transfer destination substrate, a pressure-sensitive adhesive layer, and a liquid crystal layer in this order.

### <Preparation of Black Pigment Dispersion Liquid>

Carbon black, a dispersant, a polymer, and a solvent were mixed to give the following composition of a black pigment dispersion liquid, and a black pigment dispersion liquid was obtained using a three roll mill and a beads mill. The average particle diameter of the carbon black measured using Microtrac FRA (manufactured by Honeywell Japan Ltd.) was 163 nm.

### Composition of Black Pigment Dispersion Liquid

Resin-coated carbon black produced according to the description of paragraphs to of JP5320652B: 20.0% by mass
Dispersant 1 (a structure given below): 1.0% by mass
Polymer (random copolymer of benzyl methacrylate/methacrylic acid=72/28 (molar ratio), weight-average molecular weight: 30,000): 6.0% by mass
Propylene glycol monomethyl ether acetate: 73.0% by mass

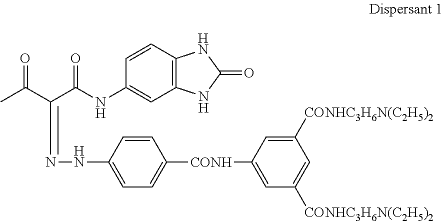

### <Composition of Coating Liquid 1 for Forming Colored Layer>

Black pigment dispersion liquid: 30 parts by mass
Polymerizable compound 1: urethane acrylate oligomer, CN-996NS, manufactured by Sartomer Japan Inc., 25 parts by mass.
Binder resin 3: ethyl acetate/ethyl methyl ketone/isopropyl alcohol solution containing 35% by mass of a urethane-modified acrylic polymer (containing polyol): 25 parts by mass
Photopolymerization initiator (IRGACURE 2959, manufactured by BASF SE): 1.0 part by mass
Methyl ethyl ketone: 19 parts by mass

### <Formation of Colored Layer>

The coating liquid 1 for forming a colored layer was applied onto the liquid crystal layer of the decorative film 3 using a die coater and dried at 100° C. for 10 minutes. The entire surface of the colored layer of the formed laminate was exposed to light at an exposure amount of 500 mJ/cm² (i-line) to form a colored layer 1 (black colored layer) having a layer thickness of 4 μm, thereby forming a decorative film 4. The decorative film 4 has a transfer destination substrate, a pressure-sensitive adhesive layer, a liquid crystal layer, and a colored layer in this order.

### <Production of Decorative Film for Molding>

The protective film on one side of a pressure-sensitive adhesive sheet (G25, manufactured by NEION Film Coatings Corp., thickness: 25 μm) was peeled off, and then the pressure-sensitive adhesive layer was attached to the transfer destination substrate surface of the decorative film 4 to obtain a decorative film for molding having a protective film, a pressure-sensitive adhesive layer, a transfer destination substrate, a pressure-sensitive adhesive layer, a liquid crystal layer, and a colored layer in this order.

### <Production of Molded Body>

The decorative film for molding was cut into a sheet having a width of 7.5 cm and a length of 17 cm, the protective film was peeled off, and then the pressure-sensitive adhesive layer was attached to a glass panel having a thickness of 2 mm, a width of 7.5 cm, and a length of 17 cm to produce a molded body.

In a case where the obtained molded body was viewed from the glass panel side, a multicolor pattern having high reflection chroma saturation, low visibility of graininess, and glossiness was visible.

The disclosures of JP2022-054572 filed on Mar. 29, 2022, and JP2022-093029 filed on Jun. 8, 2022 are incorporated herein by reference in their entirety.

All publications, patent applications, and technical standards mentioned in the present specification are herein incorporated by reference to the same extent as if each individual publication, patent application, and technical standard were specifically and individually indicated to be incorporated by reference.

What is claimed is:

1. A manufacturing method of a laminate, comprising:
a step of providing an optical mask layer on a substrate by printing, on the substrate using a first ink, a first pattern having an AM screen tone with a screen ruling of 250 lines or less and having a halftone dotted region having a halftone dot area ratio of 0.5% or more and less than 99.5%, and printing, at a position overlapping with the halftone dotted region of the first pattern using a second ink, a second pattern having a semi-translucent solid region having a print area ratio of 99.5% or more and a light transmittance of 5% or more and less than 95%;
a step of providing a liquid crystal layer containing a liquid crystal compound and a photosensitive chiral agent on a side of the substrate opposite to the optical mask layer; and
a step of irradiating the liquid crystal layer with light through the optical mask layer to subject the photosensitive chiral agent to a photoreaction.

2. The manufacturing method of a laminate according to claim 1,
wherein an entire region of the halftone dotted region of the first pattern overlaps with the semi-translucent solid region of the second pattern, or
the second pattern further has a region having a print area ratio of less than 0.5%, and the entire region of the halftone dotted region of the first pattern overlaps with the semi-translucent solid region of the second pattern and the region of the second pattern having a print area ratio of less than 0.5%.

3. The manufacturing method of a laminate according to claim 1,
wherein the entire region of the halftone dotted region of the first pattern overlaps with the semi-translucent solid region of the second pattern.

4. The manufacturing method of a laminate according to claim 1,
wherein the second pattern further has a halftone dotted region, the first pattern further has at least one region of a semi-translucent solid region or a region having a print area ratio of less than 0.5%, an entire region of the halftone dotted region of the second pattern overlaps with the at least one region of the semi-translucent solid region or the region having a print area ratio of less than 0.5% of the first pattern, and the second pattern is a pattern having an AM screen tone with a screen ruling of 250 lines or less.

5. The manufacturing method of a laminate according to claim 4, further comprising, in the step of providing the optical mask layer on the substrate:
printing a pattern different from the first pattern and the second pattern on the substrate,
wherein the pattern different from the first pattern and the second pattern has at least one region of a semi-translucent solid region or a region having a print area ratio of less than 0.5%, and the at least one region of the semi-translucent solid region or the region having a print area ratio of less than 0.5% of the pattern different from the first pattern and the second pattern overlaps with an entire region of the halftone dotted region of the first pattern and an entire region of the halftone dotted region of the second pattern.

6. The manufacturing method of a laminate according to claim 5,
wherein the pattern different from the first pattern and the second pattern further has a halftone dotted region and is a pattern having an AM screen tone with a screen ruling of 250 lines or less.

7. The manufacturing method of a laminate according to claim 6,
wherein the pattern different from the first pattern and the second pattern is a plurality of patterns, and the halftone dotted regions of each of the plurality of patterns do not overlap with each other.

8. A manufacturing method of a decorative film, comprising:
the manufacturing method of a laminate according to claim 1.

9. A laminate comprising, in the following order:
an optical mask layer;
a substrate; and
a cholesteric liquid crystal layer containing a liquid crystal compound and a photosensitive chiral agent,
wherein the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

10. A laminate comprising, in the following order:
an optical mask layer;
a substrate; and
a cholesteric liquid crystal layer containing a liquid crystal compound and a photosensitive chiral agent,
wherein the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}−T_{D}<80.75% is satisfied.

11. The laminate according to claim 10,
wherein (T_{A}−T_{D})/(T_{MAX}−Tₘᵢₙ)≤0.95 is satisfied for all halftone dotted regions of the optical mask layer.

12. The laminate according to claim 10,
wherein (T_{A}−T_{D})/(T_{MAX}−Tₘᵢₙ)≤0.50 is satisfied for all halftone dotted regions of the optical mask layer.

13. A substrate with an optical mask for manufacturing a decorative film, comprising:
a substrate; and
an optical mask layer,
wherein the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied, and in a case where a light transmittance at a portion with a lowest light transmittance in the optical mask layer is defined as Tₘᵢₙ and a light transmittance at a portion with a highest light transmittance in the optical mask layer is defined as T_{MAX}, (T_{A}−T_{D})/(T_{MAX}−Tₘᵢₙ)≤0.95 is satisfied.

14. A substrate with an optical mask for manufacturing a decorative film, comprising:
a substrate; and
an optical mask layer,
wherein the optical mask layer has a halftone dotted region having an AM screen tone with a screen ruling of 250 lines or less and a halftone dot area ratio of 0.5% or more and less than 99.5% and has, in the halftone dotted region, a region in which, in a case where a light transmittance of halftone dots is defined as T_{D} and a light transmittance of gaps between the halftone dots is defined as T_{A}, 5%≤T_{A}<95% is satisfied and 1%≤T_{A}−T_{D}<80.75% is satisfied.

15. A decorative film comprising:
a cholesteric liquid crystal layer,
wherein the cholesteric liquid crystal layer has a halftone dot region in which maximum points of a cholesteric pitch are arranged in a halftone dot-like manner, and
in a case where the halftone dot region is divided into unit lattices which are quadrangles having a smallest area with the maximum point of the cholesteric pitch as a vertex, and a difference between a maximum value and a minimum value of the cholesteric pitch in each of unit lattices is defined as an intra-lattice pitch difference ΔP_{S}, ΔP_{S(MAX)}, which is a maximum value of the ΔP_{S}, is 0<ΔP_{S(MAX)}/ΔPₐₗₗ≤0.4 with respect to ΔPₐₗₗ which is a difference between a maximum value and a minimum value of a cholesteric pitch in an entire cholesteric liquid crystal layer.

16. The decorative film according to claim 15,
wherein the cholesteric liquid crystal layer has a region in which a change in cholesteric pitch per a distance of 100 μm in an in-plane direction is 13 nm or more.

17. The decorative film according to claim 15,
wherein the ΔP_{S(MAX)} is less than 33 nm in the cholesteric liquid crystal layer.

18. A decorative film comprising:
a cholesteric liquid crystal layer,
wherein the cholesteric liquid crystal layer has a halftone dot region in which maximum points of a cholesteric pitch are arranged in a halftone dot-like manner, and
in a case where the halftone dot region is divided into unit lattices which are quadrangles having a smallest area with the maximum point of the cholesteric pitch as a vertex, and a difference between a maximum value and a minimum value of the cholesteric pitch in each of unit lattices is defined as an intra-lattice pitch difference ΔP_{S}, ΔP_{S(MAX)}, which is a maximum value of the ΔP_{S}, is less than 33 nm in the cholesteric liquid crystal layer.

19. The decorative film according to claim 15,
wherein a difference ΔPₐₗₗ between a maximum value and a minimum value of a cholesteric pitch in an entire cholesteric liquid crystal layer is 70 nm or more in the cholesteric liquid crystal layer.

20. A molded body obtained by molding the decorative film according to claim 15.

21. An article comprising:
the decorative film according to claim 15.

22. The article according to claim 21,
wherein the article is an electronic device.

23. A display device comprising:
the article according to claim 22.

24. The decorative film according to claim 18,
wherein a difference ΔPₐₗₗ between a maximum value and a minimum value of a cholesteric pitch in an entire cholesteric liquid crystal layer is 70 nm or more in the cholesteric liquid crystal layer.
